(19) United States
(12) Patent Application Publication
(10) Pub. No.: US 2007/0300245 A1
(43) Pub. Date: Dec. 27, 2007

(54) DISK DRIVE APPARATUS

(75) Inventors: Hideaki Tsutsumi, Tokyo (JP); Noriyoshi Ishii, Chiba (JP); Kiyoshi Oomori, Tokyo (JP); Katsunori Takahashi, Tokyo (JP); Shigeru Tamura, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony NEC Optiarc Inc., Shinagawa-ku (JP)

(21) Appl. No.: 11/765,797

(22) Filed: Jun. 20, 2007

(30) Foreign Application Priority Data
Jun. 23, 2006 (JP) 2006-174644

(51) Int. Cl. G11B 17/04

(52) U.S. Cl. 720/619

(57) ABSTRACT

A disk drive apparatus includes: a device main body which a disk-shaped recording medium is inserted and ejected therefrom; a loading arm which has an arm main body and a support part; a loading cam plate which has a cam groove and rotate the loading arm; a drive mechanism which is coupled to the loading cam plate; an eject arm which is rotatably supported; a link mechanism which couples the eject arm to the drive mechanism; and a cam unit which is engaged in the link mechanism, wherein a long hole is provided in one of the arm main body and the pivot part, and a protrusion part is provided in the other one which is inserted into the long hole.

### CROSS REFERENCES TO RELATED APPLICATIONS

The present invention contains subject matter related to Japanese Patent Application JP 2006-174644 filed in the Japanese Patent Office on Jun. 23, 2006, the entire contents of which being incorporated herein by reference.

### BACKGROUND OF THE INVENTION

1. Field of the Invention

The present invention relates to a disk drive apparatus which records and/or reproduces information signals from an optical disk, particularly to a so-called slot-in disk drive apparatus in which an optical disk is directly inserted thereinto and automatically mounted thereon.

2. Description of the Related Art

For optical disks, heretofore, such optical disks are widely known including CD (Compact Disk), DVD (Digital Versatile Disk) and BD (Blue-ray Disk), and magneto-optical disks such as MO (Magneto optical) and MD (Mini Disk). Various disk drive apparatus are introduced compliant to these disks and disk cartridges.

There are many types of disk drive apparatus, such as one that a cover or a door disposed on a housing is opened and a disk is directly mounted on a turntable seen therefrom, one that a disk is placed on a disk tray horizontally drawn from a housing and then the disk is automatically mounted on a turntable inside the housing at the time when the disk tray is drawn, or one that a disk is directly mounted on a turntable disposed on a disk tray. However, in these types of disk drive apparatus, it is necessary for an operator to do some manipulation, for example, to open and close the cover or the door, or to put a disk on or out of the disk tray, or to mount a disk on the turntable.

In contrast to this, there is a so-called slot-in disk drive apparatus in which a disk is only inserted from a disk port disposed on the front side of a housing and then the disk is automatically mounted on a turntable. The slot-in disk drive apparatus has a pair of guide rollers facing to each other to clamp a disk inserted from the disk port in which the paired guide rollers are rotated in reverse to each other to perform a loading operation that the disk inserted from the disk port is drawn into the housing, and an eject operation that the disk is ejected from the disk port to outside the housing.

In addition, in mobile devices, such as a notebook personal computer, on which a disk drive apparatus is mounted, it is demanded for further reductions in size, weight and thickness, and it is correspondingly demanded for reductions in size, weight and thickness of the disk drive apparatus. With this background, in the slot-in disk drive apparatus, such a disk drive apparatus is provided in which a tip end part has an abutting part which abuts against the rim part of a disk inserted from a disk port on a front panel, a plurality of rotating arms is disposed whose base end part is rotatably supported, wherein such operations are performed while the rotating arms are being rotated in the plane in parallel with the disk: a loading operation that the disk is drawn from the disk port into the housing, and an eject operation that the disk is ejected from the disk port to outside the housing (for example, see JP-A-2005-100595 (Patent Reference 1)). Among many disk drive apparatus that are intended to reduce the thickness as described above, for an ultralow-profile disk drive apparatus which is mounted on a notebook personal computer, for example, such a disk drive apparatus is also proposed including one having a thickness of 12.7 mm, and one having a thickness of 9.5 mm that is the same thickness as that of a hard disk drive (HDD) unit further reduced in thickness.

In the disk drive apparatus in which a plurality of rotating arms is disposed to perform the disk the loading operation and the eject operation while the rotating arms are being rotated in the plane in parallel with the disk, the apparatus generally has a loading arm which draws a disk and an eject arm which ejects a disk, and has a drive source which is joined to the arms through a link mechanism. The loading arm and the eject arm are rotated as they are interlocked with the drive source and the link mechanism at the time when a disk is inserted and ejected to transfer the disk.

Here, the loading arm draws a disk from the disk port into the housing, whereas the eject arm pushes a disk out of the housing to the disk port. Therefore, at the time when the disk is loaded or ejected, it is necessary that the eject arm is retracted in accordance with the rotation of the loading arm into the housing, and that the loading arm is retracted in accordance with the rotation of the eject arm toward the disk port side. This is because when such an event occurs that the eject arm is delayed to retract as it is interlocked with the disk drawing operation of the loading arm or that the loading arm is delayed to retract as it is interlocked with the disk eject operation of the eject arm, the disk drawing operation or eject operation is hampered to make it difficult to do smooth insertion and eject operations, and a load can be applied to the drive source, the link mechanism, the eject armor the loading arm.

### SUMMARY OF THE INVENTION

It is desirable to provide a disk drive apparatus which can smoothly insert and eject a disk as individual arms are interlocked with a drive source in a disk drive apparatus having rotating arms.

A disk drive apparatus according to an embodiment of the invention is a disk drive apparatus including: a device main body which a disk-shaped recording medium is inserted thereinto and ejected therefrom; a loading arm which has an arm main body and a support part wherein when the disk-shaped recording medium is inserted, the loading arm is rotated in the insertion direction to draw the disk-shaped recording medium into the device main body, and when the disk-shaped recording medium is ejected, the loading arm is rotated in the eject direction, the arm main body which is rotatably supported on a pivot part that is disposed in the direction orthogonal to in the direction of inserting and ejecting the disk-shaped recording medium by the device main body and disposed in a plane in parallel with one side of surfaces of the disk-shaped recording medium, and the support part which is disposed on the tip end of the arm main body and supports the side surface on the back side of the disk-shaped recording medium in the insertion direction; a loading cam plate which has a cam groove and rotate the loading arm, the cam groove in which an engagement projecting part is engaged that is projected on the arm main body; a drive mechanism which is coupled to the loading cam plate, and reciprocates the loading cam plate inside the device main body in association with inserting and ejecting the disk-shaped recording medium, whereby the drive mechanism rotates the loading arm through the loading cam plate in directions of inserting and ejecting the disk-shaped recording medium; an eject arm which is rotatably supported in the direction orthogonal to the directions of inserting and ejecting the disk-shaped recording medium by the device main body and on the other side of surfaces in plane in parallel with the disk-shaped recording medium, and which is pressed by the disk-shaped recording medium and rotated in the insertion direction when the disk-shaped recording medium is inserted into the device main body, and is rotated in the eject direction to eject the disk-shaped recording medium when the disk-shaped recording medium is ejected; a link mechanism which couples the eject arm to the drive mechanism, and the drive mechanism is driven, whereby the link mechanism rotates the eject arm in the directions of inserting and ejecting the disk-shaped recording medium; and cam means which is engaged in the link mechanism, wherein an engagement part of the link mechanism is pivoted from the insertion to the ejection of the disk-shaped recording medium to control an amount of rotation of the eject arm so that the amount of rotation of the eject arm with respect to the drive mechanism in ejecting the disk-shaped recording medium is greater than the amount of rotation of the eject arm with respect to the drive mechanism in inserting and ejecting the disk-shaped recording medium, wherein a long hole is provided in one of the arm main body and the pivot part, and a protrusion part is provided in the other one which is inserted into the long hole.

In accordance with the disk drive apparatus according to an embodiment of the invention, for the loading arm which is interlocked with the drive mechanism through the loading cam plate, since the insertion hole to be the rotating support point is formed in a long hole, the rotating support point is shifted when the disk-shaped recording medium is ejected, and thus such an event can be prevented that the timing of releasing the disk-shaped recording medium is delayed.

Therefore, in the disk drive apparatus, a shift of the eject arm from the timing of ejecting the disk-shaped recording medium can be absorbed to smoothly eject the disk, the eject arm which is interlocked with the drive mechanism, and is controlled so that the amounts of rotation with respect to the drive mechanism are different in inserting and ejecting the disk-shaped recording medium by the cam means.

### BRIEF DESCRIPTION OF THE DRAWINGS

FIG. 1 shows a perspective view depicting the appearance of an electronic appliance mounted with a disk drive apparatus to which an embodiment of the invention is applied;

FIG. 2 shows a perspective view depicting the appearance of the disk drive apparatus to which an embodiment of the invention is applied;

FIG. 3 shows a perspective view depicting the inside of the disk drive apparatus to which an embodiment of the invention is applied;

FIG. 4 shows a perspective view depicting the disk drive apparatus with a main chassis removed;

FIG. 5 shows a perspective view depicting the appearance of a top cover;

FIG. 6 shows a perspective view depicting a base unit;

FIG. 7 shows a cross section depicting the joining portion of the base chassis to a subchassis;

FIG. 8 shows a diagram illustrative of the support structure by means of a damper between the base chassis and the subchassis in the base unit;

FIG. 9 shows a perspective view depicting another exemplary disk drive apparatus;

FIG. 10 shows a cross section depicting another exemplary disk drive apparatus;

FIG. 11 shows a plan view depicting the disk drive apparatus which is waiting for an optical disk to be inserted;

FIG. 12 shows a plan view depicting the disk drive apparatus shifting from the insertion operation to the drawing operation;

FIG. 13 shows a plan view depicting the disk drive apparatus which starts to draw an optical disk with a loading arm;

FIG. 14 shows a plan view depicting the disk drive apparatus which draws an optical disk;

FIG. 15 shows a plan view depicting the disk drive apparatus which draws an optical disk to a centering position;

FIG. 16 shows a plan view depicting the disk drive apparatus which records and reproduces from an optical disk;

FIG. 17 shows a plan view depicting the disk drive apparatus which supports the side surface of a disk with various arms in the step of ejecting an optical disk;

FIG. 18 shows a plan view depicting the disk drive apparatus which ejects an optical disk;

FIG. 19 shows a plan view depicting the disk drive apparatus in which an optical disk is transferred to the eject position;

FIG. 20 shows a perspective view depicting a loading arm;

FIG. 21 shows a plan view depicting the loading arm;

FIGS. 22A and 22B show perspective views depicting a loading cam plate, FIG. 22A shows the front surface side, and FIG. 22B shows the back surface side;

FIG. 23 shows an exploded perspective view depicting an eject arm;

FIG. 24 shows a perspective view depicting the eject arm;

FIG. 25 shows a plan view illustrative of the operation of the eject arm when an obstacle exists in the disk transfer area at the step of ejecting a disk;

FIG. 26 shows a perspective view depicting another eject arm;

FIG. 27 shows a perspective view depicting the back surface side another eject arm;

FIG. 28 shows a perspective view depicting a supporting plate used for another eject arm;

FIGS. 29A to 29C show diagrams depicting a pickup arm of a second pickup part;

FIG. 30 shows a perspective view depicting the disk drive apparatus having another eject arm;

FIG. 31 shows a perspective view depicting a second pushing arm which supports an optical disk in the second pickup part;

FIG. 32 shows a perspective view depicting the second pushing arm which guides an optical disk in the second pickup part;

FIG. 33 shows a perspective view depicting a retaining part which is disposed on the main chassis and retained in one end part of a tensile coil spring;

FIGS. 34A and 34B show diagram depicting a loop cam plate, FIG. 34A shows a perspective view depicting it from the mounting surface side on the main chassis, and FIG. 34B shows a perspective view depicting it from the forming surface side of a guide groove;

FIG. 35 shows a plan view depicting the moving path of guide projecting parts in the loop cam;

FIG. 36 shows a plan view depicting the disk drive apparatus which uses the eject arm to prevent a wrong small diameter disk from being inserted;

FIG. 37 shows a perspective view depicting a deck arm and a regulation arm;

FIG. 38 shows a plan view depicting the disk drive apparatus which uses the deck arm to prevent a wrong small diameter disk from being inserted;

FIG. 39 shows an exploded perspective view depicting a centering guide;

FIG. 40 shows a perspective view depicting the centering guide;

FIG. 41 shows a perspective view depicting a first guide plate and a slider;

FIG. 42 shows a perspective view depicting the slider on which the first guide plate is retained;

FIG. 43 shows a perspective view depicting a second guide plate and a subslider;

FIG. 44 shows a perspective view depicting the subslider on which the second guide plate is retained;

FIG. 45 shows a cross section depicting the relation between positions of a guide pin and a guide hole, (a) is a chucking release position, (b) is a disk mounting position, and C is a recording/reproducing position;

FIG. 46 shows a perspective view depicting the guide pin and the guide hole in the state in which the base unit is lowered at the chucking release position;

FIG. 47 shows a perspective view depicting the guide pin and the guide hole in the state in which the base unit is raised at the chucking position; and

FIG. 48 shows a perspective view depicting the guide pin and the guide hole in the state in which the base unit is raised at the recording/reproducing position.

### DETAILED DESCRIPTION OF THE INVENTION

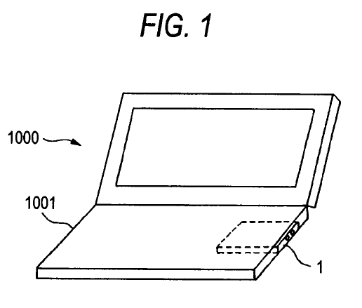

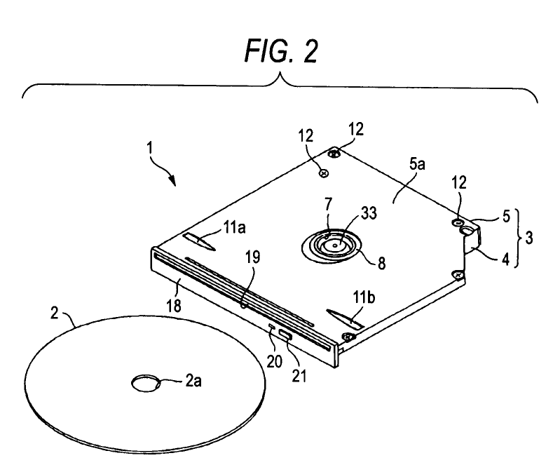

Hereinafter, a disk drive apparatus to which an embodiment of the invention is applied will be described in detail with reference to the drawings. For example, as shown in FIG. 1, a disk drive apparatus 1 is a slot-in disk drive apparatus 1 which is mounted on a device main body 1001 of a notebook personal computer 1000. As shown in FIG. 2, for example, the disk drive apparatus 1 has a structure in which the overall apparatus is reduced in thickness to about 12.7 mm, and the apparatus can record and reproduce information signals from an optical disk 2 such as CD (Compact Disk), DVD (Digital Versatile Disk), and BD (Blue-ray Disc).

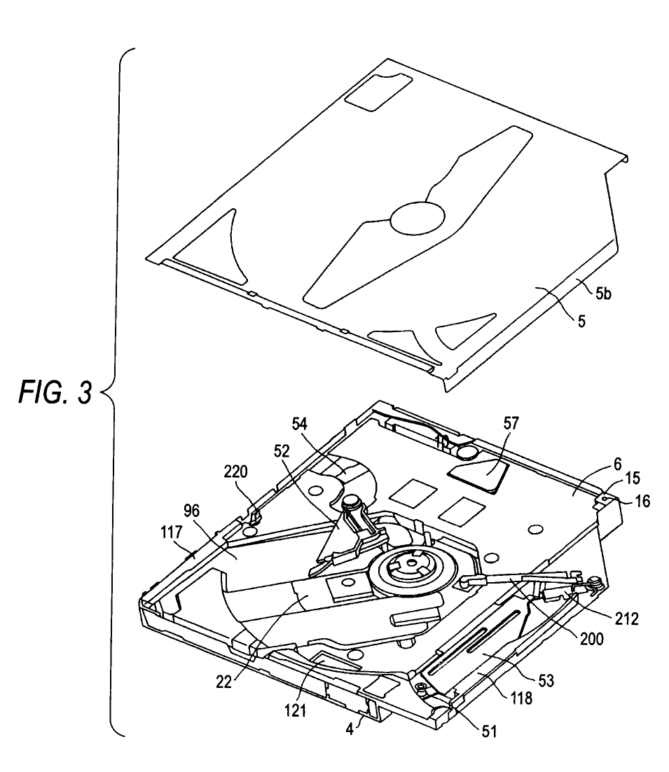

First, the specific configuration of the disk drive apparatus 1 will be described. As shown in FIGS. 3 to 5, the disk drive apparatus 1 has a housing 3 which is the outer housing of the apparatus main body. The housing 3 is configured of a bottom case 4 in a flat box shape to be a lower housing, and a top cover 5 to be a top which covers the upper opening of the bottom case 4. In addition, the housing 3 is mounted therein with a drive mechanism 120 which has a base unit 22, described later, thereabove and provides the drive force of transferring a disk, and a main chassis 6 which covers a disk transfer mechanism 50 to which the drive force of the drive mechanism 120 is transmitted.

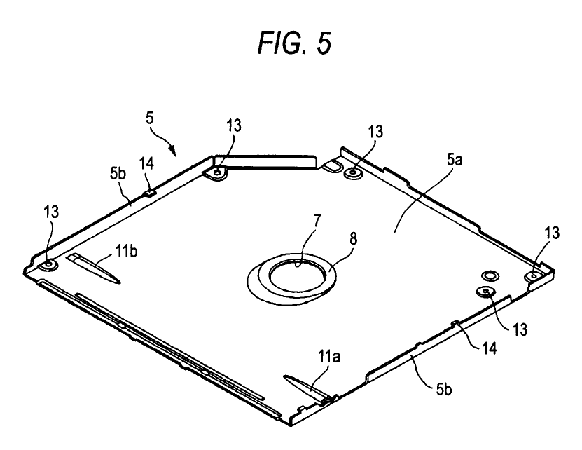

As shown in FIGS. 2 and 5, the top cover 5 is formed of a thin sheet metal, and has a top plate 5a which blocks the upper opening of the bottom case 4, and a pair of side plate parts 5b which is formed by slightly bending the rim part of the top plate 5a along two sides of the bottom case 4. At nearly the center of the top plate 5a, an opening 7 in a nearly round shape is formed. The opening 7 is used to bring an engaging protrusion part 33a of a turntable 23a outside therethrough, and the engaging protrusion part 33a is engaged in a center hole 2a of the optical disk 2 in the chucking operation, described later. In addition, the rim part of the opening 7 of the top plate 5a forms an abutting protrusion part 8 which slightly projects toward inside the housing 3 so as to abut against the rim part of the center hole 2a of the optical disk 2 held on the turntable 23a.

On the front side of the top plate 5a, a pair of guide protrusion parts 11a and 11b is formed as they are swelled inside the housing 3, and the guide protrusion parts 11a and 11b guide the optical disk 2 while they regulate the disk inserted from a disk port 19, described later, in the height direction. The pair of the guide protrusion parts 11a and 11b has a partial cone shape that is protruded to draw an arc in the insertion direction of the optical disk 2 at almost symmetric positions sandwiching the center line along the insertion direction of the optical disk 2 passing through the opening 7, and that is protruded in the direction almost orthogonal to the insertion direction of the optical disk 2 so that an arc is continuously reduced in the diameter from outside to inside. In other words, the pair of the guide protrusion parts 11a and 11b has a shape that a cone is divided in the axial direction and the vertex is toward inside, and the shape that is continuously lowered and narrowed from outside to inside.

Since the pair of the guide protrusion parts 11a and 11b has such a shape, they can smoothly guide the optical disk 2 inside the housing 3 while they are correcting a shift in the width direction of the optical disk 2 inserted from the disk port 19. In addition, the top cover 5 is provided with the guide protrusion parts 11a and 11b in such a shape, whereby the stiffness of the top plate 5a can be improved. Moreover, the inner main surface of the top plate 5a is processed to reduce the frictional resistance to the optical disk 2.

The bottom case 4 is formed of a sheet metal in a flat box shape. The bottom part has a nearly rectangular shape, and has a deck part 4a on one side surface whose bottom is more raised than the bottom part and protruded outside. The deck part 4a has a loading arm 51, described later, which draws the optical disk 2 into the housing 3, a deck arm 200 which is intended to prevent a wrong optical disk 101 of small diameter from being inserted and to center the optical disk 2 of large diameter, and a regulation arm 212 which controls the energizing force of the deck arm, and all of them are rotatably supported.

On the bottom part of the bottom case 4, electronic components such as IC chips configuring a drive control circuit, connectors which are intended to electrically connect the individual parts to each other, and a circuit board 59 disposed with detection switches that detect the operations of the individual parts, are mounted with screws, for example. On a part of the outer wall of the bottom case 4, a connector opening 4b is disposed which brings the connectors mounted on the circuit board 59 outside.

In addition, on the bottom case 4, the top cover 5 is mounted with screws. More specifically, as shown in FIG. 5, on the outer rim part of the top plate 5a of the top cover 5, a plurality of through holes 13 is formed into which screws 12 are inserted. In addition, on the side plate parts 5b on both sides, a plurality of guide strips 14 is disposed which is bent inward in almost square. On the other hand, as shown in FIG. 3, on the outer rim part of the bottom case 4, a plurality of fixing strips 15 is disposed that is bent inward in almost square. The fixing strips 15 are formed with screw holes 16 corresponding to the through holes 13 of the top cover 5. In addition, on both side surfaces of the bottom case 4, a plurality of guide slits is formed which prevents a plurality of the guide strips 14 of the top cover 5 from disconnecting, although the detail is omitted.

In mounting the top cover 5 on the bottom case 4, the top cover 5 is slid from the front side to the back side in the state in which a plurality of the guide strips 14 of the top cover 5 is engaged in a plurality of the guide slits of the bottom case 4. Thus, the top plate 5a of the top cover 5 is in the state in which the plate blocks the upper opening of the bottom case 4. Then, in the state, the screws 12 are screwed into the screw holes 16 of the bottom case 4 through a plurality of the through holes 13 of the top cover 5. As described above, the housing 3 shown in FIG. 2 is thus configured.

As shown in FIG. 2, a front panel 18 in a rectangular flat plate shape is mounted on the front side of the housing 3. The front panel 18 is disposed with a rectangular disk port 19 through which the optical disk 2 is horizontally inserted in and out. In other words, the optical disk 2 can be inserted from the disk port 19 into the housing 3, or ejected from the disk port 19 to outside the housing 3. The disk port 19 is formed with a panel curtain, not shown, on the both sides in the direction orthogonal to the longitudinal direction. The panel curtain is formed of a nonwoven fabric cut long, for example, which is attached on the back side of the front panel 18 with an adhesive to prevent dust and dirt from entering the housing 3 as well as to remove dust and dirt attached on the optical disk 2 by slidably contacting with the disk surface at the time when the optical disk 2 is inserted and ejected.

In addition, the front side of the front panel 18 is disposed with a display part 20 which indicates the access state to the optical disk 2 with lights, and an eject button 21 which is pressed at the time when the optical disk 2 is ejected.

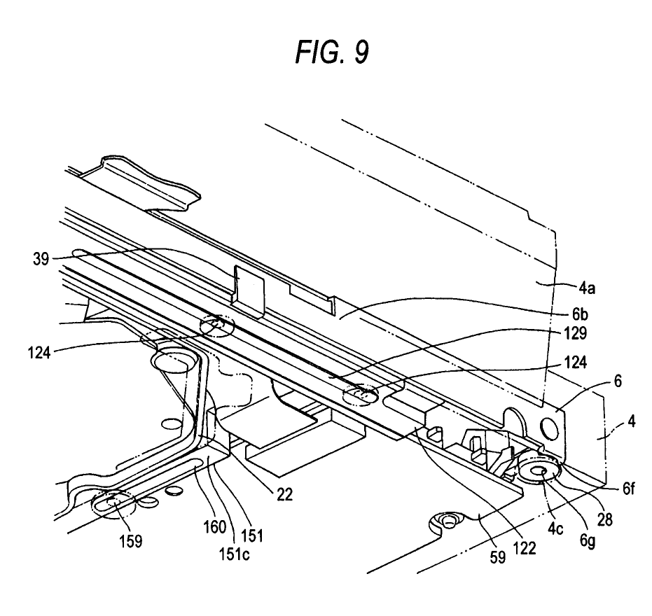

Moreover, near one side surface of the bottom case 4 on which the deck part 4a is disposed, a pair of guide projections 124 and 124 is projected as separated from each other along the one side surface which slides a slider 122 of the drive mechanism 120, described later, along the one side surface (see FIG. 9).

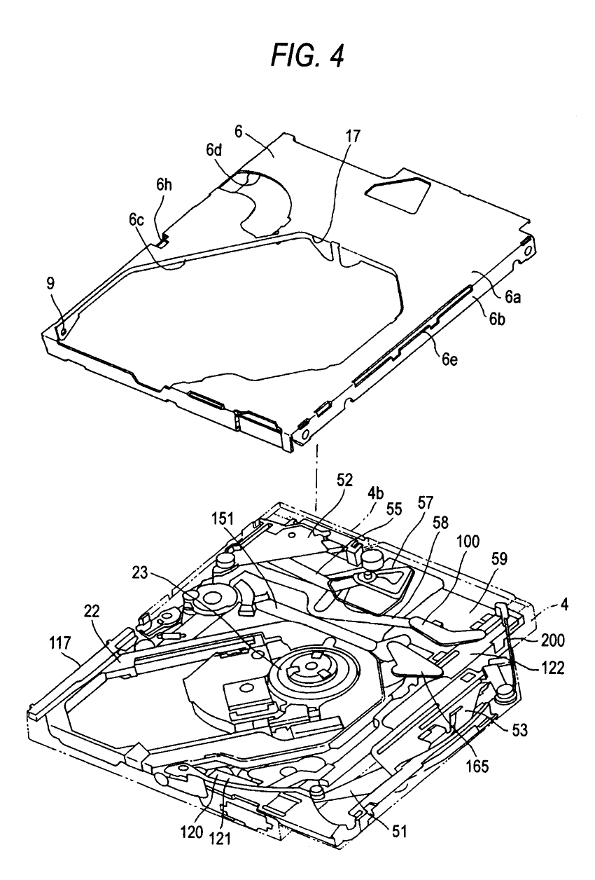

In addition, as shown in FIGS. 3 and 4, the bottom part of the bottom case 4 is mounted with a main chassis 6 with screws. The main chassis 6 is arranged above the circuit board 59 so as to partition the inside of the bottom case 4 at almost the same height as that of the deck part 4a above and below. Thus, the housing 3 has a disk transfer area on the top cover 5 side from the main chassis 6 in which the loading arm 51, the eject arm 52 and the deck arm 200 are rotatably disposed, and has an area on the bottom case 4 side from the main chassis 6 to arrange the drive mechanism 120 having a drive motor 121 and the slider 122, and first and second link arms 54 and 55, an operation arm 58, and a loop cam 57 of the disk transfer mechanism 50 which transmits the drive force of the drive motor 121 to the eject arm 52.

The main chassis 6 is formed of a sheet metal in a flat plate of low profile, and has a top 6a which covers the bottom case 4 from the back side of the bottom case 4 to one side surface where the deck part 4a is formed, and a pair of side plate parts 6b which the rim part of the top 6a is bent along the both side surfaces of the bottom case 4. In addition, on the top 6a, the main chassis 6 is formed with a base opening 6c and an opening 6d for the eject arm which bring the base unit 22 and the eject arm 52 of the disk transfer mechanism 50 over the transfer area of the optical disk 2, and on the side plate part 6b on which the deck part 4a is disposed, the main chassis 6 is formed with a side plate opening 6e into which a loading cam plate 53 is inserted that is joined to the slider 122 slid by the drive motor 121.

The top 6a of the main chassis 6 is retained with the loop cam 57 which guides the movements of the eject arm 52 which transfers the optical disk 2 into or out of the housing 3 on the bottom case 4, the operation arm 58 which transmits the drive force of the drive mechanism 120 to operate the eject arm 52, and the second link arm 55 of the disk transfer mechanism 50. Furthermore, the top 6a has the side edge that is adjacent to the base unit 22 and faced to the disk port 19, and the side edge is formed into an edge part 17 on which a pickup part 90 and a second pickup part 250 disposed on the eject arm 52, described later, are slid.

Moreover, on the side wall that is on the back side of the housing 3 in which the loop cam 57 is retained and that is near the corner part on the other side surface on which the eject arm 52 and the first and second link arms 54 and 55 are disposed, the main chassis 6 is formed with an retaining part 98 in which a tensile coil spring 56 is retained that energizes the eject arm 52 in the eject direction of the optical disk 2 through the first link arm 54.

In addition, on the side plate part 6b on both sides, the main chassis 6 is formed with a plurality of guide strips 6f, and a through hole 6g through which the bottom case 4 is fixed. On the other hand, the bottom case 4 is formed with a screw hole 4c at the position corresponding to the through hole 6g. A screw is screwed into the screw hole 4c and the through hole 6g to fix the main chassis 6.

Furthermore, near the opening 6d for the eject arm, the main chassis 6 is formed with an opening 6h for guiding of centering through which a guide strip 221 of a centering guide 220, described later, is projected.

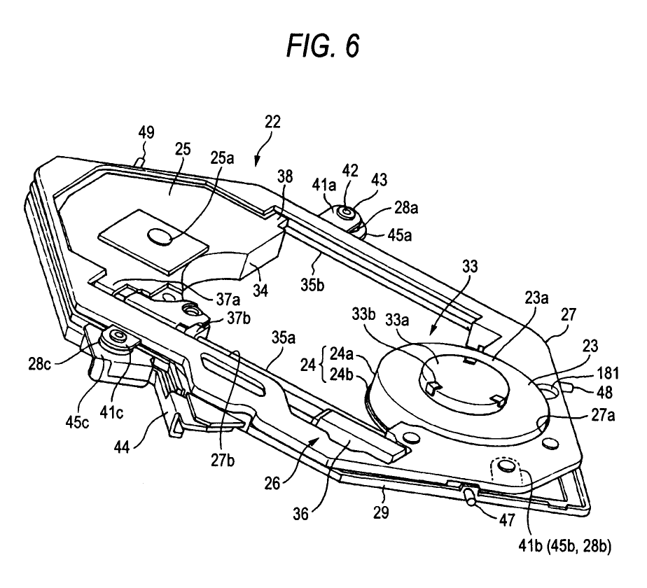

The disk drive apparatus 1 has the base unit 22 which configures the drive main body on the bottom part of the bottom case 4. As shown in FIG. 6, the base unit 22 has a base chassis 27 formed of a frame body in a nearly rectangular shape, and the base chassis 27 is supported by a subchassis 29 through a plurality of dampers 28a to 28c. The base chassis 27 is disposed on the bottom case 4 through the subchassis 29, whereby one end side in the longitudinal direction of the base unit 22 is positioned nearly on the center of the housing 3. On one end side of the longitudinal direction, the base unit 22 has a disk mounting part 23 on which the optical disk 2 is mounted that is inserted from the disk port 19 into the housing 3, and a disk rotating drive mechanism 24 which rotates and drives the optical disk 2 mounted on the disk mounting part 23. In addition, the base unit 22 has an optical pickup 25 which writes or reads signals out of the optical disk 2 rotated and driven by the disk rotating drive mechanism 24, and a pickup carry mechanism 26 which carries the optical pickup 25 across the longitudinal direction to transfer in the radial direction of the optical disk 2. They are disposed in one piece in the base chassis 27. The base chassis 27 is supported by the subchassis 29, whereby the base unit 22 is moved up and down to the optical disk 2 along with the subchassis 29 by means of a base ascending/descending mechanism 150, described later.

The base unit 22 is brought over the disk transfer area through the base opening 6c of the main chassis 6 so that the disk mounting part 23 is positioned nearly on the center in the bottom part of the bottom case 4. The base unit 22 is movable up and down by the base ascending/descending mechanism 150, described later. In the initial state, the base unit is positioned lower than the optical disk 2 inserted from the disk port 19 into the housing 3, and it is moved upward in association with the loading operation of the optical disk 2, and engaged in the optical disk 2 to be rotated. After the recording/reproducing operation, the base unit 22 is moved downward by the base ascending/descending mechanism 150, it is released of the engagement in the optical disk 2, and retracted from the transfer area of the optical disk 2.

The base chassis 27 is formed in such a way that a sheet metal is punched out in a predetermined shape and the rim part is bent slightly downward. The main surface of the base chassis 27 is continuously formed with an almost half-round opening 27a for the table which brings the turntable 23a of the disk mounting part 23, described later, upward, and an opening 27b for the pickup in a nearly rectangular shape which brings an objective lens 25a of the optical pickup 25, described later. Moreover, as shown in FIG. 3, the top part of the base chassis 27 is mounted with a decorative sheet 30 which has openings corresponding to the openings 27a and 27b.

In addition, on the end part on the opposite side of the disk mounting part 23, the base chassis 27 is formed with a guide plate 32 which prevents the contact between the optical disk 2 and the base chassis 27 and leads the optical disk 2 to a support part 88 of the eject arm 52. The guide plate 32 is attached with a fabric sheet, not shown, which can prevent the signal recording surface of the optical disk 2 from being damaged even though the optical disk 2 is slidably contacted therewith.

In addition, on the both side surfaces in the longitudinal direction, the base chassis 27 has coupling strips 41a and 41b which are coupled to the subchassis 29 through the dampers 28a and 28b, as the coupling strips are projected. Each of the coupling strips 41a and 41b is perforated with an insertion hole 43 which is connected to coupling strips 45a and 45b formed in the subchassis 29 and a step screw 42 is inserted therethrough.

The disk mounting part 23 has the turntable 23a which is rotated and driven by the disk rotating drive mechanism 24, and on the center part of the turntable 23a, a chucking mechanism 33 is disposed which mounts the optical disk 2. The chucking mechanism 33 has an engaging protrusion part 33a which is engaged in the center hole 2a of the optical disk 2, and a plurality of retaining hooks 33b which retains the rim part of the center hole 2a of the optical disk 2 engaged in the engaging protrusion part 33a, and the chucking mechanism holds the optical disk 2 on the turntable 23a.

The disk rotating drive mechanism 24 has a flat spindle motor 24a which rotates and drives the optical disk 2 in one piece with the turntable 23a. The spindle motor 24a is screwed on the under side of the base chassis 27 through a supporting plate 24b so that the turntable 23a mounted on the top part is slightly protruded from the opening 27a for the table of the base chassis 27.

The optical pickup 25 has an optical block which collects light beams emitted from a semiconductor laser to be a light source by means of the objective lens 25a, applies them onto the signal recording surface of the optical disk 2, and detects the returning light beams reflected in the signal recording surface of the optical disk 2 by means of a photodetector formed of a light receiving device, for example, and the optical pickup is configured to write or read signals from the optical disk 2.

In addition, the optical pickup 25 has an objective lens drive mechanism such as a two-axial actuator which displaces and drives the objective lens 25a in the optical axis direction (referred to as a focusing direction) and in the direction orthogonal to the recording tracks of the optical disk (referred to as a tracking direction), and the optical pickup is configured to control the drive of a focus servo and a tracking servo, the focus servo in which based on detection signals from the optical disk 2 detected by the photodetector described above, the objective lens 25a is brought into focus on the signal recording surface of the optical disk 2 while the two-axial actuator is displacing the objective lens 25a in the focusing direction and in the tracking direction, and the tracking servo causes the spot of the light beams collected by the objective lens 25a to follow the recording tracks. Moreover, for the objective lens drive mechanism, in addition to such focusing control and tracking control, a three-axis actuator may be used which can adjust the slope of the objective lens 25a (skew) with respect to the signal recording surface of the optical disk 2 so that the light beams collected by the objective lens 25a are vertically applied onto the signal recording surface of the optical disk 2.

The pickup carry mechanism 26 has a pickup base 34 on which the optical pickup 25 is mounted, a pair of the guide shafts 35a and 35b which slidably supports the pickup base 34 in the radial direction of the optical disk 2, and a displacement drive mechanism 36 which displaces and drives the pickup base 34 supported by the pair of the guide shafts 35a and 35b in the radial direction of the optical disk 2.

The pickup base 34 has a pair of guide strips 37a and 37b which is formed with a guide hole through which the guide shaft 35a of the pair of the guide shafts 35a and 35b is inserted, and a guide strip 38 which is formed with guide grooves that sandwich the guide shaft 35b, and the strips are protruded from the side surfaces opposite to each other. Thus, the pickup base 34 is slidably supported by the pair of the guide shafts 35a and 35b.

The pair of the guide shafts 35a and 35b is arranged on the under side of the base chassis 27 in parallel with the radial direction of the optical disk 2, and guides the pickup base 34 in which the optical pickup 25 is brought through the pickup opening 27b of the base chassis 27 across the optical disk 2 from the inner to the rim part.

The displacement drive mechanism 36 is a mechanism that converts the rotation and drive of a drive motor 31 mounted on the base chassis 27 into linear drive through a gear or a rack (not shown) to drive and displace the pickup base 34 in the direction along the pair of the guide shafts 35a and 35b, that is, in the radial direction of the optical disk 2, and a stepping motor having a lead screw, for example, is used.

Next, the subchassis 29 which supports the base chassis 27 through the damper 28 will be described. The subchassis 29 is one that is moved up and down by the base ascending/descending mechanism 150, described later, in accordance with the transfer of the optical disk 2, whereby it brings the base chassis 27 to be close to or separated from the optical disk 2. The subchassis 29 has almost the same shape as the outer shape of the base chassis 27, and is formed of a frame body in a nearly rectangular shape slightly greater than the base chassis 27, and the chassis is coupled to the base chassis 27 to configure the base unit 22 in one piece with the base chassis 27. The subchassis 29 is disposed along the side surface on which the guide shaft 35a is disposed, and a reinforcement chassis 44 which reinforces the subchassis 29 is mounted in one piece. In addition, the subchassis 29 is formed with the coupling strips 45a and 45b on which the dampers 28a and 28b are mounted and are coupled to the base chassis 27. The coupling strip 45a is arranged at the position corresponding to the coupling strip 41a of the base chassis 27 on one side surface across the longitudinal direction, and the coupling strip 45b is protruded at the end part on the disk mounting part 23 side on the other side surface across the longitudinal direction at the position corresponding to the coupling strip 41b of the base chassis 27.

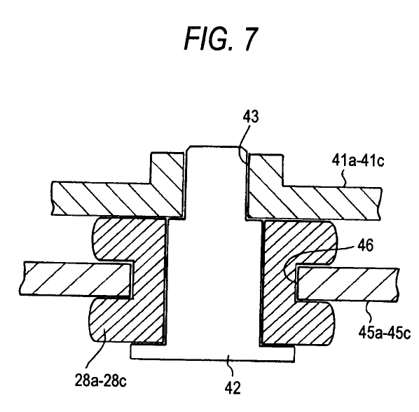

Moreover, at the end part on the opposite side of the disk mounting part 23 on the other side surface in the longitudinal direction, the coupling strip is not formed on the subchassis 29, and a coupling strip 45c is disposed on the reinforcement chassis 44 fixed to the subchassis 29 as corresponding to the coupling strip 41c of the base chassis 27. As shown in FIG. 7, in each of the coupling strips 45a to 45c, an insertion hole 46 is perforated which is connected to the insertion hole 43 of each of the coupling strip 41a to 41c of the base chassis 27. The coupling strips 45a to 45c are mounted with the dampers 28a to 28c, respectively, the coupling strips are coupled to the coupling strips 41a to 41c of the base chassis 27 through the dampers 28a to 28c, and the step screws 42 are inserted into the insertion holes 43 and 46.

In addition, as shown in FIG. 6, the subchassis 29 has a first support shaft 47 which is positioned on the disk mounting part 23 side of the side surface facing to the slider 122, described later, and engaged and supported by a first cam slit 130 of the slider 122, a second support shaft 48 which is positioned on the disk mounting part 23 side of the side surface facing to a subslider 151 and engaged and supported by a second cam slit 170 of the subslider 151, and a third support shaft 49 which is positioned on the front side of the side surface on the opposite side of the side surface facing to the slider 122, and is rotatably supported in a shaft hole 9 disposed on the side plate part 6b of the main chassis 6.

Therefore, in the subchassis 29, the first support shaft 47 is slid inside the first cam slit 130 as interlocked with the slide of the slider 122 and the subslider 151 as well as the second support shaft 48 slides inside the second cam slit 170, whereby the subchassis on the disk mounting part 23 side is rotated as it is pivoted about the third support shaft 49 to move the base chassis 27 up and down.

In addition, as shown in FIG. 3, on the bottom part of the bottom case 4, a support pin 10 is erected which prevents the eject arm 52 from bending downward when the eject arm 52, described later, rotates near the disk mounting part 23. The support pin 10 prevents such an event that the eject arm 52 bends downward to cause the optical disk 2 to collide against the disk mounting part 23 and to damage it. The support pin 10 is positioned near the disk mounting part 23 of the base unit 22, protruded upward from the bottom part of the bottom case 4, inserted into an insertion hole 30a perforated in a the decorative sheet 30, and brought over the disk transfer area.

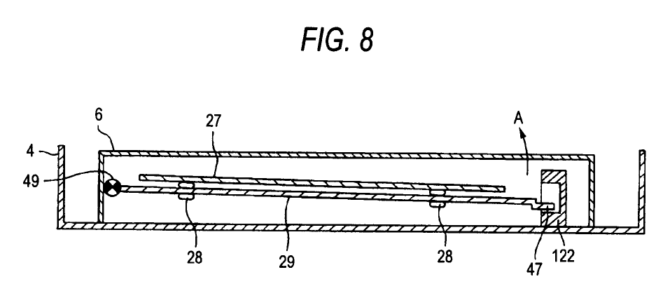

As shown in a schematic diagram in FIG. 8, the base unit 22 having this configuration is moved up and down in the direction of arrow A and in the reverse direction of arrow A. At this time, the base chassis 27 is in the state in which it is supported only by the subchassis 29 through the individual dampers 28, and all the paths, through which external vibrations are transmitted, pass through the subchassis 29 having the dampers 28, whereby the resistance to an impact is improved. In addition, no excess weight is applied to the base chassis 27, including the individual dampers 28. In other words, since the base chassis is light because dampers do not have the total weight as the target to which an impact is transmitted, the resistance to an impact is further improved.

Moreover, the disk drive apparatus 1 may be fixed through the dampers when the main chassis 6 is fixed to the bottom case 4. More specifically, as shown in FIG. 9, for the main chassis 6, the damper 28 is provided between each of the guide strips 6f and the screw holes 4c of the bottom case 4, and is fixed with a step screw.

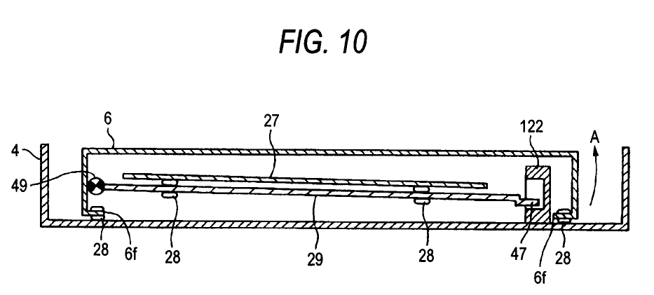

As shown in a schematic diagram in FIG. 10, in the base unit 22 thus fixed, the subchassis 29 is supported by the main chassis 6, and the main chassis 6 is fixed through the bottom case 4 and the damper 28. At this time, the base chassis 27 is supported only by the subchassis 29 through the dampers 28a to 28c, the subchassis 29 is supported by the main chassis 6, and the main chassis 6 is fixed through the bottom case 4 and the damper 28. In the state, the path through which external vibrations are transmitted passes through the main chassis 6 having the dampers 28 and the subchassis 29 having the dampers 28a to 28c, and the path passes through the dampers arranged in two stages, whereby the resistance to an impact is further improved.

In addition, as shown in FIG. 9, between approximately the middle part of the side plate part 6b of the main chassis 6 and the bottom case 4, a cushioning material 39 may be disposed. The cushioning material 39 is formed of an elastic member such as a thin rubber piece which blocks the path through which an impact is transmitted by direct contact of the side plate part 6b with the bottom case 4 caused by the amplitude of vibrations of the impact. In the cushioning material 39, an adhesive layer is formed its one side, and the adhesive layer is attached to the side plate part 6b of the main chassis 6.

Thus, the clearance between the bottom case 4 and the main chassis 6 is narrowed, and even though the main chassis 6 is connected to inside the bottom case 4 through the damper 28, such an event can be prevented that the side plate part 6b of the main chassis 6 is contacted with the bottom case 4, and disturbance is transmitted to the main chassis 6 and the base chassis 27 through this contact part.

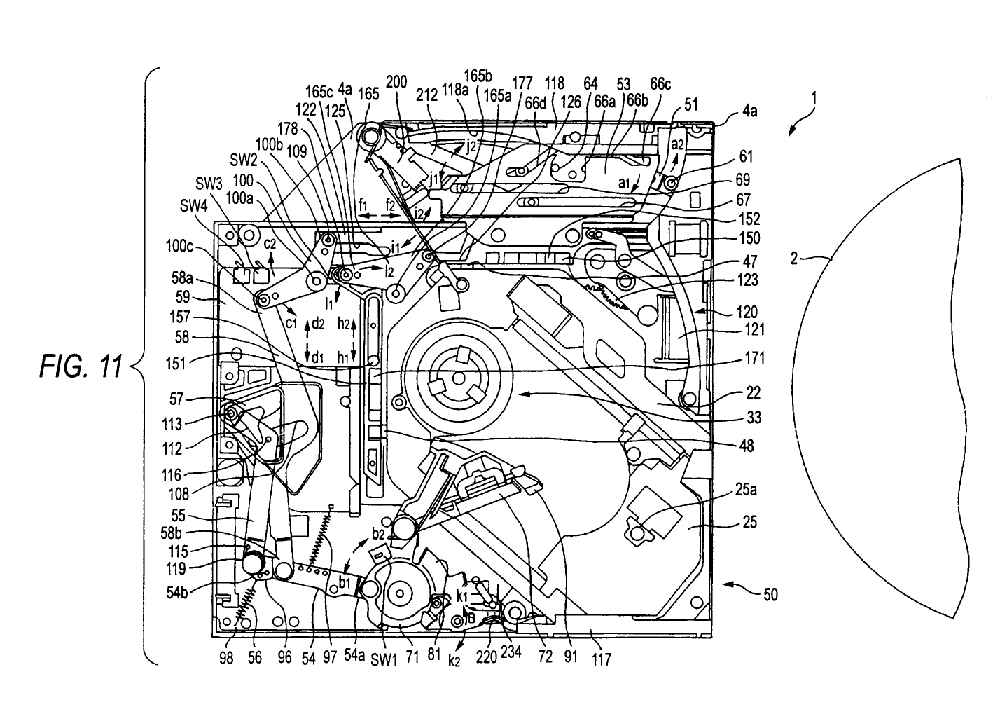

As shown in FIGS. 11 to 19, the disk drive apparatus 1 has the disk transfer mechanism 50 which transfers the optical disk 2 between the disk insertion/eject position at which the optical disk 2 is inserted or ejected from the disk port 19 and the disk mounting position at which the optical disk 2 is mounted on the turntable 23a of the disk mounting part 23.

The disk transfer mechanism 50 has the following members as support members moved between the top 6a of the main chassis 6 and the main surface facing to the disk mounting part 23 of the top plate 5a: the loading arm 51 and the eject arm 52 which can rock in the plane in parallel with the main surface of the optical disk 2, the loading cam plate 53 which transmits the drive force from the drive mechanism 120, described later, to the loading arm 51, the first link arm 54 which is engaged in the eject arm 52 and rotates the eject arm 52 in the eject direction of the optical disk 2, the second link arm 55 which is coupled to the first link arm 54, the tensile coil spring 56 which is spanned between the first link arm 54 and the main chassis 6, the loop cam 57 which is engaged in a guide projecting part 113 of the second link arm 55 and guides the second link arm 55, and the operation arm 58 which is coupled to the drive mechanism 120 and moves the first link arm 54 in the direction in which the eject arm 52 inserts or ejects the optical disk 2.

In the disk transfer mechanism 50, the optical disk 2 is inserted from the disk port 19 to rotate the eject arm 52 to a predetermined position, and then the loading arm 51 automatically draws the optical disk 2 to the disk mounting part 23, whereas the eject arm 52 is rotated to the front side of the housing 3, and then the optical disk 2 is ejected. More specifically, in the disk transfer mechanism 50, during time which the optical disk 2 is inserted and the eject arm 52 is rotated to a predetermined position to start the drawing operation, a rotating support member 71 of the eject arm 52 is rotated to a left guide wall 117 of the housing 3, the guide projecting part 113 formed at the tip end part of the second link arm 55 is guided by the loop cam 57, and then the first link arm 54 of the rotating support member 71 is moved in the direction different from the rotating direction of an engagement hole 80 in which the first link arm is engaged. Therefore, the movement of the first link arm 54 coupled to the rotating support member 71 and the second link arm 55 restricted, the tensile coil spring 56 spanned between the first link arm 54 and the main chassis 6 is extended, and then the eject arm 52 is rotated in the insertion direction while it is being energized in the eject direction.

In addition, in the disk transfer mechanism 50, during the drawing operation of the optical disk 2, the guide projecting part 113 of the second link arm 55 is guided by the loop cam 57, and then the first link arm 54 of the rotating support member 71 is moved in the same direction as the rotating direction of the engagement hole 80 in which the first link arm is engaged. Thus, the extended tensile coil spring 56 is contracted, and the energizing force of the eject arm 52 in the eject direction is reduced.

Furthermore, in the disk transfer mechanism 50, in ejecting the optical disk 2, the guide projecting part 113 of the second link arm 55 is guided by the loop cam 57, and then the first link arm 54 of the rotating support member 71 of the eject arm 52 being rotated in the eject direction of the optical disk 2 is moved in the same direction as the rotating direction of the engagement hole 80 in which the first link arm is engaged. Thus, in the state in which the energizing force caused by the tensile coil spring 56 does not work, the eject arm 52 is rotated to eject the optical disk 2.

Therefore, in the inserting step in which the optical disk 2 is inserted to a predetermined position by a user, since the tensile coil spring 56 is extended to work the energizing force in the eject direction, even in the case in which a user stops inserting the optical disk 2, such an event can be prevented that the optical disk 2 is left as it is inserted into the housing 3 halfway. In addition, in the step of drawing the optical disk 2 by the loading arm 51, since the tensile coil spring 56 is contracted to release the energizing force working on the eject arm 52 in the eject direction, the drawing operation can be performed smoothly. Moreover, in the step of ejecting the optical disk, since such a state is maintained in which the first link arm 54 is brought close to the retaining part of the main chassis 6 and the tensile coil spring 56 is contracted, the energizing force is not worked that is applied to the eject arm 52 by the tensile coil spring 56 in the eject direction, and the eject arm 52 is rotated in accordance with the operation of the operation arm 58 receiving the drive force of the drive mechanism 120. Thus, the optical disk 2 can be stably ejected at a predetermined stop position at which the center hole 2a of the optical disk 2 is brought outside the housing 3 without relying on the elastic force.

Hereinafter, the components of the disk transfer mechanism 50 will be described in detail.

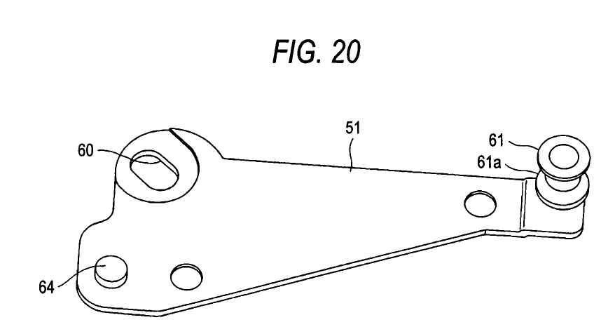

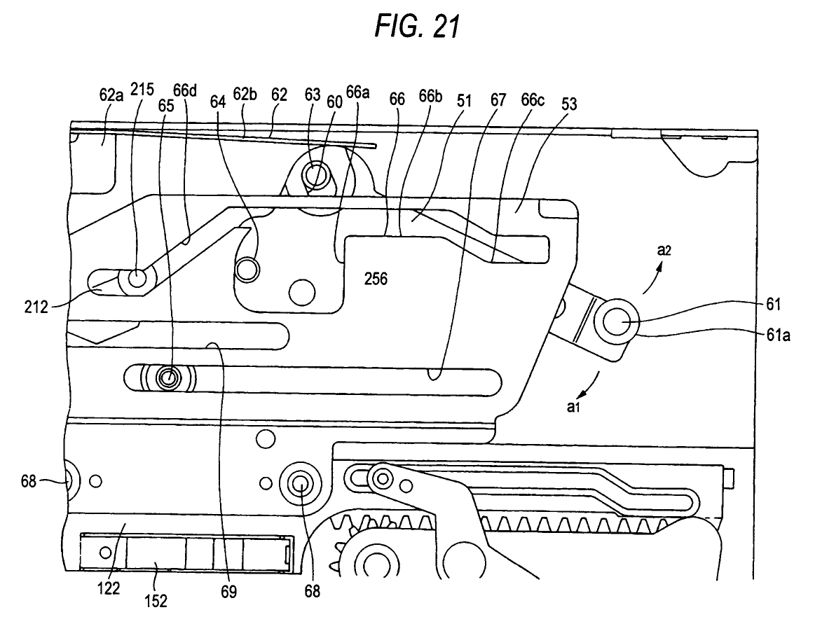

The loading arm 51 is one that draws the optical disk 2 over the disk mounting part 23, in which the base end part is rotatably supported on the deck part 4a of the bottom case 4 at the position more on the disk port 19 side than the disk mounting part 23 is located, and the tip end part is rotatable in the directions of arrows a₁ and a₂ in FIG. 11. More specifically, as shown in FIGS. 20 and 21, the loading arm 51 has an arm main body 51a formed of a flat plate sheet metal. An insertion hole 60 is protruded on one end part of the arm main body 51a, and a nearly cylindrical rotating support member 63 protruded from the deck part 4a is engaged in the insertion hole 60, whereby the loading arm is rotatably supported over the deck part 4a in the direction of arrow a₁ in which the optical disk 2 is loaded and in the direction of arrow a₂ in which the optical disk 2 is ejected in FIG. 21 as it is pivoted about rotating support member 63.

In addition, the insertion hole 60 is formed in a long hole. Therefore, the loading arm 51 is rotated in the directions of arrow a₁ and arrow a₂ in the same drawing while it is moving along the insertion hole 60. Thus, as described later, in the steps of inserting and drawing the optical disk 2 and of ejecting it, the loading arm 51 absorbs a shift of the timing of rotation that occurs between it and the eject arm 52 in accordance with the stroke of the slider 122, and it can smoothly insert and eject the optical disk 2.

In addition, the loading arm 51 has an abutting part 61 which is protruded upward at the tip end part of the arm main body 51a and abuts against the rim part of the optical disk 2 inserted from the disk port 19. The abutting part 61 is rotatably mounted with a rotating roller 61a of small diameter. In addition, the abutting part 61 is formed of a resin softer than the optical disk 2, and has a nearly hourglass shape as a flange to restrict the movement of the optical disk 2 in the height direction, in which the center part is bent inside that abuts against the rim part of the optical disk 2 inserted from the disk port 19 and both end parts are widened in diameter.

In addition, by pushing the vicinity of the insertion hole 60 sideward by means of a plate spring 62, the loading arm 51 is always rotationally energized with the energizing force of the plate spring 62 in the direction of arrow a₁ in FIG. 21 in which the optical disk 2 is energized from the disk port 19 side to on the disk mounting part 23 side as it is pivoted about the insertion hole 60. The plate spring 62 which energizes the loading arm 51 is formed of a base part 62a which is fixed on the deck part 4a, and an arm part 62b which is extended from one end of the base part 62a and energizes the loading arm 51.

Furthermore, the loading arm 51 has an engagement projecting part 64 which is projected thereon and is inserted and engaged in a first cam groove 66 of the loading cam plate 53, described later. The engagement projecting part 64 is moved along the first cam groove 66 of the loading cam plate 53, whereby the loading arm 51 is rotated while it is restricting the energizing force of the plate spring 62.

The loading cam plate 53 is formed of a flat plate sheet metal. It is engaged in the slider 122 of the drive mechanism 120, described later, and then it is moved over the deck part 4a to and fro in association with the movement of the slider 122, whereby it rotates the regulation arm 212 which restricts the energizing force of the loading arm 51 and the deck arm 200, described later. The loading cam plate 53 is overlaid on the loading arm 51 and the regulation arm 212 rotatably supported on the deck part 4a, and it is inserted therethrough with the engagement projecting part 64 of the loading arm 51 and a rotating guide part 215 of the regulation arm 212, whereby it restricts the rotation of the loading arm 51 and the regulation arm 212 in accordance with the insertion and ejection of the optical disk 2.

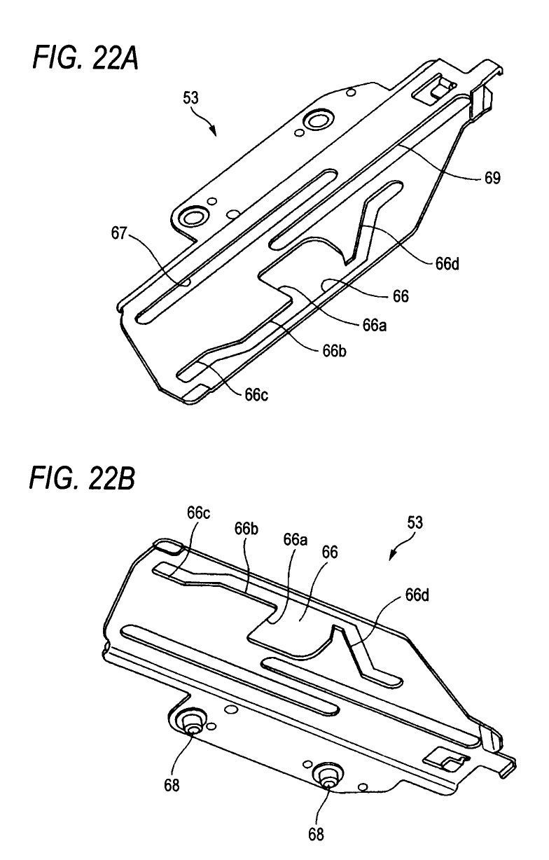

As shown in FIGS. 22A and 22B, the loading cam plate 53 is formed with the first cam groove 66 through which the engagement projecting part 64 projected on the loading arm 51 and the rotating guide part 215 of the regulation arm 212 are inserted, a second cam groove 67 through which the guide projecting part 65 projected on the deck part 4a is inserted, a pair of engagement projections 68 and 68 which are engaged in the slider 122, and a third cam groove 69 through which a rotating support pin 217 is inserted that rotatably supports the regulation arm 212 on the deck part 4a.

The first cam groove 66 restricts the rotation of the loading arm 51 energized in the loading direction of the optical disk 2 with the plate spring 62 by sliding the engagement projecting part 64, as well as it rotates the regulation arm 212 and controls the energizing force of a coil spring 203 retained on the deck arm 200 by sliding the rotating guide part 215.

As shown in FIGS. 11 and 21, the first cam groove 66 is formed of a first guide part 66a which restricts the engagement projecting part 64 and rotates the loading arm 51 in the direction of arrow a₁ in FIG. 11 that is the direction of drawing the optical disk 2, a second guide part 66b which is adjacent to the first guide part 66a and continuously formed therefrom, and restricts the rotating position of the loading arm 51 to support the optical disk 2 at the centering position, a third guide part 66c which is continuously formed from the second guide part 66b and guides the engagement projecting part 64 so that the engagement projecting part is rotated in the direction of arrow a₂ in FIG. 11 as it is separated from the outer rim part of the optical disk 2 at which the loading arm 51 is mounted on the disk mounting part 23, and a fourth guide part 66d which is disposed on the opposite side of the second guide part 66b through the first guide part 66a and guides the rotating guide part 215 to rotate the regulation arm 212.

The first guide part 66a is formed in the direction almost orthogonal to the moving direction of the loading cam plate 53. By moving the loading cam plate 53 in the direction of arrow f₁ on the back side of the housing 3 therein, it abuts against the engagement projecting part 64 from the front side, and it rotates the loading arm 51 in the direction of arrow a₁ in FIG. 11. The second guide part 66b is formed almost in parallel with the moving direction of the loading cam plate 53, it restricts the rotation of the loading arm 51 which is rotated by the first guide part 66a in the direction of arrow a₁ in which the optical disk 2 is drawn, and centers the optical disk 2. The third guide part 66c is bent on the inner side of the housing 3 more than the second guide part 66b, and guides the engagement projecting part 64 to separate the loading arm 51 from the side surface of the optical disk 2 mounted on the disk mounting part 23 to rotate the optical disk 2. The fourth guide part 66d guides the rotating guide part 215 of the regulation arm 212, rotates the regulation arm 212 in accordance with the slide of the loading cam plate, and controls the energizing force caused by the deck arm 200, described later.

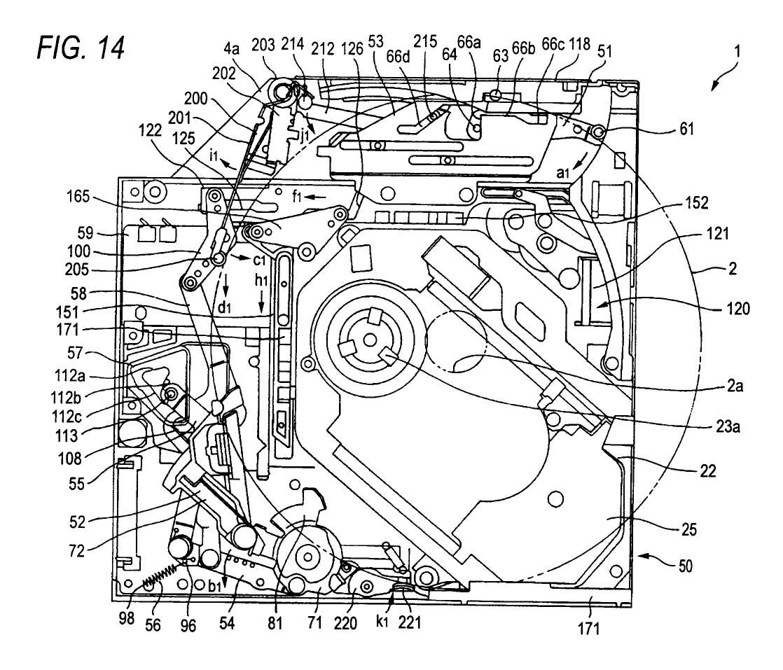

As shown in FIG. 11, in the state in which the optical disk 2 is waited to insert, in the first cam groove 66, the first guide part 66a is separated from the engagement projecting part 64, and the engagement projecting part 64 of the loading arm 51 abuts against the side surface facing to the first guide part 66a, and the loading arm 51 is rotated and energized by the plate spring 62 in the direction of arrow a₁. Thus, the loading cam plate 53 is to position the loading arm 51 in the state in which the optical disk 2 is waited to insert. When the optical disk 2 is inserted into the housing 3 and the loading cam plate 53 is moved on the back side of the housing 3 by the slider 122, as shown in FIG. 14, in the first cam groove 66, the engagement projecting part 64 abuts against the first guide part 66a, and the loading arm 51 is rotated in the direction of arrow a₁ in FIG. 14 that is the direction of drawing the optical disk 2.

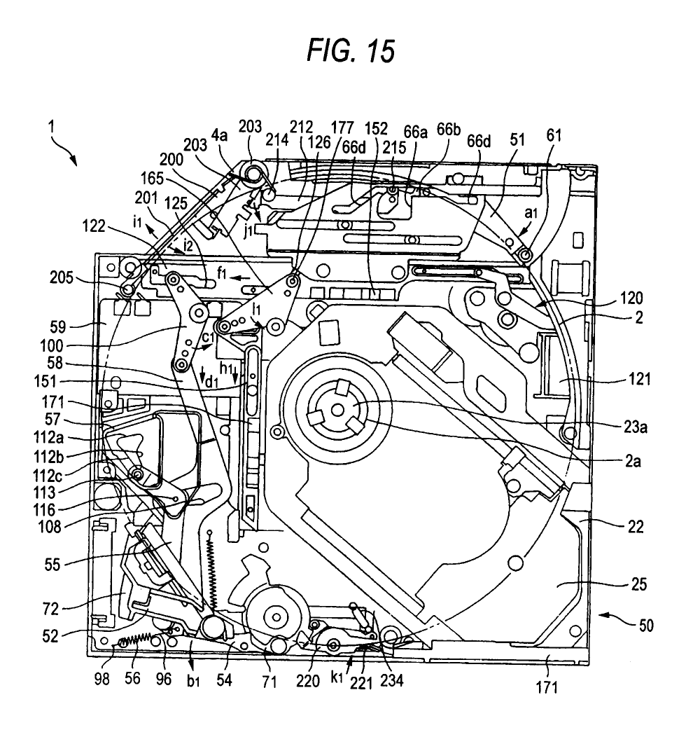

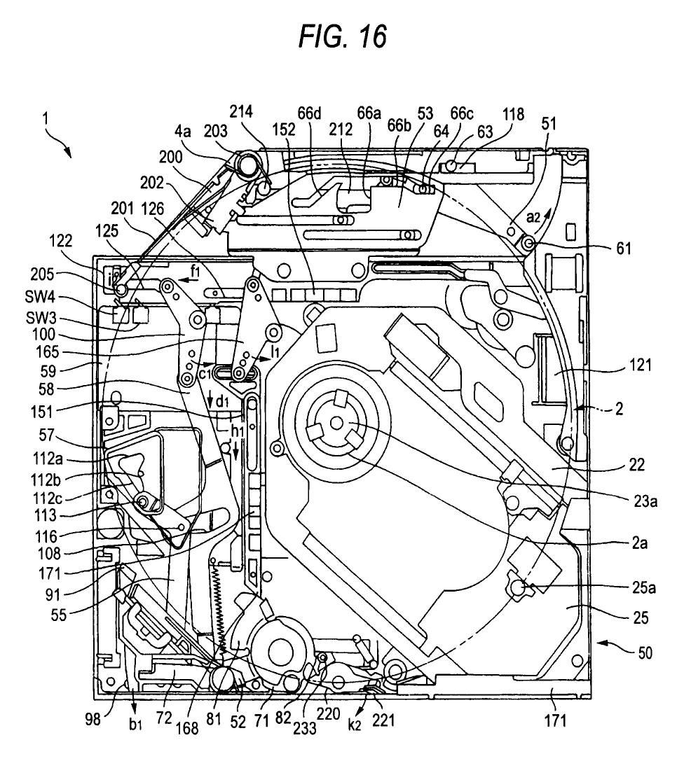

When the center hole 2a of the optical disk 2 is transferred and positioned over the turntable 23a of the disk mounting part 23, in the first cam groove 66, as shown in FIG. 15, the engagement projecting part 64 enters the second guide part 66b. For the loading arm 51, since the relative angle between the engagement projecting part 64 and the insertion hole 60 is not changed in the second guide part 66b, the abutting part 61 is not rotated in the direction of arrow a₁ to support the optical disk 2 at the centering position. After that, when the chucking of the optical disk 2 is finished, as shown in FIG. 16, in the first cam groove 66, the engagement projecting part 64 is guided by the third guide part 66c, and is rotated in the direction of arrow a₂ in FIG. 16 in which the loading arm 51 is separated from the optical disk 2.

In addition, in the first cam groove 66, when the loading cam plate 53 is moved on the back side of the housing 3, the rotating guide part 215 of the regulation arm 212 is guided by the fourth guide part 66d for rocking. A spring retaining part 214 is moved which is retained on an end 203b of the coil spring 203 that rotates and energizes the deck arm 200, and such an event is prevented that the energizing force is increased as the optical disk 2 is being inserted into the housing 3.

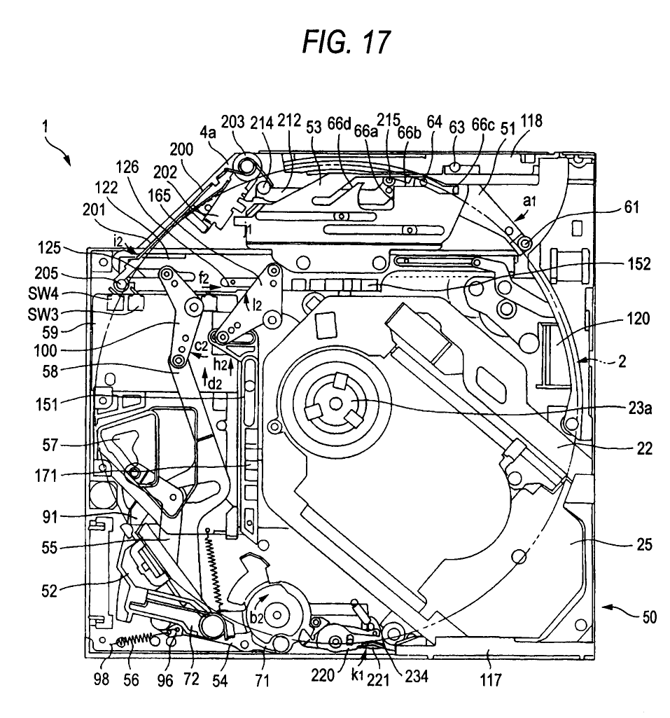

In ejecting the optical disk 2, when the loading cam plate 53 is moved in the same direction as the direction of arrow f₂ in accordance with the slider 122 being moved in the direction of arrow f₂ on the front side, as shown in FIG. 17, the engagement projecting part 64 is moved from the third guide part 66c to the second guide part 66b. Thus, the loading arm 51 is rotated in the direction of arrow a₁ in FIG. 17 that is the loading direction of the optical disk 2, and the abutting part 61 abuts against the side surface of the optical disk 2 from the front side.

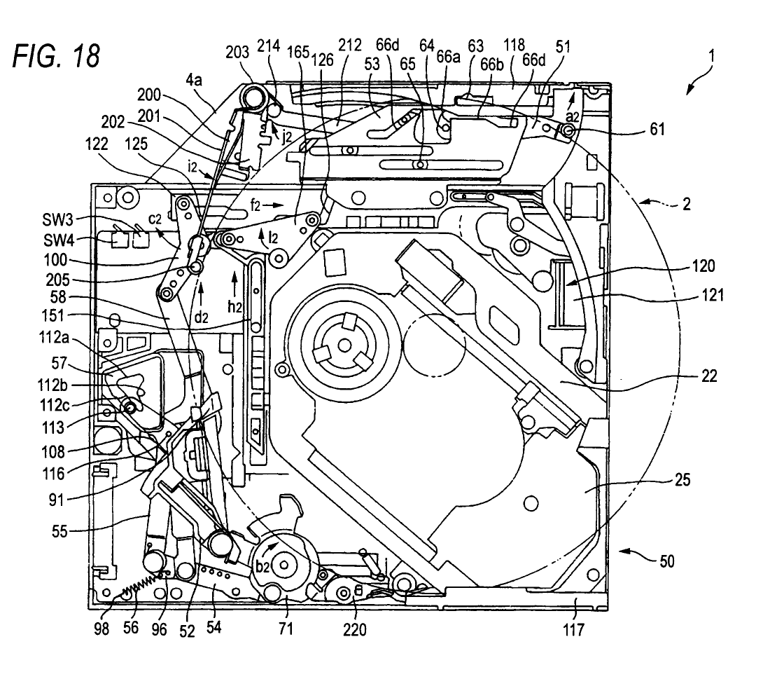

Furthermore, when the loading cam plate 53 is moved in the direction of arrow f₂ and the engagement projecting part 64 is moved from the second guide part 66b to the first guide part 66a, as shown in FIG. 18, for the loading arm 51, the abutting part 61 is allowed to rotate in the direction of arrow a₂ as the first guide part 66a is moved in the direction of arrow f₂. The drive force of the drive mechanism 120 is applied to the eject arm 52, whereby the eject arm is rotated in the direction of arrow b₂ in which the optical disk 2 is ejected. Therefore, the loading arm 51 is pressed against the optical disk 2 being transferred in the eject direction, whereby the loading arm is rotated in the direction of arrow a₂.

At this time, the loading arm 51 is rotated while it is being energized by the plate spring 62 in the direction of arrow a₁ that is the insertion direction of the optical disk 2. Thus, in ejecting the optical disk 2, the disk transfer mechanism 50 pushes the optical disk 2 to a predetermined eject position as the optical disk is clamped between the loading arm 51 and the eject arm 52, whereby the loading arm 51 can prevent a sudden eject of the optical disk 2.

Moreover, when the loading arm 51 finishes ejecting the optical disk 2, as shown in FIG. 11, the engagement projecting part 64 is retained on the side surface facing to the first guide part 66a of the first cam groove 66 of the loading cam plate 53, whereby the rotation in the direction of arrow a₁ is restricted, and the optical disk 2 is waited to insert.

The second cam groove 67 is inserted into the guide projecting part 65 projected on the deck part 4a, and then it guides the movement of the loading cam plate 53. The second cam groove 67 is a straight cam groove in parallel with the moving direction of the slider 122, and it guides the loading cam plate 53 in the moving direction of the slider 122 by sliding the guide projecting part 65 in association with the movement of the slider 122.

The pair of the engagement projections 68 and 68 which are engaged in the slider 122 is formed on one side surface of the loading cam plate 53 side as separated from each other. The engagement projections 68 and 68 are projected downward, and are overhung on the bottom part on the bottom case 4 side, whereby they are engaged in engagement recesses 127 and 127 of the slider 122 which are arranged along the side surface of the bottom case 4. Thus, the loading cam plate 53 and the slider 122 are formed in one piece, and the loading cam plate 53 is also slid in association with the movement of the slider 122.

Moreover, the loading cam plate 53 is prevented from floating from the deck part 4a in such a way that the other side surface on the opposite side of one side surface having the engagement projections 68 and 68 formed thereon is slidably inserted into a clearance formed between a right guide wall 118 and the deck part 4a.

In addition, the third cam groove 69 is inserted into the rotating support pin 217 which is erected on the deck part 4a and rotatably supports the regulation arm 212 on the deck part 4a. As similar to the second cam groove 67, the third cam groove 69 is a straight cam groove in parallel with the moving direction of the slider 122, and it is slid by the rotating support pin 217 in association with the movement of the slider 122 to guide the loading cam plate 53 in the moving direction of the slider 122.

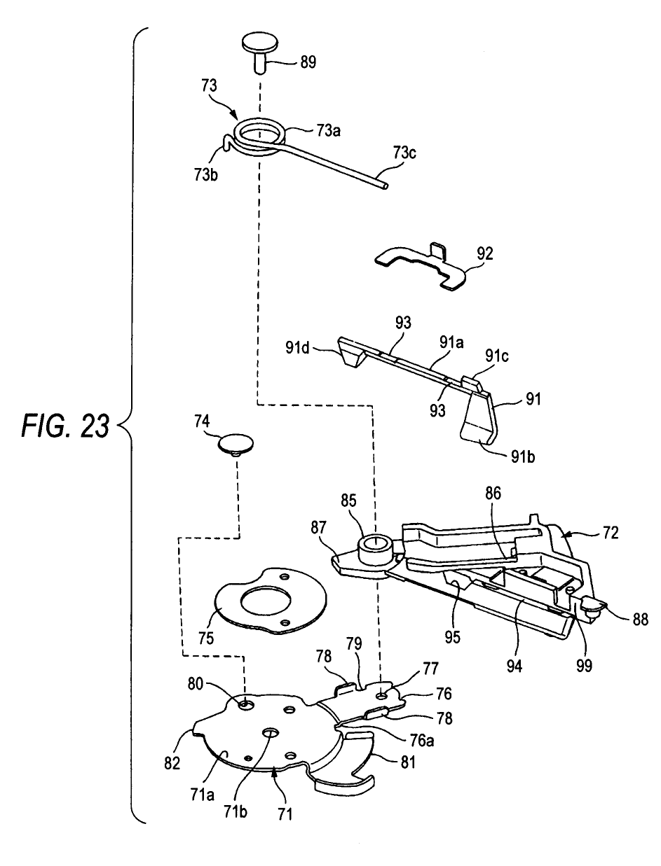

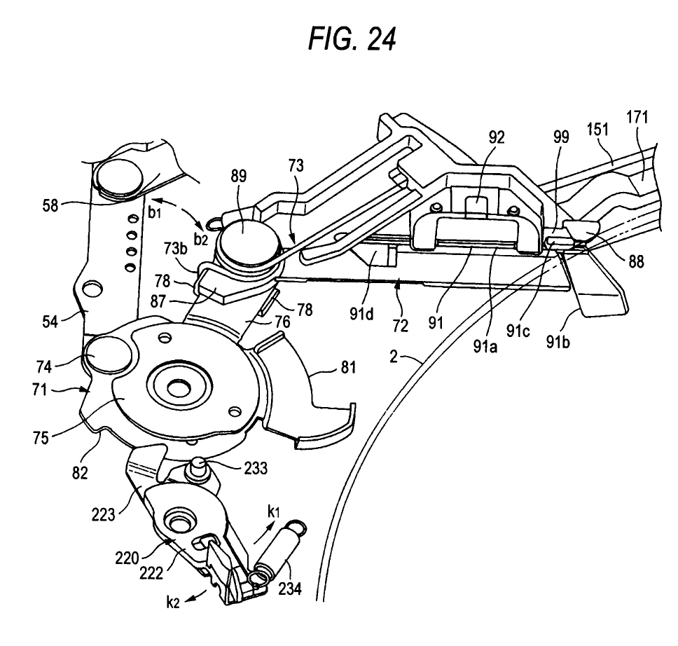

The eject arm 52 which ejects the optical disk 2 from the disk mounting part 23 to outside the disk port 19 is arranged on the side surface on the opposite side of the side surface where the loading arm 51 is formed, the arranged place is on the back side of the housing 3 more than the disk mounting part 23. The eject arm 52 is rotated in the direction of arrow b₁ in FIG. 11 in which the optical disk 2 is transferred on the disk mounting part 23 side and in the direction of arrow b₂ in FIG. 11 in which the optical disk 2 is ejected the disk port 19 side, while it is being operated by the first and second link arms 54 and 55 and the operation arm 58, described later. As shown in FIGS. 23 and 24, the eject arm 52 has the rotating support member 71 which is rotatably supported by the main chassis 6, a pushing arm 72 which is rotatably engaged in the rotating support member 71 and pushes the optical disk 2, and a coil spring 73 which energizes the pushing arm 72 in the eject direction of the optical disk 2.

The rotating support member 71 is formed of an almost round sheet metal, and is rotatably mounted on the top 6a of the main chassis 6 from on the opposite side of the disk transfer area of the top 6a. Nearly on the center of a main surface 71a of the rotating support member 71, a mounting opening 71b for the main chassis 6 is perforated. The rotating support member 71 is arranged with a spacer 75 between it and the main chassis 6, and is rotatably mounted on the main chassis 6 through the spacer 75.

In addition, the rotating support member 71 is formed with an engagement strip 76 in which the pushing arm 72 and the coil spring 73 are engaged. The engagement strip 76 is bent at the tip end of an erect wall 76a erected from the main surface 71a, and thus it is disposed upper than the main surface 71a and projected on the top 6a side more than the opening 6d for the eject arm of the main chassis 6. The engagement strip 76 is formed with an opening 77 which is connected to an engagement projecting part 85 of the pushing arm 72 and is rotatably caulked together by a caulking shaft 89, a pair of rotating regulating walls 78 and 78 which restrict the rotation area of the pushing arm 72 by abutting the side surface of the pushing arm 72, and a retain recess 79 on which an arm 73b of the coil spring 73 is retained. The rotating regulating walls 78 and 78 are raised from right and left sides of the engagement strip 76, and a regulating protrusion part 87 formed on the pushing arm 72 is arranged therebetween, whereby the rotation area of the pushing arm 72 is restricted.

In addition, the rotating support member 71 is formed with the engagement hole 80 on the main surface 71a, the engagement hole is rotatably engaged in the first link arm 54, described later. The engagement hole 80 is connected to the insertion hole formed in an end 54a of the first link arm 54, and is rotatably coupled to the first link arm 54 with a screw 74.

In addition, the rotating support member 71 is formed with a bend strip 81 from one side surface of the main surface 71a. The bend strip 81 is bent downward more than the main surface 71a, and then it is formed in a bump strip which is bumped against the subslider 151 of the base ascending/descending mechanism 150, described later. When the optical disk 2 is inserted to rotate the bend strip in the direction of arrow b₁ in FIG. 11 in which the optical disk 2 is transferred on the disk mounting part 23 side, the bend strip presses the switch of a first switch SW1 mounted on the circuit board 59. Therefore, the disk drive apparatus 1 can detect that the eject arm 52 pressed by the optical disk 2 is rotated to the back side of the housing 3, and can detect the timing to drive the drive mechanism 120.

Furthermore, the rotating support member 71 is formed with a rotating strip 82 which rotates the centering guide 220, described later, so as to separate the centering guide from the side surface of the optical disk 2 transferred on the disk mounting part 23. When the optical disk 2 is transferred to the centering position at which the disk can be mounted on the disk mounting part 23, the rotating strip 82 abuts against a cam shaft 233 of the centering guide 220 by rotating the rotating support member 71, and the rotating strip rotates the centering guide 220 to separate from the optical disk 2 to allow the optical disk 2 to be rotatable.

The pushing arm 72 rotatably engaged in the engagement strip 76 is a resin molded member formed in a nearly triangle shape, and has the engagement projecting part 85 which is inserted and engaged in the opening 77 of the engagement strip 76, a retain wall 86 on which another arm 73c of the coil spring 73 is retained, and the support part 88 which supports the side surface of the optical disk 2 on the insertion end side. The engagement projecting part 85 is a hollow cylinder formed on one apex of a triangle, and its hollow part is joined to the opening 77 which is perforated in the engagement strip 76 of the rotating support member 71, the hollow part is inserted into a cylindrical part 73a of the coil spring 73, and the engagement projecting part is caulked together with the engagement strip 76 by the caulking shaft 89. Thus, the pushing arm 72 is rotatable on the engagement strip 76 as it is pivoted about the engagement projecting part 85.

In the coil spring 73 engaged in the engagement strip 76 together with the pushing arm 72 by the caulking shaft 89, the engagement projecting part 85 is inserted into the cylindrical part 73a, the arm 73b is retained on the retain recess 79 formed on the engagement strip 76, and the arm 73c is retained on the retain wall 86 formed on the pushing arm 72. Thus, the coil spring rotates and energizes the pushing arm 72 rotatably supported by the engagement strip 76 in the eject direction of the optical disk 2 as it is pivoted about the engagement projecting part 85.

The pushing arm 72 is formed with the regulating protrusion part 87 near the engagement projecting part 85, and the regulating protrusion part decides the rotation area on the engagement strip 76. The regulating protrusion part 87 is positioned between the rotating regulating walls 78 and 78 erected on the engagement strip 76, and the pushing arm 72 is rotated over the engagement strip 76, whereby the regulating protrusion part is reciprocated between the rotating regulating walls 78. Therefore, since the rotation of the pushing arm 72 is restricted by abutting the regulating protrusion part 87 against any one of the rotating regulating walls 78, the rotation area is decided over the engagement strip 76.

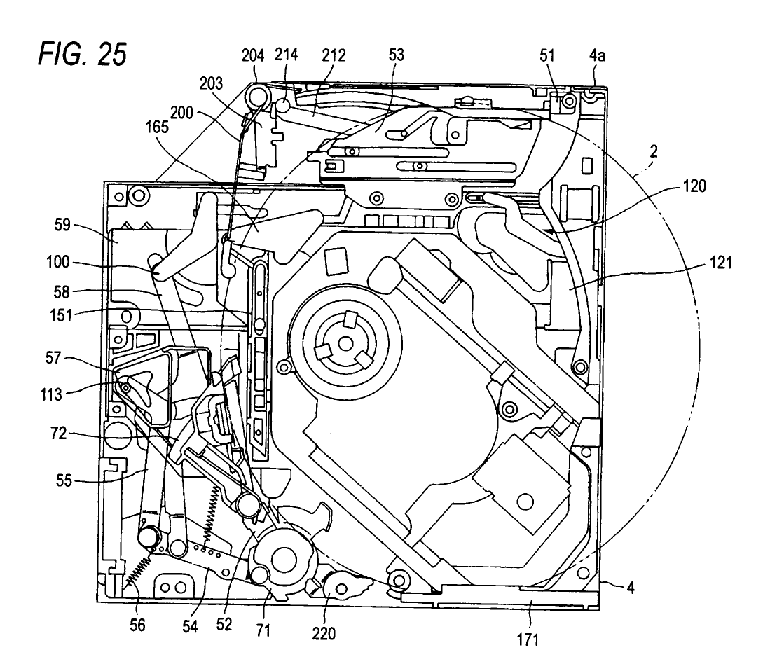

The pushing arm 72 is rotatably engaged in the rotating support member 71, and is rotated and energized on the disk port 19 side by the coil spring 73 with a predetermined spring force. Therefore, while the eject arm 52 is being rotated in the direction of arrow b₂ in FIG. 25 in which the optical disk 2 is ejected out of the housing 3 by means of the first link arm 54 and the operation arm 58 to which the drive force of the drive mechanism 120, described later, is applied, even though some force is applied in the direction of arrow b₁ because an obstacle exists in the transfer area of the optical disk 2, the force in the direction opposite to the eject direction of the optical disk 2 is applied to the pushing arm 72, and the pushing arm is rotated in the direction of arrow b₁ against the energizing force of the coil spring 73 as it is pivoted about the opening 77 of the rotating support member 71. Thus, such an event is avoided that the drive force which rotates the eject arm 52 in the direction of arrow b₂ runs counter to the force working in the opposite direction of the drive force. Therefore, no excess load is not applied to a motor, for example, of the drive mechanism 120 which drives the first link arm 54 and the operation arm 58 so as to rotate the eject arm 52 in the direction of arrow b₂ in FIG. 25, and the optical disk 2 is sandwiched between the energizing force in the eject direction generated by the eject arm 52 and the force working in the opposite direction thereof, whereby the disk can be prevented from being damaged.

In addition, as shown in FIGS. 23 and 24, on the tip end part of the pushing arm 72, the pickup part 90 is disposed which prevents the optical disk 2 from sinking on the bottom case 4 side. The pickup part 90 has a pickup arm 91 which supports the optical disk 2 from thereunder, and a holding member 92 which presses the pickup arm 91 so as to catch the optical disk 2.

The pickup arm 91 has a rod like shaft part 91a, a support strip 91b which is disposed on one end side of the shaft part 91a and supports the optical disk 2, a bump strip 91c which is raised near the support strip 91b and against which the outer rim surface of the optical disk 2 inserted in the housing 3 is bumped, and a slide strip 91d which is disposed on the other end of the shaft part 91a and is slid over the top 6a of the main chassis 6 in association with the rotation of the eject arm 52 to rotate the shaft part 91a in the direction of raising the support strip 91b.

The shaft part 91a is formed in a nearly column shape, the support strip 91b and the bump strip 91c are protruded on one end side thereof, and the slide strip 91d is protruded on the other end side. The shaft part 91a is rotatably supported by a bearing part 94 formed on the pushing arm 72. The support strip 91b supports the rim part of the optical disk 2 on the insertion end side, the disk being inserted slantingly on the bottom case 4 side, whereby the support strip prevents the disk from colliding against the optical pickup 25 as well as it returns the disk to the normal transfer area. The support strip is formed in a rectangular plate shape, the thickness is gradually reduced to the tip end in the longitudinal direction, and the strip has an inclined surface. When the bump strip 91c is bumped against the outer rim surface of the optical disk 2, it is supported by a support wall 99 raised on the pushing arm 72 to restrict the rotation of the shaft part 91a. In addition, the bump strip 91c is raised from the shaft part 91a in the direction almost orthogonal to the direction of extending the support strip 91b. When the bump strip is supported by the support wall 99, the support strip 91b is rotated over the normal transfer area of the optical disk 2. The slide strip 91d is protruded from the shaft part 91a, and then it is brought on the underside of the pushing arm 72 from an opening 95 perforated in the pushing arm 72. Then, the slide strip 91d is slid over the top of the main chassis 6, whereby it holds and rotates the support strip 91b to the normal transfer area of the optical disk 2.

In addition, the shaft part 91a is formed with pressed parts 93 and 93 which are pressed by the holding member 92. The pressed parts 93 and 93 are flattened by shaping the shaft part 91a in a D-shape in cross section, and they are portions to be pressed by the holding member 92 formed in a flat plate. The holding member 92 which presses the pressed parts 93 and 93 is a plate spring member formed in a U-shape, which is mounted on the pushing arm 72 to rotate and energize the shaft part 91a so that the support strip 91b of the pickup arm 91 is tilted downward all the time. At this time, since the holding member 92 presses the flat part of the pressed parts 93 and 93 formed in a D-shape in cross section, it can surely rotate and energize the pickup arm 91 so that the support strip 91b faces downward. Thus, the slide strip 91d of the pickup arm 91 is protruded out of the opening 95 formed in the pushing arm 72 toward the under side of the pushing arm 72, and the pushing arm 72 is rotated on the back side of the housing 3 to allow the slide strip to abut against the edge part 17 of the main chassis 6.

In the state in which the optical disk 2 is waited to insert, in the pickup arm 91, since the eject arm 52 is rotated on the front side of the housing 3, the slide strip 91d is separated from the edge part 17 of the main chassis 6, and the shaft part 91a is energized by the holding member 92, whereby the support strip 91b is tilted downward. Then, when the optical disk 2 is inserted, the outer rim surface of the optical disk is bumped against the bump strip 91c, whereby the shaft part 91a is rotated against the energizing force of the holding member 92, and the support strip 91b is raised on the top cover 5. Thus, the pickup arm 91 is being rotated on the back side of the housing 3 while it is supporting the under side of the optical disk 2 by means of the support strip 91b. After that, when the pushing arm 72 is rotated over the top of the main chassis 6, such a state is held in the pickup arm 91 in which the slide strip 91d brought out of the opening 95 to under the pushing arm 72 is slidably contacted with the top 6a from the edge part 17 of the main chassis 6, and then the support strip 91b is raised on the top cover 5 side. Therefore, after the optical disk 2 is transferred to the disk mounting part 23, even though the pushing arm 72 is separated from the optical disk 2, such an event can be prevented that the support strip 91b is rotated on the bottom case 4 side with the energizing force of the holding member 92 and slid over the top of the main chassis 6.

In addition, when the insertion end of the optical disk 2 is inserted slantingly on the bottom case 4 side, the outer rim surface of the insertion end of the optical disk 2 is supported by the support strip 91b which is rotated on the bottom case 4 side as it is waiting for insertion of the disk. Thus, such an event can be prevented that the optical disk 2 collides against the other components arranged on the bottom case 4 side such as the turntable 23a and the optical pickup 25.

When the optical disk 2 is being inserted slantingly, because the eject arm 52 and the pushing arm 72 are rotated in the direction of arrow b₁, in the pickup arm 91, the slide strip 91d is slidably contacted with the edge part 17 of the main chassis 6. Thus, the shaft part 91a is rotated against the energizing force of the holding member 92, and the support strip 91b is rotated the top cover 5 side. Moreover, the rotation area of the support strip 91b is restricted by supporting the bump strip 91c formed on the shaft part 91a by means of the support wall 99 raised on the pushing arm 72. In addition, the support strip 91b is rotated to bump the rim part of the optical disk 2 against the bump strip 91c. Thus, the pickup arm 91 can return the optical disk 2 having been inserted slantingly on the bottom case 4 side to the normal transfer area.

In addition, the pushing arm 72 has a clamp strip 88 which is raised thereon near the support strip 91b of the pickup arm 91 and clamps the rim part of the optical disk 2 together with the support strip 91b. The clamp strip 88 is extended from the tip end of the erect wall raised from the main surface of the pushing arm 72 in the same direction as the support strip 91b. The pushing arm 72 receives the side surface of the insertion end of the optical disk 2 by means of the bump strip 91c and the erect wall of the clamp strip 88, and it clamps the insertion end of the optical disk 2 by means of the clamp strip 88 and the support strip 91b. The pushing arm is rotated on the back side of the housing 3 when the disk is inserted and drawn, whereas it pushes the optical disk 2 to the front side of the housing 3 when the disk is ejected.

The distance between the clamp strip 88 and the support strip 91b rotated over the normal transfer area is formed greater than the thickness of the optical disk 2, and these strips do not clamp the optical disk 2 strongly. Therefore, the eject arm 52 can prevent the optical disk 2 from tilting in association with the rotation in the directions of arrows b₁ and b₂ by means of the clamp strip 88 and the support strip 91b as well as it can smoothly release the optical disk 2 and clamp the disk in ejecting the disk.

In addition, the pushing arm and the pickup part for the eject arm 52 may be formed as described below.

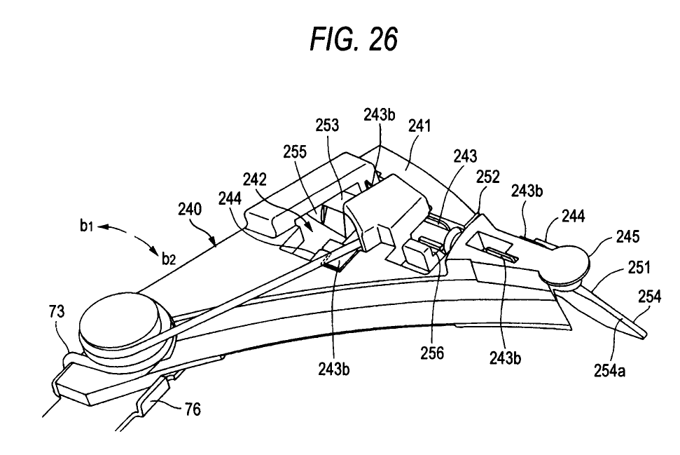

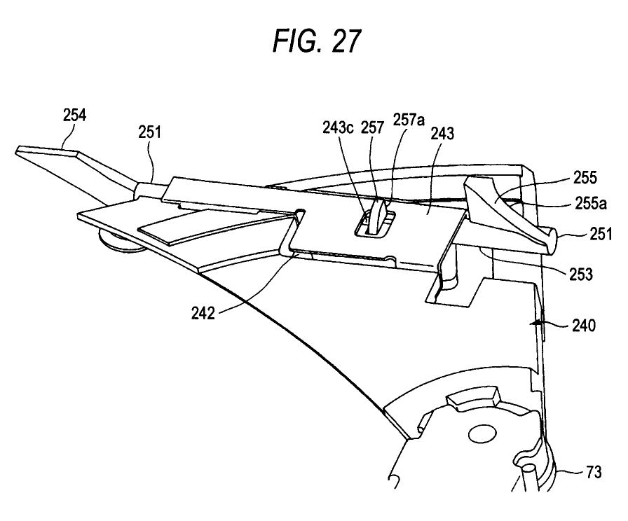

As shown in FIGS. 26 and 27, as similar to the pushing arm 72 mounted on the eject arm 52, a second pushing arm 240 is rotatably mounted on the opening 77 perforated in the engagement strip 76 of the rotating support member 71, and is rotated and energized by the coil spring 73 in the direction of arrow b₂ in FIG. 26 that is the eject direction of the optical disk 2. In addition, the second pushing arm 240 is a resin molded member formed in a nearly triangle shape, and is formed with a pickup support part 241 on which a second pickup part 250 is disposed on the opposite side of the apex supported by the engagement strip 76, and a clamp strip 245 which clamps the side surface of the insertion end of the optical disk 2 together with the pickup arm 251 of the second pickup part 250.

The pickup support part 241 has an accommodation recess 242 which rotatably accommodates the pickup arm 251, and a retaining part 244 on which a supporting plate 243 is retained that supports the pickup arm 251 on the accommodation recess 242. The accommodation recess 242 is disposed along one side of the second pushing arm 240 in accordance with the rod like pickup arm 251, and intermittently supports the upper part of the pickup arm 251 along the longitudinal direction. In addition, a plurality of retain strips 243b formed in the supporting plate 243 is retained on the retaining part 244, whereby the retaining part retains the supporting plate 243 on the pickup support part 241 from the back surface side of the accommodation recess 242.

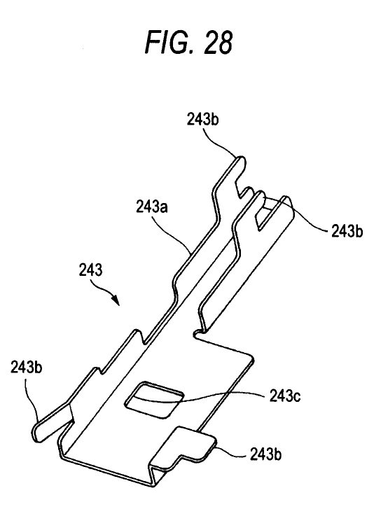

The supporting plate 243 is retained on the pickup support part 241 from the back surface side of the second pushing arm 240, whereby it rotatably supports the pickup arm 251 on the pickup support part 241. As shown in FIG. 28, the supporting plate 243 has an accommodating part 243a formed of a U-shape metal plate which accommodates the pickup arm 251 therein, and a plurality of the retain strips 243b which is retained on a plurality of the retaining parts 244 disposed on the pickup support part 241. In the supporting plate 243, the pickup arm 251 is accommodated in the accommodating part 243a, and the pickup arm is prevented from dropping off from the pickup support part 241 by retaining the retain strip 243b on the retaining part 244. The supporting plate 243 has a retain hole 243c perforated therein which restricts the rotation area of the pickup arm 251. A retain protrusion part 257 raised on the pickup arm 251 is inserted into the retain hole 243c, and a retain surface 257a of the retain protrusion part 257 is retained, whereby the rotation area of the support part 254 of the pickup arm 251 can be determined.

In addition, as similar to the clamp strip 88 of the pushing arm 72, the clamp strip 245 clamps the rim part of the optical disk 2 together with the pickup arm 251, and is protruded from the tip end of the erect wall raised on the main surface of the second pushing arm 240 in the same direction as the support part 254 of the pickup arm 251.

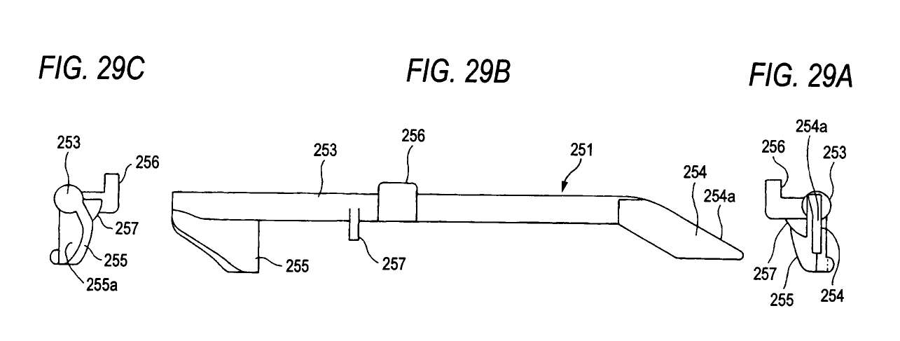

As shown in FIGS. 26 and 27, the second pickup part 250 has the pickup arm 251, and a coil spring 252 which rotates and energizes the pickup arm 251. The pickup arm 251 supports the rim part of the optical disk 2 inserted slantingly to prevent the disk from colliding against the optical pickup 25, and guides it to the normal transfer area. As shown in FIGS. 29A to 29C, the second pickup part has an arm main body 253 in a column shape, the support part 254 which is formed at the tip end of the arm main body 253 and supports the rim part of the optical disk 2, a slide part 255 which is formed at the rear end of the arm main body 253 and slides over the top 6a of the main chassis 6 to rotate the arm main body 253, a spring retaining part 256 which is protruded from the outer region of the arm main body 253 and one end of the coil spring 252 is retained thereon, and the retain protrusion part 257 which is protruded from the outer region of the arm main body 253 and is inserted into the retain hole 243c of the supporting plate 243.

The arm main body 253 is accommodated in the accommodation recess 242 disposed on the second pushing arm 240, and is rotatably held by the accommodating part 243a of the supporting plate 243. On the outer region of the arm main body 253, the spring retaining part 256 and the retain protrusion part 257 are protruded.

The support part 254 formed at the tip end of the arm main body 253 is formed overall in a flat plate, and as shown in FIG. 29A, it is formed to have an acute angle seen from the side surface. In the state in which the optical disk 2 is waited to insert, the support part 254 is supported as a main surface 254a is stood in the direction nearly orthogonal to the main surface of the optical disk 2. At this time, the support part 254 has the main surface 254a tilted on the bottom case 4 side, and when the optical disk 2 is inserted slantingly on the bottom case 4 side, it can support the side surface of the insertion end of the optical disk 2.

The slide part 255 which is formed at the rear end of the arm main body 253 has an erect wall having a curved surface which is raised from the arm main body 253. As shown in FIG. 29 C, the slide part 255 has a curved surface 255a which is the side surface abutting against the edge part 17 of the main chassis 6 when the eject arm 52 is rotated in the direction of arrow b₁. The eject arm 52 is rotated in the direction of arrow b₁, whereby the curved surface abuts against the edge part 17 of the main chassis 6 to rotate the arm main body 253 and the support part 254. The slide part 255 abuts against the main chassis 6 to rotate the arm main body 253, and then in the support part 254, the main surface 254a having been rotated in the direction almost orthogonal to the main surface of the optical disk 2 is almost in parallel with the main surface of the optical disk 2.

In addition, the arm main body 253 is inserted through the coiled part of the coil spring 252 which rotates and energizes the pickup arm 251, one end of the coil spring is retained on the main surface of the second pushing arm 240, and the other end is retained on the spring retaining part 256 disposed on the arm main body 253 of the pickup arm 251. In the coil spring 252, one end is retained on the pushing arm 240, and the other end is retained on the spring retaining part 256 of the pickup arm 251, whereby the coil spring rotates and energizes the pickup arm 251.

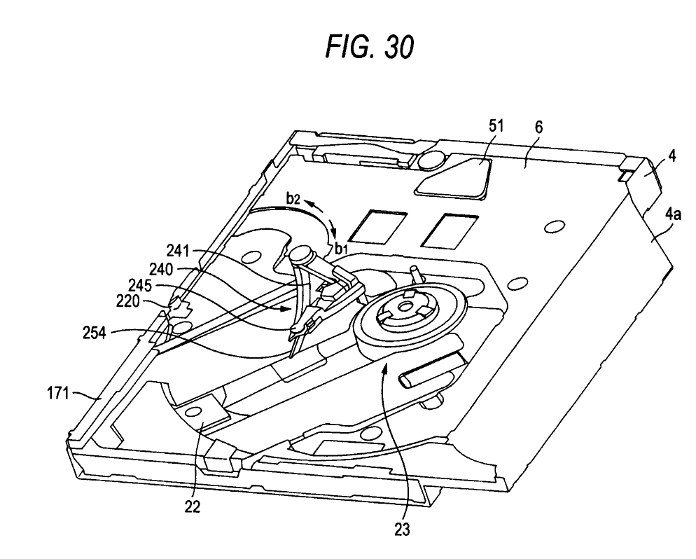

In the pickup arm 251, the arm main body 253 is accommodated in the accommodation recess 242 of the second pushing arm 240, and the retain protrusion part 257 is inserted into the retain hole 243c of the supporting plate 243 mounted from the back surface side of the second pushing arm 240, whereby the pickup arm is supported by the pickup support part 241 of the second pushing arm 240. At this time, in the pickup arm 251, the spring retaining part 256 energized by the coil spring 252 abuts against the main surface of the supporting plate 243, and then the main surface 254a of the support part 254 is stood and held in the direction almost orthogonal to the main surface of the optical disk 2. As shown in FIG. 30, the support part 254 waits for the insertion of the optical disk 2 in the state in which the main surface 254a is tilted on the bottom case 4 side.

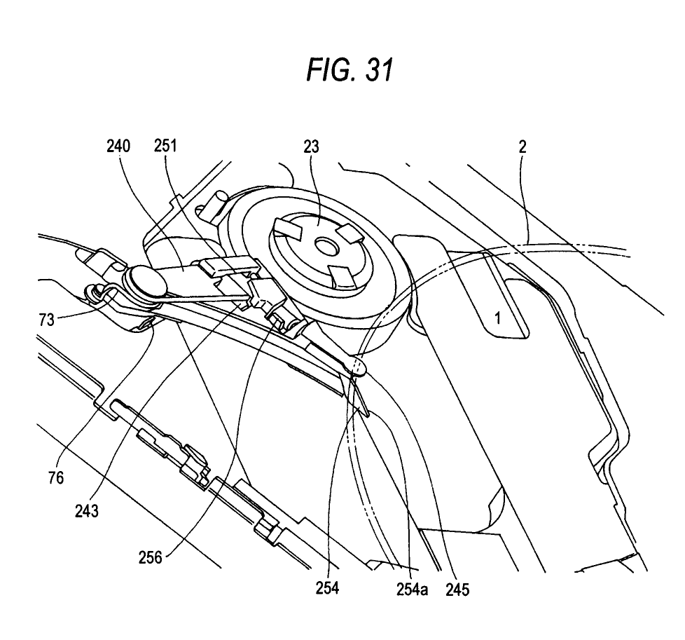

When the optical disk 2 is inserted into the housing 3, the side surface of the insertion end of the optical disk 2 abuts against the erect wall disposed with the clamp strip 245, and the second pushing arm 240 is rotated in the direction of arrow b₁. At this time, as shown in FIG. 31, when the optical disk 2 is inserted as the tip end thereof is tilted on the bottom case 4 side, the support part 254 supports the tip end of the optical disk 2. Therefore, even though the optical disk 2 is inserted slantingly on the bottom case 4 side, the rim part of the optical disk 2 can be prevented from colliding against the turntable 23a or the optical pickup 25 of the base unit 22 arranged in the bottom case 4. The optical disk 2 is guided by the main surface 254a of the support part 254, and then the rim part on the insertion end side is moved to the normal transfer area.

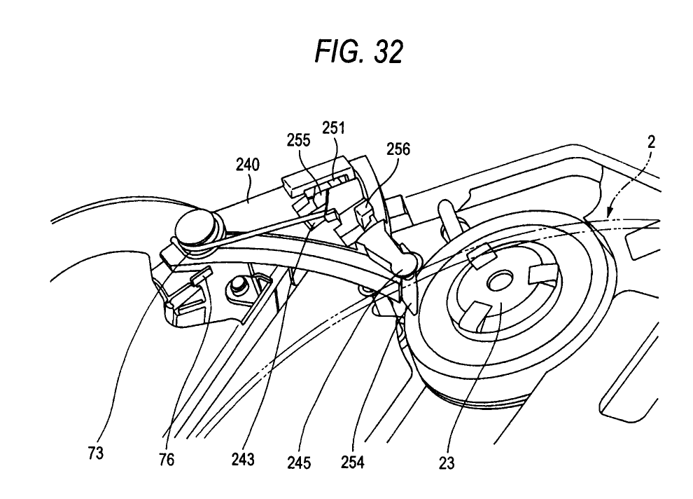

When the eject arm 52 is rotated in the direction of arrow b₁ in the state in which the optical disk 2 is supported by the support part 254, in the pickup arm 251, the curved surface 255a of the slide part 255 abuts against the edge part 17 of the main chassis 6, and then the arm main body 253 is rotated against the energizing force of the coil spring 252. Thus, as shown in FIG. 32, the support part 254 is rotated from the state in which the main surface is stood in the direction nearly orthogonal to the main surface of the optical disk 2 to the state in which the main surface thereof is almost in parallel with the main surface of the optical disk 2. Then, the support part guides the optical disk 2 inserted slantingly to the normal transfer area, as well as clamps the optical disk 2 together with the clamp strip 245 raised on the second pushing arm 240.

In the step of drawing the optical disk 2, when the eject arm 52 is further rotated in the direction of arrow b₁, the slide part 255 of the pickup arm 251 is slid over the top 6a of the main chassis 6, and then the support part 254 is moved while it is being maintained as it is almost in parallel with the main surface of the optical disk 2. Therefore, in inserting and drawing the disk, the pickup arm 251 is rotated on the back side of the housing 3 while it is clamping the optical disk 2 together with the clamp strip 245, whereas in ejecting the disk, it pushes the optical disk 2 on the front side of the housing 3 side.

The distance between the clamp strip 245 and the support part 254 rotated over the normal transfer area is formed greater than the thickness of the optical disk 2, and they do no clamp the optical disk 2 strongly. Therefore, the eject arm 52 can prevent the optical disk 2 from tilting by means of the clamp strip 245 and the support part 254 in association with the rotation in the directions of arrows b₁ and b₂, it smoothly releases the optical disk 2, and it can clamps the disk in ejecting the disk.

Next, the first link arm 54 which is rotatably engaged in the rotating support member 71 of the eject arm 52 will be described. The first link arm 54 is operated by the operation arm 58, described later, to rotate the eject arm 52 in the insertion direction of the optical disk 2, or in the direction of arrow b₁ in FIG. 11 or in the direction of arrow b₂ that is the eject direction. The first link arm 54 is formed of a metal plate in a nearly rectangular shape, in which the end 54a in the longitudinal direction is rotatably engaged in the engagement hole 80 of the rotating support member 71, an end 54b in the longitudinal direction is rotatably engaged in the second link arm 55, the end part is formed with a retaining part 96 on which one end of the tensile coil spring 56 spanned to the main chassis 6 is retained, and an end 58b of the operation arm 58 is mounted approximately in the middle part in the longitudinal direction.

Moreover, the first link arm 54 may have an energizing coil spring 97 retained between it and the loop cam 57. The energizing coil spring 97 is disposed for preparing such an event that in the step of ejecting the optical disk 2, the power of the slider 122 as turning effect is not sufficiently transmitted to the rotating support member 71 of the eject arm 52 through the first link arm 54, and the energizing coil spring rotates the eject arm 52 to the position of ejecting the optical disk 2.

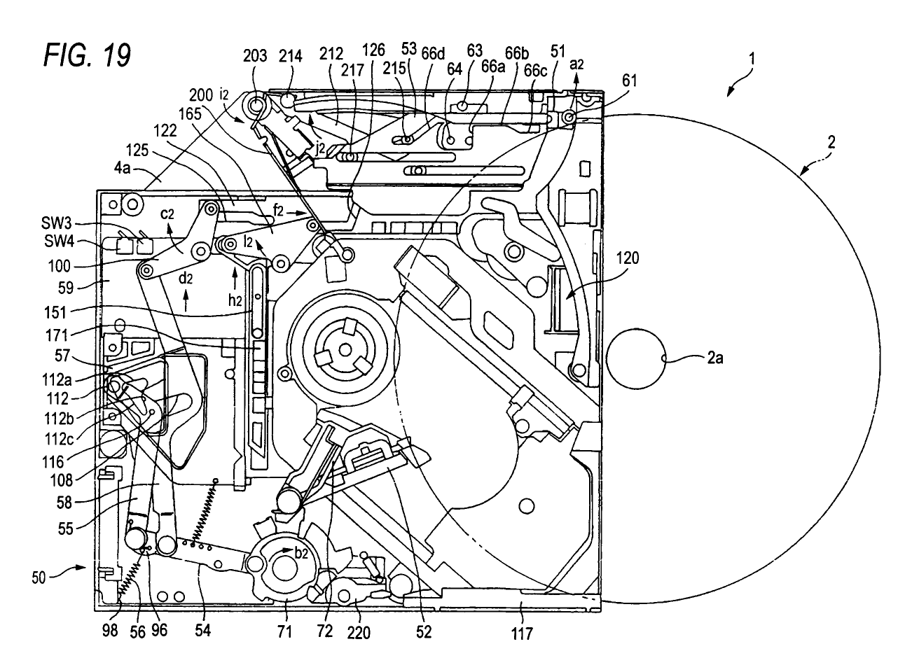

The energizing coil spring 97 has one end retained on a loop cam plate 111 of the loop cam 57, and the other end mounted approximately in the middle part of the first link arm 54. Thus, in the step of ejecting the optical disk 2, the energizing coil spring 97 rotates and energizes the rotating support member 71 in the direction of arrow b₂ in FIG. 19 through the first link arm 54. Therefore, the eject arm 52 can transfer the optical disk 2 to a predetermined eject position. Moreover, in the disk transfer mechanism 50, the energizing coil spring 97 is not essential, which is used as an auxiliary part. Generally, the disk transfer mechanism 50 transfers the optical disk 2 to a predetermined eject position, by rotating the eject arm 52 in the direction of arrow b₂ in accordance with the slide of the slider 122, not by the energizing force of the energizing coil spring 97.

The tensile coil spring 56, which is formed at the tip end of the first link arm 54 and is retained on the retaining part 96, rotates and energizes the eject arm 52 through the first link arm 54 in the direction of arrow b₂ in FIG. 11 that is the eject direction of the optical disk 2, whereby it applies the energizing force in the eject direction to the eject arm 52 in inserting the optical disk 2. In other words, when the optical disk 2 is inserted to rotate the eject arm 52 in the direction of arrow b₁, the end 54a of the first link arm 54 coupled to the rotating support member 71 is similarly rotated in the direction of arrow b₁. At this time, in the tensile coil spring 56 which is retained on the retaining part 96 of the first link arm 54, the other end retained on the retaining part 98 of the main chassis 6 is separated from one end retained on the retaining part 96 of the first link arm 54, and the tensile coil spring is extended. Therefore, in the eject arm 52, the energizing force of the tensile coil spring 56 pulls back the end 54a of the first link arm 54 and the rotating support member 71 engaged in the first link arm 54 in the opposite direction of the direction of arrow b₁ that is the rotating direction. Therefore, the energizing force in the direction of arrow b₂ that is the eject direction of the optical disk 2 is applied with a predetermined force.

Accordingly, in the disk drive apparatus 1, when a user inserts the optical disk 2, the optical disk 2 can be inserted while the eject arm 52 is applying the energizing force in the direction of arrow b₂ that is opposite to the insertion direction. Therefore, suppose even in the case in which a user stops inserting the optical disk 2 halfway, the optical disk 2 can be pushed back to the eject position, and such an event can be prevented that the disk is left at a position halfway inside the housing 3.

Moreover, when the optical disk 2 is inserted into the housing 3 to some extent, the drive mechanism 120, described later, is driven to perform the drawing operation of the optical disk 2 by the loading arm 51, as well as the operation arm 58 receives the drive force of the drive motor 121 to move the first link arm 54. Thus, the energizing force generated by the tensile coil spring 56 in the direction of arrow b₂ does not work on the eject arm 52. In addition, in ejecting the optical disk 2, the first link arm 54 is guided so that the retaining part 96 is not separated from the retaining part 98 of the main chassis 6. Thus, the tensile coil spring 56 is not extended, and the energizing force in the eject direction will not work on the eject arm 52 and the optical disk 2.

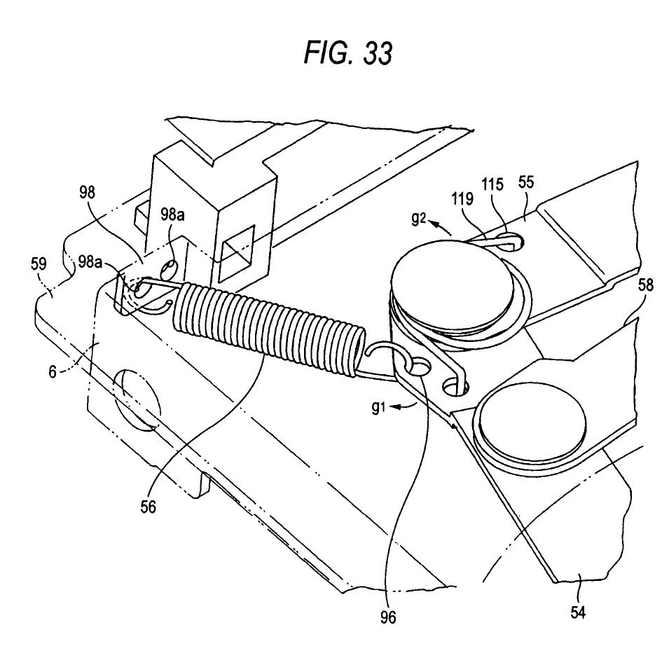

As shown in FIG. 33, in the retaining part 98 of the main chassis 6 in which the tensile coil spring 56 is retained between it and the retaining part 96 of the first link arm 54, a plurality of retain holes 98a is formed. The tensile coil spring 56 changes the retain holes 98a to vary the extending length when the optical disk 2 is inserted, and then it allows the energizing force in the eject direction to be variable. In addition, a plurality of retain holes may be formed in the retaining part 96 which is formed in the first link arm 54. Moreover, a plurality of retain holes may be formed in both of the retaining part 96 and the retaining part 98.

As described above, a plurality of retain holes is disposed on the first link arm 54 and/or the retaining parts 96 and 98 of the main chassis 6, and then the length of extending the tensile coil spring 56 can be adjusted. Only the retain position of on the retain hole is changed to work a desired ejecting force with no preparation of a plurality of tensile coil springs 56 with different capacity. Although the energizing force of the eject arm 52 in the eject direction generated by the tensile coil spring 56 can be also varied by preparing a plurality of tensile coil springs with different capacity, it is necessary to prepare a plurality of types of tensile coil springs, which leads to an increase in the number of parts and complicated parts management by a service department. Therefore, a plurality of retain holes is formed on the first link arm 54 or the retaining parts 96 and 98 of the main chassis 6, whereby a burden of preparing a plurality of types of tensile coil springs can be eliminated.

The second link arm 55, which is rotatably engaged in the end 54b of the first link arm 54, is formed of a long sheet metal in which an end 55a has the guide projecting part 113 raised thereon which is guided by a guide groove 114 of the loop cam 57, and an end 55b has an engagement hole thereon which is rotatably engaged in the end 54b of the first link arm 54. The second link arm 55 controls the distance between the retaining part 96 of the first link arm 54 and the retaining part 98 of the main chassis 6 by guiding the guide projecting part 113 by means of the loop cam 57.

In addition, the second link arm 55 is formed with an engaging protrusion part 116 which is engaged in a cam groove 108 formed in the operation arm 58, described later. The disk transfer mechanism 50 can rotate the eject arm 52 in accordance with the movement of the slider 122 by engaging the engaging protrusion part 116 of the second link arm 55 in the cam groove 108, and it can stably eject the optical disk 2 to a predetermined eject position.

In other words, when the panel curtain disposed on the disk port 19 of the front panel 18 is slidably contacted with the optical disk 2 to apply a load during the ejection of the optical disk 2, the rotating support member 71 of the eject arm 52 and the first link arm 54 are energized in the direction of arrow b₁. Here, in the case in which the second link arm 55 is not engaged in the operation arm 58 by means of the engaging protrusion part 116, even though the operation arm 58 is moved in the direction of arrow d₂ in association with the slide of the slider 122 in the direction of arrow f₂, the first link arm 54 is only rotated in the direction of arrow d₂ with respect to the rotating support member 71 as it is pivoted about the engagement hole 80, and it is difficult to rotate the eject arm 52 in the direction of arrow b₂. In addition, the second link arm 55 is also only rotated with respect to the first link arm 54.

On the other hand, when the second link arm 55 is engaged in the operation arm 58 by means of the engaging protrusion part 116, the engaging protrusion part 116 abuts against the side wall of the cam groove 108 in association with the movement of the operation arm 58 in the direction of arrow d₂, and it is difficult to freely rotate the second link arm 55 with respect to the first link arm 54. In other words, the rotation of the first link arm 54 is restricted in the direction of arrow d₂ by abutting the engaging protrusion part 116 of the second link arm 55 against the side wall of the cam groove 108. Therefore, even in the case in which the eject arm 52 is energized in the direction of arrow b₁ during the ejection of the optical disk 2, when the operation arm 58 is moved in the direction of arrow d₂, the first link arm 54 is moved in the direction of arrow d₂ while it is against the energizing force in the direction of arrow b₁, and it rotates the eject arm 52 in the direction of arrow b₂. Therefore, it is realized that the eject arm 52 is rotated in the direction of arrow b₂ in accordance with the sliding amount of the slider 122 in the direction of arrow f₂, and it is ensured that the optical disk 2 can be ejected at a predetermined eject position.

Moreover, the second link arm 55 has a retain hole 115 formed on the end part thereof in which the first link arm 54 is engaged, and a torsion coil spring 119 is retained thereon. The torsion coil spring 119 has one end retained on the first link arm 54, and the other end is retained on the retain hole 115 of the second link arm 55, whereby the torsion coil spring rotates and energizes the second link arm in the direction of widening an angle formed of the first link arm 54 and the second link arm 55, that is, in the directions of arrows g₁ and g₂ in FIG. 33 that is the direction of opening the first link arm 54 and the second link arm 55. Thus, in the second link arm 55, the guide projecting part 113 can go over a projecting part 112e disposed on the loop cam 57, described later, and it can be guided from a pulling guide wall 112b to an ejecting guide wall 112c.

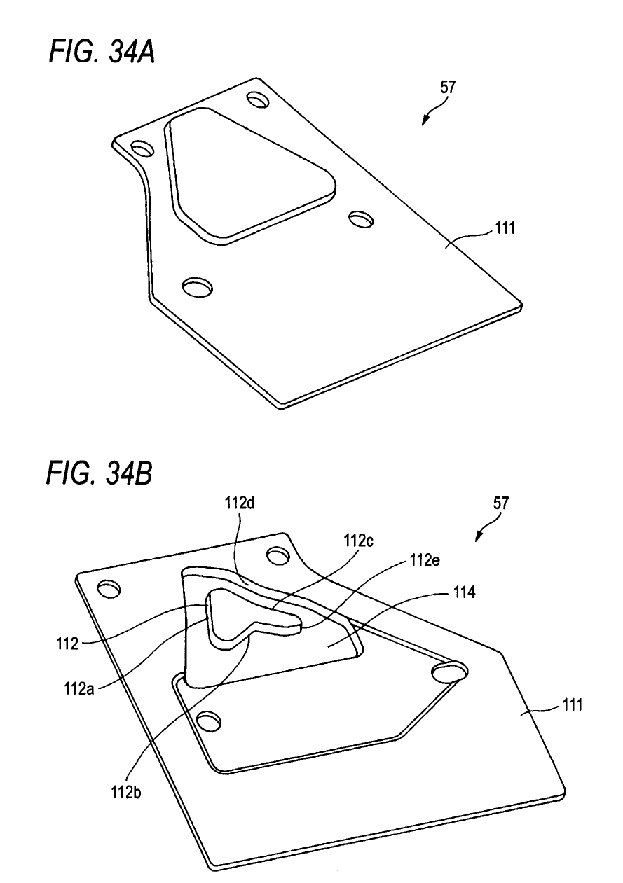

The loop cam 57, which guides the movement of the guide projecting part 113 of the second link arm 55, has an insertion guide part which guides the first and second link arms 54 and 55 so as to generate the energizing force in the eject direction for the eject arm 52 in inserting the optical disk 2, and a drawing guide part and an ejecting guide part which guide the first and second link arms 54 and 55 so as not to generate the energizing force in the eject direction for the eject arm 52 in drawing and ejecting the optical disk 2. The loop cam has these parts continuously formed in a ring. As shown in FIGS. 34A and 34B, it is shaped into the loop cam plate 111 in a plate shape, and the loop cam plate 111 is mounted on the surface on the bottom case 4 side of the top 6a of the main chassis 6. The loop cam plate 111 has a cam wall 112 in a nearly ring shape raised toward the bottom case 4 side. In the operations of inserting, drawing and ejecting the optical disk 2, the guide projecting part 113 of the second link arm 55 are circled around on the cam wall 112. The cam wall has an insertion guide wall 112a on which the guide projecting part 113 is slid in inserting the optical disk 2, the pulling guide wall 112b on which the guide projecting part 113 is slid in drawing the optical disk 2, and the ejecting guide wall 112c on which the guide projecting part 113 is slid in ejecting the optical disk 2, and they are continuously formed in a ring shape. The walls are surrounded by a rim part 112d to form the guide groove 114 in a ring shape on which the guide projecting part 113 is moved. In addition, the loop cam 57 is formed with the projecting part 112e which prevents the guide projecting part 113 from going backward between the pulling guide wall 112b and the ejecting guide wall 112c.

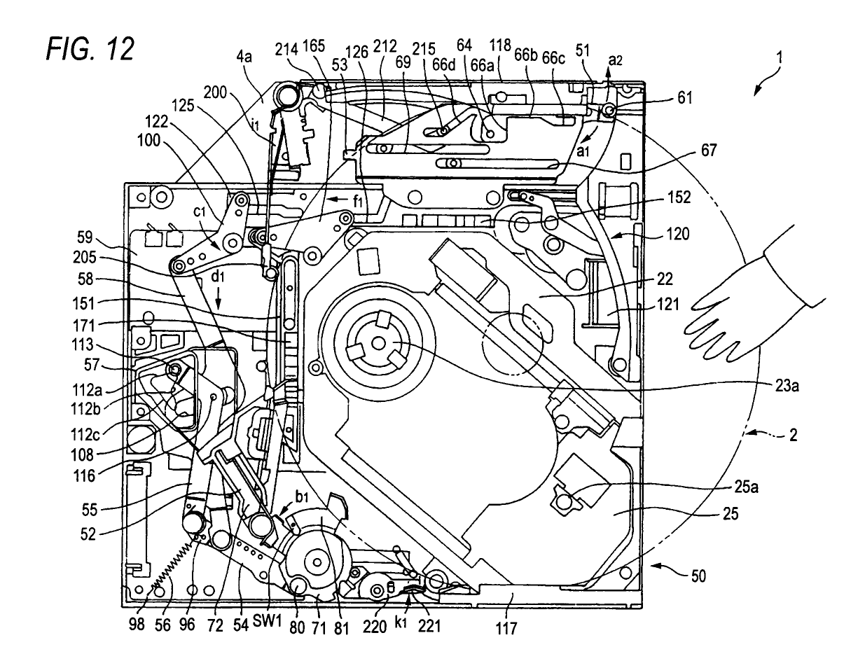

As shown in FIG. 12, the insertion guide wall 112a is formed in the direction of the front side of the housing 3 toward the right guide wall 118 side, the pulling guide wall 112b is formed from the right guide wall 118 side toward the left guide wall 117 side, and the ejecting guide wall 112c is formed in the direction of the back side of the housing 3 from the left guide wall 117 side toward the right guide wall 118 side.

The operation arm 58, which is coupled to the first link arm 54 and the drive mechanism 120 and operates the eject arm 52, is formed of a long metal plate, in which an end 58a in the longitudinal direction is rotatably engaged in a third link arm 100 coupled to the slider 122 of the drive mechanism 120, and the end 58b is rotatably engaged in the first link arm 54. In addition, the operation arm 58 is formed with the cam groove 108 into which the engaging protrusion part 116 is inserted that is formed at the center of the second link arm 55 in the longitudinal direction.

As described above, the cam groove 108 is engaged in the engaging protrusion part 116 of the second link arm 55, whereby it rotates the eject arm 52 in accordance with the slide of the slider 122. The cam groove is formed in a long hole so that the engaging protrusion part 116 is movable when the second link arm 55 is circled around the loop cam 57. In addition, the cam groove 108 is formed in the direction almost orthogonal to the directions of arrows d₁ and d₂ in FIG. 11 that are the moving direction of the operation arm 58. Thus, the operation arm 58 can restrict the rotation of the second link arm 55 by abutting the engaging protrusion part 116 against the side wall of the cam groove 108, and can restrict the rotation of the first link arm 54 in the direction of arrow d₂.

The operation arm 58 is moved through the third link arm 100 in the directions of arrows d₁ and d₂ in FIG. 11 that are the lateral direction by sliding the slider 122, and the operation arm rotates the first link arm 54 and the eject arm 52. More specifically, when the operation arm 58 is moved in the direction of arrow d₁ in FIG. 11 by the third link arm 100, it pushes the first link arm 54 in the same direction, and thus it rotates the eject arm 52 in the direction of arrow b₁ in FIG. 11 that is the insertion direction of the optical disk 2. In addition, when the operation arm 58 is moved in the direction of arrow d₂ in FIG. 11 by the third link arm 100, it moves the first link arm 54 in the same direction, and thus it rotates the eject arm 52 in the direction of arrow b₂ in FIG. 11 that is the eject direction of the optical disk 2.

The third link arm 100, which is rotatably engaged in the end 58a of the operation arm 58, is formed of a metal plate in a dogleg shape, in which a bend part 100a is rotatably mounted on the main chassis 6 to rotatably support the third link arm in the directions of arrows c₁ and c₂ in FIG. 11, an end 100b is extended from the bend part 100a, an engagement projecting part 109 formed on the end is engaged in the slider 122, and an end 100c is rotatably engaged in the operation arm 58. Thus, when the slider 122 receives the drive force of the drive motor 121 of the drive mechanism 120 and is transferred in the direction of arrow f₁ in FIG. 11, the third link arm 100 is guided by a first guide groove 125 formed in the slider 122, and is rotated in the direction of arrow c₁ in FIG. 11, and the third link arm moves the operation arm 58 in the direction of arrow d₁ in the same drawing. In addition, when the slider 122 is transferred in the direction of arrow f₂ in FIG. 11, the third link arm 100 is guided by the first guide groove 125, and rotated in the direction of arrow C₂ in the same drawing, and the third link arm moves the operation arm 58 in the direction of arrow d₂ in the same drawing.

Moreover, the right and left guide walls 117 and 118 arranged on right and left sides of the disk transfer area guide the insertion and ejection of the disk by sliding the side surface of the optical disk 2, which are formed of a synthetic resin softer than the optical disk 2. The right guide wall 118 is arranged on the deck part 4a, and the left guide wall 117 is arranged on the main chassis 6, both of which are fixed by a screw or an adhesive tape.

The right and left guide walls 117 and 118 have side walls 117a and 118a raised thereon. The side walls 117a and 118a are disposed at the positions at a predetermined clearance apart from the side surface of the optical disk 2 transferred at the centering position, and they are not contacted with the side surface of the optical disk 2 being rotated and driven.

Next, the operations from insertion to ejection of the optical disk 2 done by the disk transfer mechanism 50 thus configured will be described. The state of transferring the optical disk 2 is monitored by detecting the press of first to fourth switches SW1 to SW4 mounted on the circuit board 59. As shown in FIG. 11, the first switch SW1 is disposed in the rotation area of the rotating support member 71 of the eject arm 52, and H/L is switched by pressing down the switch by means of the bend strip 81 formed on the rotating support member 71 in association with the rotation of the eject arm 52. In addition, as shown in FIG. 11, the second to fourth switches SW2 to SW4 are arranged over the moving area of the slider 122, and H/L is in turn switched by sliding the slider 122 in the direction of arrow f₁ or in the direction of arrow f₂.

In the disk drive apparatus 1, the pressing states and time periods of the first to fourth switches SW1 to SW4 are monitored by a microcomputer, whereby the transfer state of the optical disk 2 is detected, and the displacement drive mechanism 36, for example, is driven to move the drive motor 121, the spindle motor 24a, or the optical pickup 25.

Before the optical disk 2 is inserted, as shown in FIG. 11, the slider 122 is slid in the direction of arrow f₂ in the drawing that is the disk port 19 side. Thus, for the loading arm 51, the engagement projecting part 64 is retained on the side surface facing to the first guide part 66a formed in the first cam groove 66 of the loading cam plate 53, and the abutting part 61 is rotated and held at the position retracted from the transfer area of the optical disk 2. In addition, the third link arm 100 which is engaged in the slider 122 is rotated in the direction of arrow c₂ in FIG. 11, whereby the eject arm 52, which is rotated by the operation arm 58 and the first link arm 54 is rotated in the direction of arrow b₂ in FIG. 11. In addition, the slider 122 is slid in the direction of f₂, whereby the subslider 151 is slid in the direction of arrow h₂ in the drawing. Thus, the subchassis 29 configuring the base unit 22 is descended on the bottom case 4 side, and is retracted from the transfer area of the optical disk 2.

When a user inserts the optical disk 2 from the disk port 19, the support part 88 of the eject arm 52 is pressed against the surface of the insertion end of the optical disk 2, and the eject arm 52 is rotated in the direction of arrow b₁ in FIG. 12, as shown in FIG. 12. At this time, since for the eject arm 52, the rotating support member 71 is rotated in the direction of arrow b₁ as it is pivoted about the mounting opening 71b, for the first link arm 54 which is engaged in the rotating support member 71, the end 54a is moved in the same direction as well. On the other hand, for the second link arm 55 which is engaged in the first link arm 54, the first link arm 54 is moved in the direction of arrow b₁, whereby the guide projecting part 113 which is engaged in the guide groove 114 of the loop cam 57 is moved toward the front side of the housing 3 side along the insertion guide wall 112a. Since the insertion guide wall 112a of the loop cam 57 is extended on the front side of the housing 3 toward the right guide wall 118 side, when the second link arm 55 is guided by the insertion guide wall 112a, the end 54b of the first link arm 54 which is engaged in the second link arm is moved on the right guide wall 118 side, and is moved in the opposite direction of the end 54a of the first link arm 54 being rotated in the direction of arrow b₁ along with the rotating support member 71.

In other words, for the first link arm 54, the retaining part 96 near the end 54b engaged in the second link arm 55 is moved in the direction separated from the retaining part 98 of the main chassis 6. Therefore, as the optical disk 2 is inserted and the eject arm 52 is rotated in the direction of arrow b₁ in FIG. 12, the tensile coil spring 56 spanned between the first link arm 54 and the main chassis 6 is extended, and it energizes so that the retaining part 96 of the first link arm 54 is pulled to the retaining part 98 of the main chassis 6. Here, since the engagement hole 80 of the rotating support member 71 is rotated on the front side of the housing 3, for the first link arm 54, it is energized by the tensile coil spring 56 to apply force going on the back side of the housing 3, that is, the energizing force going on the opposite side of the rotating direction of the rotating support member 71. Therefore, the eject arm 52 is energized in the direction of arrow b₂ in FIG. 12 that is the eject direction of the optical disk 2.

Thus, since the optical disk 2 is inserted as it runs counter to the energizing force in the eject direction working on the eject arm 52, even though a user stops inserting the optical disk 2 halfway, the disk is ejected out of the housing 3. Therefore, such an event can be prevented that the optical disk 2 is left inside the housing 3 halfway.

When the optical disk 2 is inserted by the user while it is running counter to the energizing force and the eject arm 52 is rotated to a predetermined angle, the first switch SW1 arranged on the circuit board 59 is pressed by the bend strip 81 of the rotating support member 71, and then the drive mechanism 120 is activated. The drive mechanism 120 receives the drive force of the drive motor 121, and the slider 122 is slid in the direction of arrow f₁ in FIG. 14. Thus, since the loading cam plate 53 is also slid in the same direction together with the slider 122, for the loading arm 51, the engagement projecting part 64 abuts against the first guide part 66a of the first cam groove 66. In the loading arm 51, the engagement projecting part 64 is pressed by the first guide part 66a in the direction of arrow f₁, whereby the abutting part 61 is rotated in the direction of arrow a₁ in FIG. 14 about the insertion hole 60 to draw the optical disk 2.

In addition, when the slider 122 is slid in the direction of arrow f₁ and the optical disk 2 is transferred by the loading arm 51 to the centering position positioned on the disk mounting part 23, as shown in FIG. 15, the engagement projecting part 64 is moved through the first cam groove 66 of the loading cam plate 53 from the first guide part 66a to the second guide part 66b. Since the second guide part 66b is formed in parallel with the slide direction of the slider 122, the loading arm 51 is not guided by the engagement projecting part 64 in association with the movement of the slider 122, and it holds the optical disk 2 at the centering position. In addition, in the drawing operation of the optical disk 2, the state of pressing down the first to fourth switches SW1 to SW4 is detected to tell that the base unit 22 is descended to the chucking release position, and thus the optical disk 2 can be transferred safely.

Moreover, the optical disk 2 is loaded by the loading arm 51 as well as it is guided by the right and left guide walls 117 and 118. In addition, the disk abuts against the deck arm 200 and the centering guide 220, described later, whereby it is centered on the disk mounting part 23.

In addition, when the slider 122 is slid in the direction of arrow f₁, the third link arm 100 is guided by the first guide groove 125 of the slider 122 and rotated in the direction of arrow c₁ in FIG. 14, and the operation arm 58 engaged in the third link arm 100 is moved in the direction of arrow d₁ in the same drawing. Therefore, the first link arm 54 engaged in the end 58b of the operation arm 58 is pressed by the operation arm 58, and moved in the direction of arrow d₁.

In addition, as shown in FIG. 12, when the eject arm 52 is rotated to the position of activating the drive mechanism 120, the guide projecting part 113 of the second link arm 55 is movable from the insertion guide wall 112a of the loop cam 57 to the pulling guide wall 112b. Thus, when the first link arm 54 is moved by the operation arm 58 in the direction of arrow d₁, the second link arm 55 is also moved in the same direction. The first link arm 54 and the second link arm 55 are moved in the direction of arrow d₁, whereby in the first link arm 54, the retaining part 96 formed on the end 54b is brought closer to the retaining part 98 formed in the main chassis 6, and the tensile coil spring 56 is being contracted. Therefore, in the drawing operation of the optical disk 2, the energizing force in the direction of arrow b₂ working on the eject arm 52 is gradually lost. In addition, in the disk transfer mechanism 50, since the eject arm 52 is rotated in the direction of arrow b₁ by the operation arm 58 receiving the drive force of the drive mechanism 120, the drawing operation of the optical disk 2 done by the loading arm 51 is not hampered by the energizing force in the eject direction working on the eject arm 52, and the disk can be drawn smoothly with no load applied to the optical disk 2.

Moreover, since the second link arm 55 is rotated and energized in the direction of arrow g₂ by the torsion coil spring 119 retained on the first link arm 54, the guide projecting part 113 is moved to the border between the pulling guide wall 112b and the ejecting guide wall 112c, and then it can easily go over the projecting part 112e disposed on the border, and will not again go back to the pulling guide wall 112b side in ejecting the optical disk 2.

In the eject arm 52, the first link arm 54 is moved by the operation arm 58 in the direction of arrow d₁, and the guide projecting part 113 of the second link arm 55 is moved in the direction of arrow d₁ while it is being guided by the pulling guide wall 112b, whereby the energizing force of the tensile coil spring 56 is lost. In addition, the optical disk 2 is drawn into the back side of the housing 3 by the loading arm 51, whereby the pushing arm 72 and the rotating support member 71 are rotated in the direction of arrow b₁ in FIG. 12.

In addition, when the slider 122 is slid in the direction of arrow f₁, a coupling arm 165 which is engaged in the slider 122 is rotated to slide the subslider 151 as well in the direction of arrow h₁ in FIG. 15. Then, after the optical disk 2 is centered, the base unit 22 is ascended from the chucking release position to the chucking position by the slider 122 and the subslider 151. Thus, for the optical disk 2 transferred at the centering position, the rim part of the center hole 2a is clamped by the turntable 23a and the abutting protrusion part 8 formed on the rim part of the opening 7 of the top plate 5a, and is chucked on the turntable 23a.

Moreover, at this time, the detection of the state of pressing down the first to fourth switches SW1 to SW4 tells that the base unit 22 is ascended to the chucking position, and that the optical disk 2 is chucked on the turntable 23a.

When the slider 122 is moved in the direction of arrow f₁ as well as the subslider 151 is further slid in the direction of arrow h₁, the base unit 22 is descended from the chucking position to the recording/reproducing position. At this time, the state of pressing down the first to fourth switches SW1 to SW4 is detected, which tells that the base unit 22 is descended to the recording/reproducing position.

When the optical disk 2 is chucked on the turntable 23a, the third link arm 100 is further rotated in the direction of arrow c₁ by the slider 122 being slid in the direction of arrow f₁, and the operation arm 58 is further moved in the direction of arrow d₁. Thus, the eject arm 52 is rotated in the direction of arrow b₁ through the first link arm 54. In addition, an abutting projecting part 168 at the tip end of the subslider 151 is bumped against the bend strip 81 of the rotating support member 71, and the rotating support member 71 is rotated in the direction of arrow b₁. Therefore, for the eject arm 52, the support part 88 of the pushing arm 72 is separated from the optical disk 2. In addition, the eject arm 52 is rotated in the direction of arrow b₁, whereby the rotating strip 82 formed on the rotating support member 71 presses the centering guide 220 which is rotated and energized over the disk transfer area, and the centering guide 220 is separated from the side surface of the optical disk 2. Moreover, the slider 122 is slid in the direction of arrow f₁, and then the engagement projecting part 64 is moved from the second guide part 66b of the loading cam plate 53 to the third guide part 66c. Thus, the loading arm 51 is rotated in the direction of arrow a₂ in FIG. 16, and the abutting part 61 is separated from the side surface of the optical disk 2.

In addition, the deck arm 200 which has centered the optical disk 2 is pressed against the loading cam plate 53, and then separated from the side surface of the optical disk 2.

Accordingly, the optical disk 2 is released from various arms and the centering guide 220 to be rotatable, and then the disk waits for the recording or reproducing operation by a user.

In addition, as shown in FIG. 16, the subslider 151 is moved in the direction of arrow h₁, and then the tip end part is bumped against the bend strip 81 of the rotating support member 71 to restrict the rotation of the rotating support member 71 in the direction of arrow b₂. Thus, such an event can be prevented that the rotating support member 71 is rotated in the direction of arrow b₂ and the pushing arm 72 or the centering guide 220 is bumped against the optical disk 2 being rotated and driven.

In addition, in the step of loading the optical disk 2 in the disk drive apparatus 1, after the optical disk 2 is chucked on the turntable 23a, a so-called double chucking is performed in which the spindle motor 24a is driven to half rotate the optical disk 2 and to inversely rotate the drive motor 121, whereby the base unit 22 is again ascended for chucking. Thus, such an event can be prevented that the optical disk 2 is recorded or reproduced as it is engaged in the turntable 23a halfway.

When the recording/reproducing operation is finished to eject the optical disk 2 by a user, first, the drive motor 121 of the drive mechanism 120 is inversely rotated, and the slider 122 is slid in the direction of arrow f₂ in FIG. 17. Thus, the engagement projecting part 64 is moved from the third guide part 66c to the second guide part 66b of the loading cam plate 53, whereby the loading arm 51 is rotated in the direction of arrow a₁ in FIG. 17, and the abutting part 61 abuts against the side surface of the optical disk 2.

In addition, after the subslider 151 is slid in the direction of arrow h₂ in the same drawing and the press against the rotating support member 71 is released, then, the slider 122 rotates the third link arm 100 in the direction of arrow c₂, and the operation arm 58 is moved in the direction of arrow d₂. Thus, since the end 54b is also moved in the direction of arrow d₂ in the first link arm 54, in the eject arm 52, the rotating support member 71 engaged in the end 54a of the first link arm 54 is rotated in the direction of arrow b₂, and the abutting part 61 of the pushing arm 72 abuts against the side surface of the optical disk 2. Here, since the guide projecting part 113 of the second link arm 55 is moved on the ejecting guide wall 112c side of the loop cam 57, the eject arm 52 is rotated without separating the retaining part 96 of the first link arm 54 from the retaining part 98 of the main chassis 6, and the energizing force in the eject direction due to the tensile coil spring 56 is not generated.

Furthermore, the loading cam plate 53 is moved in the same direction in association of the movement of the slider 122 in the direction of arrow f₂, and then the deck arm 200 pressed by the loading cam plate 53 also abuts against the side surface of the optical disk 2.

Subsequently, the slider 122 is further slid in the direction of arrow f₂, and the subslider 151 is slid in the direction of arrow h₂ in FIG. 17, whereby the base unit 22 is descended from the recording/reproducing position to the chucking release position. Thus, the optical disk 2 is thrust up by the guide pin 180 raised on the bottom case 4 to release its chucking on the turntable 23a. The guide pin 180 which releases the chucking of the optical disk 2 will be described later.

Moreover, at this time, the state of pressing down the first to fourth switches SW1 to SW4 is detected to tell that the base unit 22 is descended to the chucking release position, and that the state is attained that the optical disk 2 is safely ejected.

After that, the third link arm 100 engaged in the slider 122 is slid through the first guide groove 125 of the slider 122, and the third link arm is further rotated in the direction of arrow c₂, whereby the operation arm 58 is further moved in the direction of arrow d₂. As shown in FIG. 18, when the first link arm 54 is moved in the same direction in association with the movement of the operation arm 58 in the direction of arrow d₂, the eject arm 52 is rotated in the direction of arrow b₂ in FIG. 18 in accordance with the travel of the operation arm 58, and ejects the optical disk 2.

At this time, since the engagement projecting part 64 is engaged in the first cam groove 66 of the loading cam plate 53, the loading arm 51 is rotatable in accordance with only the slide of the loading cam plate 53, and its free rotation is restricted. Then, the loading cam plate 53 is slid in the direction of arrow f₂ in FIG. 18 together with the slider 122, and thus, the engagement projecting part 64 of the loading arm 51 is guided from the second guide part 66b to the first guide part 66a. Although the rotation of the loading arm 51 is restricted in the direction of arrow a₂ by the first guide part 66a, the first guide part 66a is moved on the front side of the housing 3 in accordance with the slide of the slider 122 while the optical disk 2 is being ejected on the front side of the housing 3 by the eject arm 52, and then the loading arm is rotatable in the direction of arrow a₂. Therefor, the loading arm will not hamper the optical disk 2 from being ejected by the eject arm 52.

In addition, as described above, the engagement projecting part 64 abuts against the first guide part 66a to restrict the rotation of the loading arm 51 in the direction of arrow a₂ that is the eject direction of the optical disk 2, and the loading arm 51 is rotatable in the direction of arrow a₂ in association with the slide of the slider 122 and the rotation of the eject arm 52. Therefore, such an event can be prevented that the optical disk 2 is energized in the eject direction by the deck arm 200 and is suddenly popped out of the disk port 19.

Furthermore, by the plate spring 62 fixed to the deck part 4a, the loading arm 51 is energized in the direction of arrow a₁ in which the optical disk 2 is energized into the housing 3 all the time. Therefore, when the engagement projecting part 64 is rotated to the position at which it abuts against the first guide part 66a, the loading arm 51 is energized by the plate spring 62 in the direction of arrow a₁. Thus, the loading arm applies the energizing force in the insertion direction to the optical disk 2 when the disk is moved by the eject arm 52 and the deck arm 200 in the eject direction, and prevents the optical disk 2 from popping out. In addition, since the energizing force generated by the plate spring 62 is weaker than the rotating force by the eject arm 52 in the eject direction, it will not hamper the optical disk 2 from being ejected by the eject arm 52, and will not apply an excess load to the optical disk 2.

In addition, by moving the first link arm 54 in the direction of arrow d₂ by means of the operation arm 58, for the second link arm 55, the guide projecting part 113 is slid over the loop cam 57 in the area surrounded by the ejecting guide wall 112c and the outer wall 112d. At this time, the rotating support member 71 of the eject arm 52 is also rotated in the direction of arrow b₂ through the first link arm 54 by means of the operation arm 58, whereby the engagement hole 80 in which the first link arm 54 is engaged is moved toward the back side of the housing 3 in the direction of arrow b₂. Thus, the first link arm 54 which is engaged in the engagement hole 80 is moved toward the back side of the housing 3 in the direction of arrow d₂ as in almost the same attitude with hardly changing its angle. Since the retaining part 98 formed in the main chassis 6 is formed near the left corner part on the back side on which the loop cam 57 is retained, the retaining part 96 of the first link arm 54 is moved as it maintains almost the equal distance to the retaining part 98 of the main chassis 6, and the tensile coil spring 56 will not be extended. Therefore, the eject arm 52 is not energized by the tensile coil spring 56, and is rotated by the drive force of the drive mechanism 120 in the direction of arrow b₂ that is the eject direction by the amount corresponding to the slide of the slider 122. Thus, the eject arm can stably eject the optical disk 2 to a predetermined eject position without popping out the optical disk 2 by the energizing force of the tensile coil spring 56.

In addition, at this time, since the optical disk 2 is slidably contacted with the panel curtain disposed on the disk port 19 of the front panel 18, when the energizing force works on the eject arm 52 and the first link arm 54 relatively in the direction of arrow b₁, as described above, for the disk transfer mechanism 50, the rotation of the first link arm 54 in the direction of arrow d₂ is restricted by abutting the engaging protrusion part 116 of the second link arm against the side wall inside the cam groove 108 of the operation arm 58. Thus, the first link arm 54 and the eject arm 52 are rotated by the amount corresponding to the sliding amount of the slider 122 in the direction of arrow f₂ in association with the movement of the operation arm 58 in the direction of arrow d₂. Therefore, the disk transfer mechanism 50 can rotate the eject arm 52 by the amount corresponding to the slide of the slider 122 as it runs counter to the energizing force in the direction of arrow b₁.

As shown in FIG. 19, when the slider 122 is moved to the initial position, the detection switch is pressed to stop the slide operation, and correspondingly, the eject arm 52 is also rotated to the initial position by the operation arm 58 and the first link arm 54, and stops the optical disk 2 at the position at which the center hole 2a is ejected from the disk port 19. At this time, the state of pressing down the first to fourth switches SW1 to SW4 is detected to tell that the eject arm 52 transfers the optical disk 2 to a predetermined eject position, and then the drive of the drive motor 121 is stopped.

Here, the timing of drawing the optical disk 2 inserted by a user by means of the loading arm 51 and the timing of restricting the loading arm 51 from ejecting in ejecting the optical disk 2 are decided by the position of the loading cam plate 53 of the first guide part 66a in the slide direction and the length of the second guide part 66b.

In other words, as described above, the rotation of the loading arm 51 is restricted by guiding the engagement projecting part 64 by means of the first cam groove 66 of the loading cam plate 53. When the eject arm 52 is rotated in the direction of arrow b₂ to start ejecting the optical disk 2, the engagement projecting part 64 abuts against the second guide part 66b and the first guide part 66a to restrict the rotation in the direction of arrow a₂ that is the eject direction of the optical disk 2, and then the amount of rotation in the direction of arrow a₂ is decided in accordance with the travel of the first guide part 66a in the direction of arrow f₂. Therefore, suppose that the length of the second guide part 66b is shortened and the position of the first guide part 66a is moved on the front side of the loading cam plate 53 in the slide direction (in the direction of arrow f₂) by that amount. Thus, the timing is made earlier by that amount, at which the engagement projecting part 64 is restricted first by the second guide part 66b and then by the first guide part 66a, and the loading arm can be rotated in the direction of arrow a₂ at a relatively earlier timing than the rotation of the eject arm 52 in the direction of arrow b₂. Thus, the timing of rotating the loading arm 51 by the loading cam plate 53 is delayed more than the timing of ejecting the optical disk 2 by the eject arm 52, whereby such an event can be prevented that the loading arm 51 hampers the optical disk 2 from being ejected.

On the other hand, the timing of drawing the optical disk 2 is also decided by the position of the first guide part 66a of the loading cam plate 53 and the length of the second guide part 66b. In other words, when a user inserts the optical disk 2 to activate the drive mechanism 120, the slider 122 and the loading cam plate 53 are moved in the direction of arrow f₁. Thus, since the engagement projecting part 64 abuts against the first guide part 66a which is being moved in the direction of arrow f₁, the loading arm 51 is rotated in the direction of arrow a₁, and draws the optical disk 2 inserted by the user into the back side of the housing 3. Therefore, when the second guide part 66b is formed long and the position of the first guide part 66a in the slide direction of the loading cam plate 53 is formed on the back side of the slide direction (in the direction of arrow f₁), the loading arm 51 is allowed to start drawing the disk at an earlier stage in which the insertion depth from the disk port 19 is shallow by that amount, that is, the user does not insert the optical disk 2 deep so much.

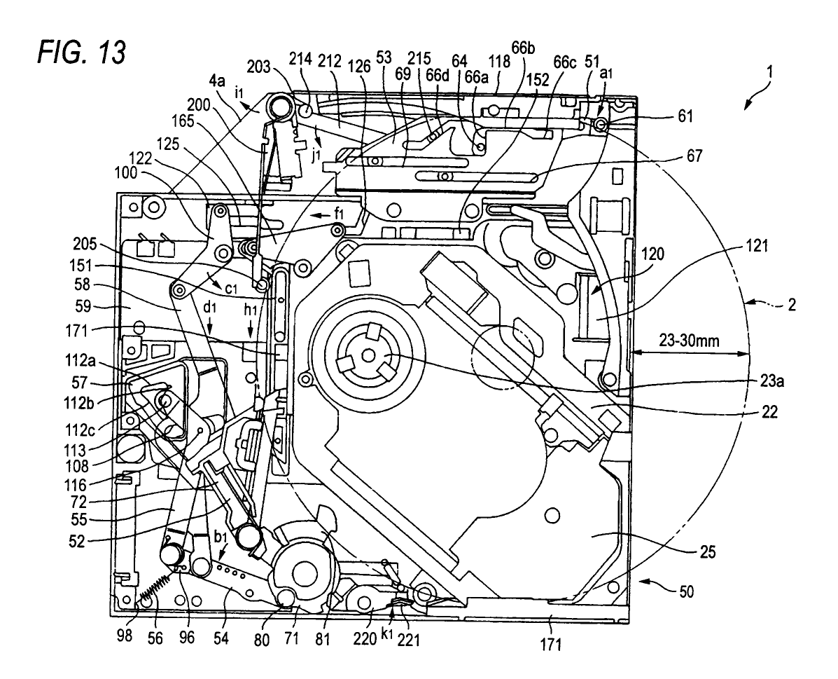

Then, in the disk transfer mechanism 50, the position at which the first guide part 66a of the loading cam plate 53 is formed and the length of the second guide part 66b are decided so as to allow the prevention of the loading arm 51 from hampering the optical disk 2 to be ejected and to allow early drawing of the optical disk 2. As shown in FIG. 13, in the disk drive apparatus 1, for example, in the case in which an optical disk having a diameter of 12 cm is used, it is designed to allow the loading arm 51 to draw the disk when the disk is inserted to the position at which the distance between the disk port 19 and the side surface of on the back side in the insertion direction of the optical disk is about 23 mm to 30 mm. As described above, in the disk drive apparatus 1, the position of drawing the optical disk 2 is placed at the position apart from the disk port 19, whereby the distance for insertion by a user can be shortened, and the disk can be drawn without inserting the optical disk 2 deep to the rear part of the housing 3, leading to improved use.

In addition, the timing of drawing the loading arm 51 toward the insertion direction (in the direction of arrow a₁) in drawing the optical disk 2 and the timing of rotating the loading arm 51 toward the eject direction (in the direction of arrow a₂) in ejecting the optical disk 2 by the eject arm 52 can be regulated by the first cam groove 66 formed on the loading cam plate 53. However, the loading cam plate 53 is operated by reciprocation in the directions of inserting and removing the slider 122 (in the directions of arrows f₁ and f₂) when the optical disk 2 is drawn and ejected. In addition, in drawing and ejecting the optical disk 2, the slider 122 is slid along the same route by the same travel at the same speed as well. Therefore, in drawing and ejecting the optical disk 2, the amounts of rotation of the loading arm 51 in the directions of arrows a₁ and a₂ are the same with respect to the amounts of sliding the slider 122 and the loading cam plate 53, and the rotation of the loading arm 51 in the direction of arrow a₁ and the rotation thereof in the direction of arrow a₂ are uniquely determined by the slide positions of the slider 122 and the loading cam plate 53.

On the other hand, the eject arm 52, which is rotated in the eject direction of the optical disk 2 (in the direction of arrow b₂), has different amounts of rotation with respect to the amount of sliding the slider 122 between the insertion direction (in the direction of arrow b₁) in inserting the optical disk 2 and the eject direction (in the direction of arrow b₂). This is because in drawing the optical disk 2, the eject arm 52 is rotated to some extent in the insertion direction (in the direction of arrow b₁) due to the insertion operation done by the user before the slider 122 is driven, whereas the eject arm ejects the optical disk 2 including the amount of insertion done by the user in ejecting the optical disk 2. In other words, in drawing and ejecting the optical disk 2, although the amount of sliding the slider 122 is the same, the amounts of rotation of the eject arm 52 are different which is rotated in accordance with the slide of the slider 122.

In inserting and ejecting the optical disk 2, the timings of rotating the eject arm 52 with respect to the movement of the slider 122 are different because the trace of movement of the second link arm 55, which is coupled to the rotating support member 71 of the eject arm 52 through the first link arm 54, is restricted by the loop cam 57 during the time from insertion of the optical disk 2 to ejection of the disk. In other words, in the state in which the slider 122 is not driven, the optical disk 2 is inserted from the disk port 19 and the eject arm 52 is rotated in the direction of arrow b₁, and then the second link arm 55 is guided by the insertion guide wall 112a. Then, the slider 122 is driven from the front side to the back side of the housing 3 to rotate the eject arm 52 further in the direction of arrow b₁, and the optical disk 2 is drawn to the disk mounting part 23. At this time, the second link arm 55 is guided by the pulling guide wall 112b. Then, the slider 122 is driven from the back side to the front side of the housing 3 to rotate the eject arm in the direction of arrow b₂, and then the optical disk 2 is ejected from the disk mounting part 23 to the disk port 19. At this time, the second link arm 55 is guided by the ejecting guide wall 112c, and moved to the insertion guide wall 112a. As described above, it is configured that the travels of the second link arm 55 being guided by the loop cam 57 with respect to the travel of the slider 122 at the time of drawing and ejecting the optical disk 2 are made different from that at the time of ejecting the optical disk 2.

As described above, both of the loading arm 51 and the eject arm 52 are rotated in accordance with the slide of the slider 122. The loading arm 51 is driven linearly in a reciprocating manner by the loading cam plate 53 together with the slider 122, whereas the trace of movement of the eject arm 52 is controlled by the second link arm 55 moving on orbit with respect to the reciprocating slider 122. Also in the disk transfer mechanism 50, the trace of the guide projecting part 113 of the second link arm 55 can be decided uniquely, and the guide projecting part is circled around the guide groove 114 of the loop cam 57 with respect to the reciprocating slider 122. The timings of rotating the loading arm 51 and the eject arm 52 can be matched with respect to the reciprocating slider 122.

Here, for the guide groove 114 of the loop cam 57 in which the guide projecting part 113 of the second link arm 55 is slid, in the case in which the groove is formed narrow with no margin for the trace of the guide projecting part 113 which is moved in accordance with the eject arm 52 and the movement of the slider 122 during the time from insertion to ejection of the optical disk 2, the guide projecting part 113 might not be moved smoothly because of errors in accuracy or in mounting the loop cam 57 or various arms and in deterioration over time, or the guide projecting part 113 might not be circled around the guide groove 114. Then, it is necessary for the loop cam 57 to provide some margin to the guide groove 114 on which the guide projecting part 113 is circled around.

On the other hand, the provision of some margin to the guide groove 114 might not allow the second link arm 55 and the eject arm 52 to accurately follow the movement of the slider 122. For example, in ejecting the optical disk 2, the timing of sliding the second link arm 55 toward the ejecting guide wall 112c, the second link arm being moved through the operation arm 58 and through the first link arm 54 in association with the movement of the slider 122 in the direction of arrow f₂, is shifted from the timing of sliding the loading cam plate 53 in association with the slide of the slider 122, and then the timing of rotating the eject arm 52 in the direction of arrow b₂ can be shifted from the timing of rotating the loading arm 51 which is rotated in the direction of arrow a₂ in association with the slide of the slider 122. Thus, the loading arm 51 might not be released when the eject arm 52 is about to eject the optical disk 2, which might hamper the optical disk 2 from being ejected.

In order to absorb a shift between the timing of ejecting the eject arm 52 and the timing of releasing the loading arm 51, and to smoothly eject the optical disk 2 by the eject arm 52, the insertion hole 60 is formed long into which the rotating support member 63 perforated in the loading arm 51 is inserted. Since the loading arm 51 has the long insertion hole 60, the rotating support point is moved along the longitudinal direction of the insertion hole 60. Thus, when the loading arm 51 is energized in the direction of arrow a₂ by the optical disk 2 which is pressed by means of the eject arm 52, the rotating support point is moved and the loading arm is rotatable in the same direction. Therefore, even though a shift occurs between the timings of rotating the eject arm 52 and the loading arm 51 in association with a stroke of the slider 122, the loading arm will not hamper the optical disk 2 from being ejected.

In addition, the insertion hole 60 of the loading arm 51 is formed long, and the first guide part 66a of the first cam groove 66 formed on the loading cam plate 53 is disposed on the back side of the housing 3 to elongate the second guide part 66b, whereby the timing of drawing the optical disk 2 is made early. Even in this case, it can be prevented that the timing of releasing the loading arm 51 in the direction of arrow a₂ is delayed in ejecting the optical disk 2.

In other words, the engagement projecting part 64 is pressed by the first guide part 66a of the first cam groove 66, and then the loading arm 51 is rotated in the direction of arrow a₁ that draws the optical disk 2 into the housing 3. Therefore, suppose that the loading arm is contacted with the first guide part 66a as fast as possible from the start of sliding the slider 122, the distance of inserting the optical disk 2 by user's hand can be shortened. In contrast to this, after the engagement projecting part 64 is guided by the second guide part 66b of the first cam groove 66 and then moved along the first guide part 66a, the loading arm 51 is rotatable in the direction of arrow a₂ in which the optical disk 2 is ejected out of the housing 3. Therefore, the second guide part 66b is provided long, the eject arm 52 is rotated in the direction of arrow b₂ in which the optical disk 2 is ejected, and then the engagement projecting part 64 is moved on the first guide part 66a, whereby the loading arm 51 is rotated in the direction of arrow a₂, otherwise it is difficult to rotate the loading arm to hamper the optical disk 2 from being ejected.

At this time, since the insertion hole 60 is formed long to shift the rotating support point, the loading arm 51 can be rotated in the direction of arrow a₂, and it can be prevented that the timing of releasing the loading arm 51 in the direction of arrow a₂ is delayed in ejecting the optical disk 2.

Moreover, in addition to disposing the long insertion hole 60 on the loading arm 51 and the rotating support member 63 on the deck part 4a, such a scheme may be performed in which a cylindrical rotating support member 63 is protruded on the loading arm 51, a long insertion hole 60 is perforated in the deck part 4a, and the loading arm 51 is supported rotatably.

Here, in the case in which the optical disk 2 is inserted by a predetermined amount to start driving the drive motor 121 and then a user becomes aware that a wrong optical disk 2 has been inserted and grabs the optical disk 2 quickly, the disk transfer mechanism 50 stops the drive motor 121, and then inversely drives it to eject the optical disk 2.

More specifically, when the optical disk 2 is inserted by a predetermined amount by means of the disk port 19 to drive the drive motor 121, the loading arm 51 is rotated in the direction of arrow a₁ in association with the movement of the slider 122 and the loading cam plate 53 in the direction of arrow f₁. At this point in time, when a user grabs the optical disk 2, the rotation of the loading arm 51 is restricted, and the loading cam plate 53 is slid in the direction of arrow f₁ together with the slider 122. Thus, the engagement projecting part 64 protruded on the loading arm 51 is retained on the first guide part 66a of the loading cam plate 53. Therefore, the slides of the slider 122 and the loading cam plate 53 in the direction of arrow f₁ are restricted. After a predetermined time period elapses in this state, the drive motor 121 is inversely driven, and the optical disk 2 is ejected in the reverse manner to the inserting step of the optical disk 2 described above.

At this time, the optical disk 2 is inserted by a predetermined amount, and then the guide projecting part 113 of the second link arm 55 is also slid along the insertion guide wall 112a of the loop cam 57. Thus, the retaining part 96 of the first link arm 54 and the retaining part 98 of the main chassis 6 are moved in the direction in which they are separated from each other, and the tensile coil spring 56 spanned therebetween is extended. Therefore, when the drive motor 121 is inversely driven and the slider 122 is finished sliding in the direction of arrow f₂, the first link arm 54 applied with the energizing force of the tensile coil spring 56 is rotated, and the eject arm 52 is rotated in the direction of arrow b₂. Therefore, in the disk drive apparatus 1, the eject arm 52 is rotated and energized by the tensile coil spring 56 in the direction of arrow b₂ in which the optical disk 2 is ejected out of the disk port 19, and the optical disk 2 is ejected by the energizing force of the tensile coil spring 56.

Thus, the guide projecting part 113 of the second link arm 55 goes reversely along the insertion guide wall 112a, not passing through the ejecting guide wall 112c side, whereby the eject arm 52 can be rotated to the eject position by the energizing force of the tensile coil spring 56 stored in inserting the optical disk 2, although it is difficult to rotate the eject arm 52 to the eject position by the slide of the slider 122 in the direction of arrow f₂. Therefore, such an event can be prevented that in loading the optical disk 2, the optical disk 2 is grabbed to stop driving the drive motor 121 and the optical disk 2 is left as it is brought halfway from the disk port 19.

Moreover, such abnormal transfer of the optical disk 2 can be detected by a microcomputer to monitor the state of pressing down the first to fourth switches SW1 to SW4 mounted on the circuit board 59. In other words, it is detected that the disk on abnormal transfer when it takes a predetermined time period, for example, three seconds or longer for the slider 122 sliding until the eject arm 52 presses down the first switch SW1 and it is detected that the base unit 22 is descended to the chucking release position, or when it takes a predetermined time period or longer until the base unit 22 is moved from the chucking release position through the chucking position to the recording/reproducing position. Then, the drive motor 121 is stopped or reversely rotated to eject the optical disk 2.

In addition, when an obstacle such as a book is placed in front of the disk port 19 in ejecting the optical disk 2, the optical disk 2 abuts against that obstacle for no ejection, and thus an excess load is applied to the drive motor 121 of the drive mechanism 120. In addition, the optical disk 2 is clamped between that obstacle and the eject arm 52 being rotated with the drive force of the drive motor 121, and thus an excess load is applied to the optical disk 2 as well.

Here, as shown in FIG. 23, in the disk drive apparatus 1, the rotating support member 71 of the eject arm 52 is rotatably engaged in the pushing arm 72 by the caulking shaft 89 in the directions of arrows b₁ and b₂ around the opening 77 and the engagement projecting part 85, and they are energized by the coil spring 73 in the direction of arrow b₂ with a predetermined force. Therefore, even in the case in which in ejecting the optical disk 2, an obstacle blocking the ejection of the optical disk 2 is placed and the eject arm 52 receives the force in the opposite direction of the eject direction of the optical disk 2 (in the direction of arrow b₂), and the pushing arm 72 applied with the force in the opposite direction is rotated in the direction of arrow b₁, such an event can be prevented that an excess load is applied to the drive motor 121 or the optical disk 2.

In the disk drive apparatus 1, when the pushing arm 72 of the eject arm 52 is rotated in the direction of arrow b₁, the drive of the drive motor 121 is stopped. In this state, after a predetermined time period elapses as an obstacle placed in front of the disk port 19 blocks the ejection of the optical disk 2, the optical disk 2 is again drawn to the disk mounting part 23 side. In other words, the optical disk 2 is ejected out of the disk port 19, one side surface of the optical disk 2 abuts against the obstacle, and then the ejection of the optical disk 2 is stopped for a predetermined time period. Then, the drive motor 121 is rotated inversely. Therefore, the first and second link arms 54 and 55 and the operation arm 58 are moved in the reverse manner to the manner described above, and they load the optical disk 2. Moreover, also in this case, since the guide projecting part 113 of the second link arm 55 goes inversely along the ejecting guide wall 112c, the first link arm 54 and the retaining part 98 of the main chassis 6 are moved as they are not separated from each other. Therefore, the tensile coil spring 56 is not extended, and the energizing force in the eject direction does not work on the eject arm 52.

Thus, in the disk drive apparatus 1, such events can be prevented that the optical disk 2 is left as it is clamped between the obstacle and the eject arm 52 being rotated in the eject direction, and that an excess load is applied to the drive motor 121 or the optical disk 2.

Moreover, such abnormal transfer of the optical disk 2 can be detected by the microcomputer to monitor the state of pressing down the first to fourth switches SW1 to SW4 mounted on the circuit board 59. In other words, it is detected that the disk on abnormal transfer when it takes a predetermined time period, for example, three seconds or longer for the slider 122 moving until the drive motor 121 is reversely rotated and the base unit 22 is descended from the recording/reproducing position through the chucking position to the chucking release position, or when it takes a predetermined time period or longer for the slider 122 moving until the base unit 22 is descended to the chucking release position and all of the first to fourth switches SW1 to SW4 are not pressed down. Then, the drive motor 121 is stopped, or rotated forward to load the optical disk 2.

In addition, for the loop cam 57, a large movable area 114a of the guide projecting part 113 is provided in the direction of extending the insertion guide wall 112a and the pulling guide wall 112b of the guide groove 114. The movable area 114a prevents such an event that when the optical disk 2 is inserted into the most rear part of the housing 3 in the state in which the power source of the disk drive apparatus 1 is not turned on, the guide projecting part 113 abuts against the rim part 112d of the loop cam 57 to damage the disk transfer mechanism 50, and the maximum movable range is secured for the guide projecting part 113 in association with the optical disk 2.

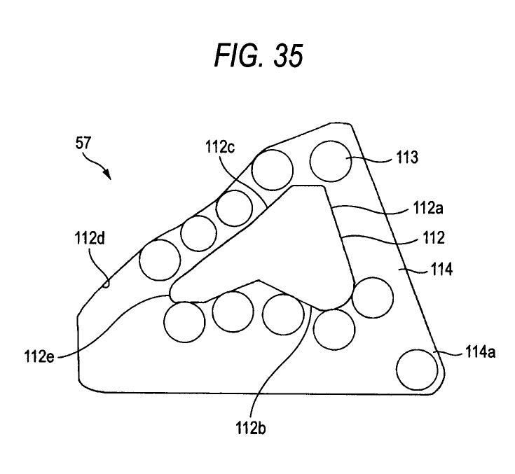

In other words, as shown in FIG. 35, in the state in which the power source of the disk drive apparatus 1 is turned on, when the optical disk 2 is inserted, the drive motor 121 is driven, and the guide projecting part 113 moves the pulling guide wall 112b to the ejecting guide wall 112c side in association with the slide of the slider 122 in the direction of arrow f₁ and the movement of the operation arm 58 moving in the direction of arrow d₁. However, in the state in which the power source of the disk drive apparatus 1 is not turned on, the drive motor 121 is not driven even though the optical disk 2 is inserted into the rear part of the housing 3. Thus, the guide projecting part 113 is not moved to the ejecting guide wall 112c side by the operation arm 58 and the second link arm 55. Therefore, when a user pushes the optical disk 2 to the rear part beyond the original position of starting drawing the disk, the eject arm 52 is rotated further in the direction of arrow b₁ to cause the guide projecting part 113 of the second link arm 55 off the original route of the guide groove 114 and to abut against the rim part 112d, and then an excess load is applied to the loop cam 57, the first and second link arms 54 and 55, or the eject arm 52.

Therefore, the loop cam 57 secures the maximum movable range for the guide projecting part 113 as the movable area 114a when the optical disk 2 is inserted into the most rear part of the housing 3 in the state in which the power source is not turned on. Thus, in the disk drive apparatus 1, even though the optical disk 2 is inserted into the most rear part of the housing 3 in the state in which the power source is not turned on, or even though a user does not wait for the loading arm 51 to draw the optical disk 2 and pushes the disk to the most rear part of the housing 3 in the state in which the power source is turned on, the disk transfer mechanism 50 can be prevented from being damaged due to the collision of the guide projecting part 113 against the loop cam 57.

As described above, according to the disk transfer mechanism 50 of the disk drive apparatus 1 to which an embodiment of the invention is applied, in inserting the optical disk 2, in the process that the optical disk 2 is inserted to a predetermined position by a user, the guide projecting part 113 of the second link arm 55 is slid along the insertion guide wall 112a of the loop cam 57 to guide the first link arm 54 and the retaining part 98 of the main chassis 6 in the direction in which they are separated from each other, and then the energizing force in the eject direction generated by the tensile coil spring 56 spanned therebetween can be worked on the eject arm 52. Therefore, such an event can be prevented that a user stops inserting the optical disk 2 to cause the optical disk 2 to remain halfway inside the housing 3.

In addition, in drawing the optical disk, the guide projecting part 113 is slid along the pulling guide wall 112b of the loop cam 57 to bring the first link arm 54 closer to the retaining part 98 and to further rotate the eject arm 52 in the drawing direction by the operation arm 58, whereby the energizing force in the eject direction applied to the eject arm 52 by means of the tensile coil spring 56 is removed, and the eject arm 52 can be rotated in accordance with the operation of the slider 122 and the operation arm 58 having applied with the drive force of the drive mechanism 120.

In ejecting the optical disk 2, the guide projecting part 113 is slid along the ejecting guide wall 112c of the loop cam 57, whereby the eject arm 52 can be rotated in the eject direction by the amount corresponding to the operation of the slider 122 and the operation arm 58 with no separation between the first link arm 54 and the retaining part 98.

Therefore, in the disk transfer mechanism 50, the optical disk 2 can be stably ejected at a predetermined stop position at which the center hole 2a of the optical disk 2 is brought outside the housing 3 without relying on the elastic force the drive force of the drive mechanism 120.

Furthermore, since the disk transfer mechanism 50 does not adopt such a mechanism in which in ejecting the optical disk 2, the eject arm 52 is rotated by the energizing force of the tensile coil spring 56, an eject lever having applied with this energizing force will not cause sounds when the lever abuts against the optical disk. Therefore, the disk drive apparatus 1 does not generate noise in ejecting the optical disk 2, for improved use.

Next, the deck arm 200 which prevents a wrong optical disk 101 of small diameter from being inserted as well as intends to center the optical disk 2 of large diameter will be described. The deck arm 200 is provided for preparation of such an event that a user inserts an optical disk 101 of small diameter (for example, a diameter of 8 cm) because the disk drive apparatus 1 is configured dedicated to the optical disk 2 of large diameter (for example, a diameter of 12 cm).

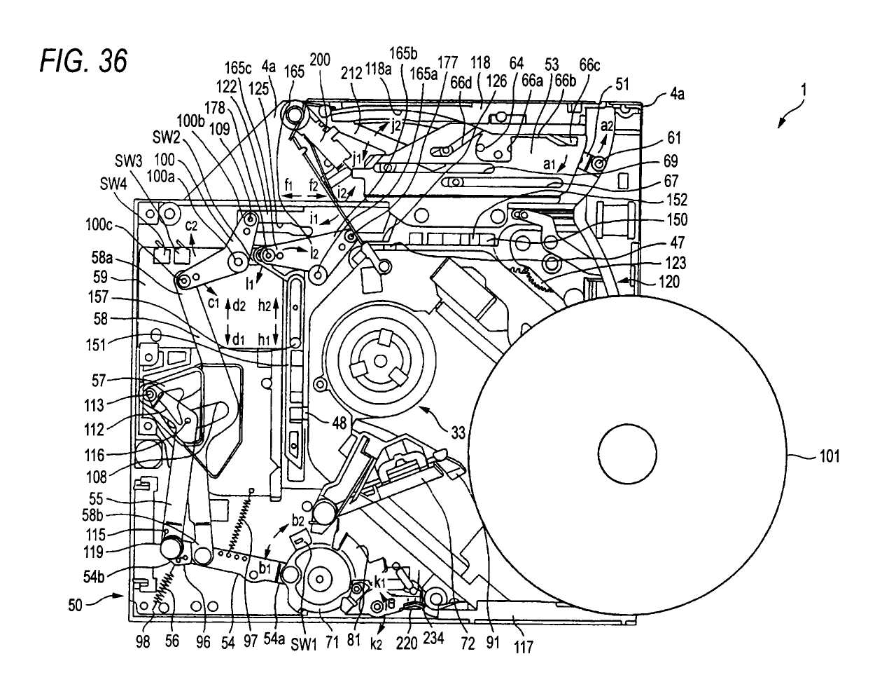

In other words, when the small diameter disk 101 abuts against the pushing arm 72 of the eject arm 52, as shown in FIG. 36, the disk is pushed back out of the disk port 19 by the energizing force in the direction of arrow b₂ generated by the tensile coil spring 56 which is retained on the first link arm 54 or the coil spring 73 which is engaged in the pushing arm 72, and the eject arm 52 is not rotated to the position at which the drive mechanism 120 is driven. On the other hand, the small diameter disk 101 is inserted as it leans to the loading arm 51 side, the disk does not abut against the pushing arm 72 of the eject arm 52 and inserted to the rear part of the housing 3, and then the disk might remain at the position out of the rotation area of the eject arm 52.

Then, the deck arm 200 is disposed on the deck part 4a on the opposite side of the eject arm 52 to prevent a small diameter disk from being inserted to the rear part of the housing 3 even though the small diameter disk 101 is inserted as it leans to the loading arm 51 side.

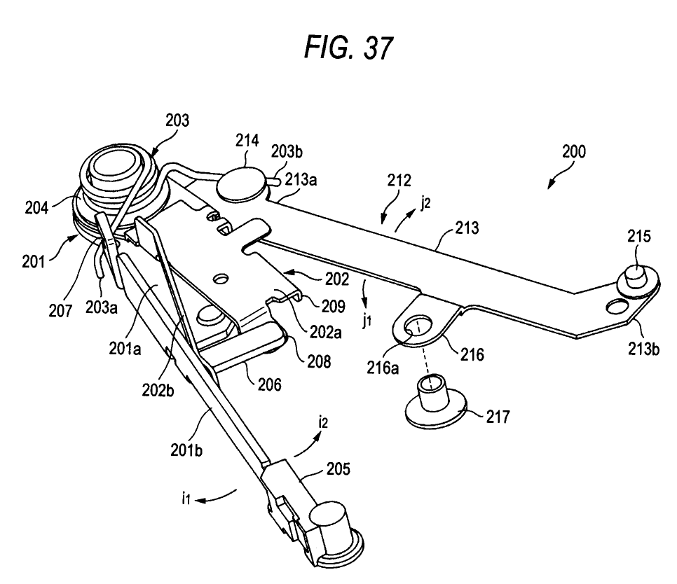

As shown in FIG. 11, the deck arm 200 is rotatably disposed on the deck part 4a of the bottom case 4 on the back side of the housing 3. It is rotated and energized on the disk port 19 side in the state in which the optical disk 2 is waited to insert, and it can eject a disk out of the disk port 19 with the energizing force generated by inserting the small diameter disk 101. More specifically, as shown in FIG. 37, the deck arm 200 has an arm member 201 which is rotatably supported by the deck part 4a to abut against the optical disk 2 and the small diameter disk 101, a pressing plate 202 which is coaxially supported with the arm member 201 to press the arm member 201, and the coil spring 203 which rotates and energizes the arm member 201, and the arm member 201 and the pressing plate 202 are rotatably mounted on the deck part 4a by a caulking shaft 204.

The arm member 201 has a rotating plate 201a in a rectangular plate shape, and an arm part 201b which is raised from one side edge in the longitudinal direction of the rotating plate 201a and is extended in the longitudinal direction. On the tip end of the arm part 201b, an abutting member 205 is disposed which abuts against the optical disk 2 or the small diameter disk 101. The rotating plate 201a has a rotating support part on one end in the longitudinal direction which is supported by the deck part 4a, and has a guide strip 206 on the other end side which guides the rotation of the pressing plate 202. The arm part 201b is formed with a slit 207 at the end part on the rotating support part in the longitudinal direction on which the end 203a of the coil spring 203 is retained.

The pressing plate 202, which is coaxially supported with the arm member 201, reliably separates the arm member 201 from the disk outer rim in mounting the optical disk 2 on the turntable 23a, having a main surface part 202a which is overlaid over the rotating plate 201a of the arm member 201, and a pressing arm 202b which is raised on one side edge on the arm part 201b side of the main surface part 202a and presses the arm part 201b. The main surface part 202a is formed in a nearly rectangular shape, having a rotating support part on one end in the longitudinal direction which is supported by the deck part 4a together with the arm member 201, and a guide projecting part 208 is projected on the other end side which is guided by the guide strip 206 formed on the rotating plate 201a of the arm member 201. The pressing plate 202 is prevented from floating from the rotating plate 201a by guiding the guide projecting part 208 by means of the guide strip 2o6. The pressing plate 202 has an abutting strip 209 on the side edge part on the opposite side of the side edge at which the pressing arm 202b is disposed, the abutting strip which abuts against the tip end part of the loading cam plate 53 to be slid in the direction of arrow f₁. The deck arm 200 is rotated in the direction of arrow i₁ by pressing the abutting strip 209 against the loading cam plate 53, and then the abutting member 205 disposed at the tip end part of the arm part 201b is separated from the outer rim surface of the optical disk 2.

The pressing arm 202b, which is raised from the main surface part 202a, is extended on the arm member 201 side, and the tip end thereof abuts against the arm part 201b of the arm member 201. When the main surface part 202a of the pressing plate 202 is pressed against the loading cam plate 53, the pressing arm 202b presses the arm part 201b in the direction of arrow i₁.

The arm member 201 and the pressing plate 202 are rotatably supported by the caulking shaft 204 on the deck part 4a, the caulking shaft 204 is wounded with the coil spring 203, and the coil spring 203 rotates and energizes the arm member 201 and the pressing plate 202 in the direction of arrow i₂ that is the eject direction of the optical disk 2 all the time. The end 203a of the coil spring 203 is retained on the slit 207 of the arm part 201b, and the end 203b is retained on the regulation arm 212 which restricts the energizing force by the coil spring 203.

The regulation arm 212 prevents the energizing force from increasing in the direction of arrow i₂ by moving the end 203b of the coil spring 203 when the deck arm 200 is rotated in the direction of arrow i₁ on the back side of the housing 3. As similar to the deck arm 200, the regulation arm 212 has an arm main body 213 which is rotatably mounted on the deck part 4a, a spring retaining part 214 which is disposed on the end 213a side of the arm main body 213 and on which the end 203b of the coil spring 203 is retained, and a rotating guide part 215 which is disposed on the end 213b side of the arm main body 213 and is engaged in the fourth guide part 66d of the first cam groove 66 formed on the loading cam plate 53.

The arm main body 213 is formed long, and has an inserting strip 216 nearly in the middle in the longitudinal direction into which a rotating support pin 217 is inserted that rotatably retains the arm main body 213 on the deck part 4a. The inserting strip 216 is perforated with an insertion hole 216a into which the rotating support pin 217 is inserted. The rotating support pin 217 is inserted into the inserting strip 216, and thus the arm main body 213 is rotatably retained on the deck part 4a as it is pivoted about the inserting strip 216. The rotating support pin 217 is projected above the deck part 4a through the insertion hole 216a, whereby it is inserted into the third cam groove 69 formed on the loading cam plate 53 in parallel with the slide direction to guide the slide of the loading cam plate 53.

On the spring retaining part 214, which is formed on the end 213a of the arm main body 213, the end 203b of the coil spring 203 is retained. Thus, the coil spring 203 maintains a predetermined interval between the regulation arm 212 and the arm member 201 where the end 203a is retained on the slit 207 of the arm part 201b. For the coil spring 203, the optical disk 2 is inserted to rotate the arm member 201 in the direction of arrow i₁. When the rotation of the regulation arm 212 is restricted, the end 203a which is retained on the slit 207 of the arm part 201b is moved in the direction separating from the end 203b as the coiled part 203c is centered which is inserted into the caulking shaft 204. Thus, sine the end 203a of the coil spring 203 is energized on the end 203b side, the arm part 201b of the arm member 201 applied with the energizing force is energized in the direction of arrow i₂ on the front side of the housing 3 side as the optical disk 2 is being inserted into the housing 3. Therefore, since the energizing force in the eject direction is applied to the deck arm 200 having the energizing force of the coil spring 203 applied thereto, the deck arm 200 can eject the wrong small diameter disk 101 that has been inserted out of the housing 3.

As shown in FIG. 21, the rotating guide part 215 disposed on the end 203b of the arm main body 213 is inserted into the fourth guide part 66d of the loading cam plate 53, whereby the rotating guide part rotates the regulation arm 212 in accordance with the slide of the loading cam plate 53 in the direction of arrows f₁ and f₂, and controls the energizing force of the coil spring 203. In other words, as shown in FIGS. 13, 14 and 15, when the optical disk 2 is inserted to slide the loading cam plate 53 in the direction of arrow f₁ together with the slider 122, the rotating guide part 215 is guided by the fourth guide part 66d to rotate the arm main body 213 is rotated as it is pivoted about the inserting strip 216, and the spring retaining part 214 is rotated in the direction of arrow j₁ in which the deck arm 200 is followed that is rotated in the direction of arrow i₁. The spring retaining part 214 follows the deck arm 200, and then in the coil spring 203, the end 203a retained on the arm part 201b is not separated from the end 203b retained on the spring retaining part 214. Thus, the energizing force is not increased in association with the rotation of the deck arm 200 in the direction of arrow i₁. Therefore, the regulation arm 212 follows in association with the rotation of the deck arm 200, whereby the energizing force of the coil spring 203 which energizes the arm member 201 in the eject direction maintains a constant state, and the drawing operation of the optical disk 2 by the loading arm 51 is not greatly hampered.

In addition, when the loading cam plate 53 is slid in the direction of arrow f₂, as shown in FIG. 18, the rotating guide part 215 is guided and rotated by the fourth guide part 66d, and the spring retaining part 214 is rotated in the direction of arrow j₂. At this time, for the deck arm 200, since the end 203a is also energized by the energizing force of the coil spring 203 in the direction of coming close to the end 203b, the arm member 201 is rotated in the direction of arrow i₂. Then, when the optical disk 2 is ejected to stop the rotation of the spring retaining part 214 in the direction of arrow j₂, the deck arm 200 is also rotated to the initial position, and it waits for the optical disk 2 to insert.

In addition, the abutting member 205, which is disposed at the tip end of the arm part 201b, is formed of a resin softer than the optical disk 2, in which the center part is bent inside that abuts against the rim part of the optical disk 2 inserted from the disk port 19, a flange with wider diameter is formed at the lower end part, and the abutting member is formed to regulate the movement of the optical disk 2 in the height direction.

Next, the operation of the deck arm 200 and the regulation arm 212 in the steps of inserting, drawing and ejecting the optical disk 2 will be described. As shown in FIG. 11, in the state in which the optical disk 2 is waited to insert, in the regulation arm 212, the rotating guide part 215 is guided by the fourth guide part 66d of the loading cam plate 53 to rotate the spring retaining part 214 in the direction of arrow j₂. In addition, the spring retaining part 214 is rotated in the direction of arrow j₂, the deck arm 200 is energized by the end 203a of the coil spring 203, and the arm member 201 is rotated in the direction of arrow i₂. At this time, the rotation of the deck arm 200 is restricted in the direction of arrow i₂ by abutting the tip end part of the guide strip 206 against the tip end of the loading cam plate 53.

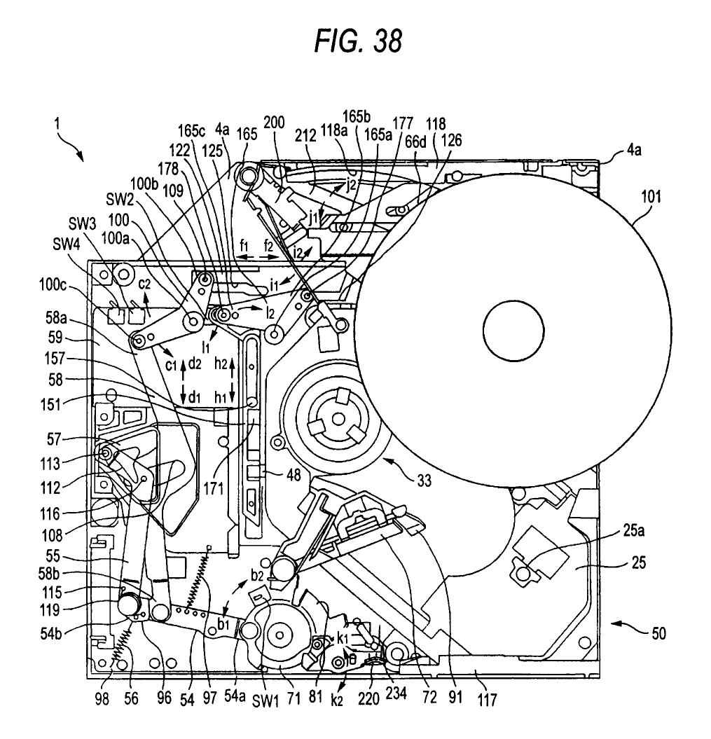

In addition, in the state in which the optical disk 2 is waited to insert, in the eject arm 52 and the deck arm 200, at least one of the pushing arm 72 and the abutting member 205 is abuttable against the small diameter disk 101 inserted from the disk port 19. As shown in FIG. 38, when the small diameter disk 101 is inserted into the housing 3 as the disk leans to the deck part 4a side, in the deck arm 200, the abutting member 205 is pressed by the small diameter disk 101 to rotate the arm part 201b in the direction of arrow i₁. Therefore, since the end 203a of the coil spring 203 retained on the arm part 201b is separated from the end 203b retained on the spring retaining part 214, the energizing force of the coil spring 203 is generated for the deck arm 200 in the direction of arrow i₂ that is the eject direction. Even though the small diameter disk 101 is fully inserted from the disk port 19, the drive mechanism 120 is not driven, and thus the disk is ejected out of the housing 3 by the deck arm 200. Therefore, even though a wrong small diameter disk 101 is inserted, the small diameter disk 101 can be reliably ejected with no disk remaining inside the housing 3.

When the optical disk 2 of large diameter is inserted, the deck arm 200 is pressed by the optical disk 2, and the arm member 201 is rotated in the direction of arrow i₁. As shown in FIG. 12, in the step of inserting the optical disk 2, the drive mechanism 120 is not driven, and the slider 122 and the loading cam plate 53 are not slid. Thus, the spring retaining part 214 of the regulation arm 212 is not rotated. Therefore, when the arm member 201 is rotated in the direction of arrow i₁, in the coil spring 203, the end 203a retained on the arm member 201 is separated from the end 203b retained on the spring retaining part 214, and the coil spring applies to the deck arm 200 the energizing force in the direction of arrow i₂.

Going to the step of drawing the optical disk 2, the loading cam plate 53 is slid in the same direction in association with the slide of the slider 122 in the direction of arrow f₁. As shown in FIGS. 13, 14 and 15, when the loading cam plate 53 is slid, the loading arm 51 draws the optical disk 2 to rotate the deck arm 200 further in the direction of arrow i₁, the regulation arm 212 is rotated as it is guided by the fourth guide part 66d of the first cam groove 66 and is pivoted about the inserting strip 216, and the spring retaining part 214 is rotated in the direction of arrow j₁ for following the deck arm 200. Therefore, in the coil spring 203 mounted on the deck arm 200, the end 203a retained on the arm member 201 is not separated from the end 203b retained on the spring retaining part 214, and the energizing force working on the deck arm 200 is not increased. Thus, such an event can be prevented that the energizing force of the deck arm 200 in the direction of arrow i₂ generated by the coil spring 203 is increased as the optical disk 2 is being drawn to hamper the drawing operation done by the loading arm 51. In addition, also in the step of drawing the optical disk 2, since the energizing force in the direction of arrow i₂ by the coil spring 203 works on the deck arm 200, the abutting member 205 energizes the rim part of the optical disk 2 with a predetermined force in the same direction.

As shown in FIG. 16, when most of the optical disk 2 is drawn on the disk mounting part 23, the abutting strip 209 of the pressing plate 202 is bumped against the tip end part of the loading cam plate 53, and the deck arm 200 is rotated further in the direction of arrow i₁. When the pressing plate 202 is pressed by the loading cam plate 53, the pressing arm 202b extended from the main surface part 202a energizes the arm part 201b of the arm member 201 in the direction of arrow i₁. Therefore, the deck arm 200 can reliably separate the abutting member 205 mounted on the arm part 201b from the outer rim surface of the optical disk 2 mounted on the turntable 23a.

In the step of ejecting the optical disk 2, the loading cam plate 53 is moved by the slider 122 in the direction of arrow f₂. When the loading cam plate 53 is slid, the loading arm 51 is rotated in the direction of arrow a₂ on the front side of the housing 3, and the eject arm 52 is rotated in the direction of arrow b₂ to eject the optical disk 2. As shown in FIG. 18, by sliding the loading cam plate 53, the rotating guide part 215 is guided by the fourth guide part 66d to rotate the regulation arm 212 as it is pivoted about the inserting strip 216, and the spring retaining part 214 is rotated in the direction of arrow j₂. Thus, the end 203b of the coil spring 203 is rotated in the direction of arrow j₂ together with the spring retaining part 214, and then the end 203a of the coil spring 203 and the arm member 201 retained on the end 203a are rotated by the energizing force of the coil spring 203 in the same direction. In addition, since the coil spring 203 is rotated in accordance with the rotation of the regulation arm 212, the energizing force of the coil spring 203 is not increased, and the deck arm 200 pops the optical disk 2 out with the energizing force of the coil spring 203.

When the slide of the loading cam plate 53 is stopped, the rotation of the regulation arm 212 is also stopped. Thus, the rotation of the deck arm 200 caused by the energizing force of the coil spring 203 is stopped as well, and the deck arm is returned to the initial position waiting for the optical disk 2 to insert.

In addition, when the abutting member 205 abuts against the rim part of the optical disk 2 and is rotated on the back side of the housing 3 to draw most of the optical disk 2 to near the disk mounting part 23, the deck arm 200 energizes the optical disk 2 by the coil spring 203 in the direction of arrow i₂ with a constant force. At this time, in the direction of energizing the abutting member 205, the centering guide 220 is disposed which is retained on the main chassis 6, and the optical disk 2 is centered right above the turntable 23a of the disk mounting part 23 by the deck arm 200, the centering guide 220 and the loading arm 51 which draws the optical disk 2 into the housing 3.

As described above, the deck arm 200 is rotatably supported at the position on the back side of the housing 3 more than the disk mounting part 23 on the deck part 4a, whereby the deck arm can function for preventing a wrong small diameter disk 101 from being inserted and for the centering guide of the optical disk 2. In addition, since the area of the deck part 4a on the back side of the housing 3 is secured as an available space even when the optical disk 2 is mounted on the disk mounting part 23, the deck arm 200 has the rotating support point in this area, whereby the small space inside the housing 3 can be utilized effectively, leading to no increase in the size of the housing 3.

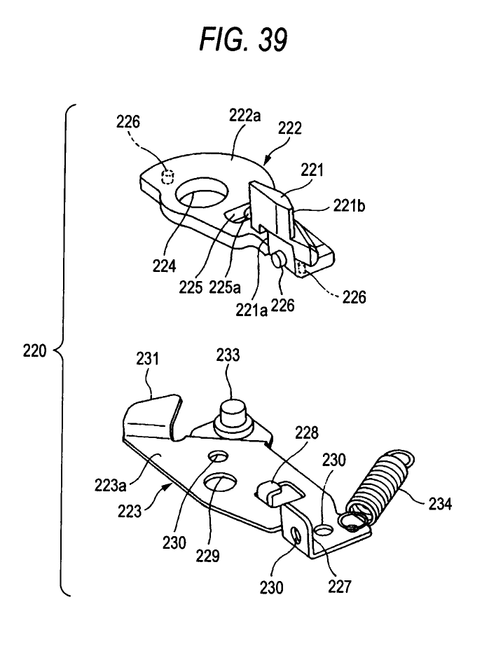

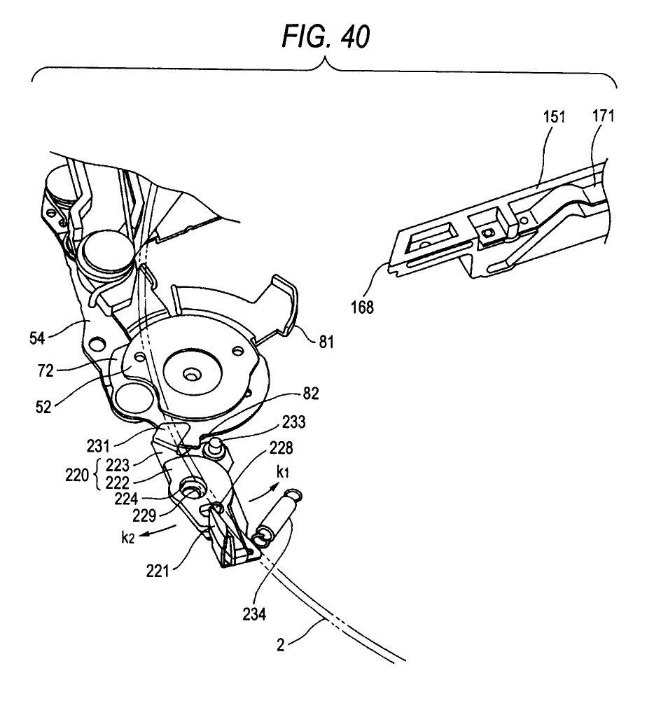

Next, the centering guide 220 which is intended to center the optical disk 2 together with the deck arm 200 will be described. As shown in FIG. 3, the centering guide 220 is protruded from the opening 6h for centering guide of the main chassis 6 to the top 6a side, which supports the side surface of the optical disk 2 and guides centering. As shown in FIGS. 39 and 40, the centering guide has a guide plate 222 which is disposed with the guide strip 221 that supports the side surface of the optical disk 2, and a rotating plate 223 which rotates the guide plate 222, in which the guide plate 222 and the rotating plate 223 are mounted in one piece together, and they are rotatably mounted on the top 6a of the main chassis 6 from the back surface side.

The guide plate 222 is formed of a resin mold product, and has the guide strip 221 raised from one end of the main surface part 222a for guiding the outer rim surface of the optical disk 2. The main surface part 222a is formed with an insertion hole 224 which is connected to an opening 229 formed in the rotating plate 223 and into which a caulking pin is inserted. In addition, the main surface part 222a is formed with a retain hole 225 having a retaining part 225a which is retained on a retain strip 228 raised on the rotating plate 223. Moreover, the main surface part 222a has a coupling projecting part 226 on the back side and the side surface thereof which is inserted into a coupling hole 230 of the rotating plate 223. Then, the retaining part 225a is retained on the retain strip 228, and the coupling projecting part 226 is inserted into the coupling hole 230, whereby the guide plate 222 is rotatable in one piece with the rotating plate 223.

The guide strip 221 has an abutting wall 221a which is raised from the main surface of the guide plate 222 and abuts against the side edge of the opening 6h for centering guide, and a guide part 221b which is projected over the main chassis 6 and abuts against the rim part of the optical disk 2 to guide centering the disk. In the guide strip 221, the guide plate 222 is rotated and energized together with the rotating plate 223 toward the rim side of the optical disk 2 drawn into the housing 3, whereby the abutting wall 221a abuts against the side edge of the opening 6h for centering guide to intend to position the guide part 221b, and the guide part 221b supports the outer rim surface of the optical disk 2.

The rotating plate 223 is formed of a sheet metal member, and on the main surface part 223a, it is formed with a support wall 227 which supports the guide strip 221 raised on the guide plate 222, the retain strip 228 which is inserted into the retain hole 225, the opening 229 which is coaxially connected to the insertion hole 224, and the coupling hole 230 into which the coupling projecting part 226 is inserted.

The support wall 227 is formed with the coupling hole 230 into which the coupling projecting part 226 is inserted that is projected from the abutting wall 221a of the guide strip 221 sideward. The support wall 227 supports the abutting wall 221a, and energizes the guide strip 221 on the outer rim surface of the optical disk 2 side by rotating and energizing the rotating plate 223 by means of a tensile coil spring 234, described later. The retain strip 228 is raised from the main surface part 223a of the rotating plate 223, and is retained on the retaining part 225a of the retain hole 225 of the guide plate 222 by bending the tip end thereof in the nearly orthogonal direction. Thus, the retain strip 228 energizes the guide plate 222 to the outer rim surface of the optical disk 2 side together with the support wall 227.

In addition, the opening 229 is connected to the insertion hole 224 of the guide plate 222, and a caulking pin, not shown, is inserted. Thus, the centering guide 220 is rotatably supported over the top 6a of the main chassis 6, and is rotatable in the direction of arrow k₁ in FIG. 40 in which the guide strip 221 is rotated on the outer rim surface of the optical disk 2 side, and in the direction of arrow k₂ in which the guide strip 221 is separated from the outer rim surface of the optical disk 2.

In addition, on the main surface part 223a, the rotating plate 223 is formed with the cam shaft 233 which is rotated by the rotating strip 82 formed on the rotating support member 71 of the eject arm 52. The cam shaft 233 is formed by mounting the caulking pin on the main surface part 223a of the rotating plate 223. In the centering guide 220, the eject arm 52 is rotated in the direction of arrow b¹ in which the optical disk 2 is drawn, whereby the rotating strip 82 of the rotating support member 71 abuts and presses against the cam shaft 233 to rotate the guide strip 221 in the direction of arrow k₂ in which the outer rim surface of the optical disk 2 is separated as it is pivoted about the caulking pin which is inserted into the insertion hole 224 and the opening 229.

In addition, the rotating plate 223 has an engagement strip 231 on the main surface part 223a which is engaged in the rotating support member 71 of the eject arm 52. As shown in FIG. 40, the engagement strip 231 is bent upper than the main surface part 223a, and then is bent on the rotating support member 71 side, whereby it is formed at the position higher than the main surface part 223a, and is extended over the rotating support member 71. Therefore, the rotating plate 223 is engaged in the main surface of the rotating support member 71 to bump the cam shaft 233 against the rotating strip 82.

Furthermore, the rotating plate 223 has the tensile coil spring 234 retained on the main surface part 223a, the tensile coil spring which rotates and energizes the centering guide 220 in the direction of arrow k₁ in which the guide strip 221 abuts against the outer rim surface of the optical disk 2. Its one end is retained on the rotating plate 223, and the other end is retained on the main chassis 6, whereby the tensile coil spring 234 rotates and energizes the guide strip 221 of the centering guide 220 in the direction of arrow k₁ all the time. The guide strip 221 is rotated and energized in the direction of arrow k₁, whereby the abutting wall 221a is pressed against the side edge of the opening 6h for centering guide disposed on the main chassis 6 to intend to position the guide part 221b. In the centering guide 220, the abutting wall 221a is energized in the opening 6h for centering guide by the energizing force of the tensile coil spring 234 for positioning, whereby the guide part 221b can be prevented from rocking in the direction of arrow k₂ in which the outer rim surface of the optical disk 2 is separated.

Next, the step of centering the optical disk 2 using the centering guide 220 will be described. As described above, in the steps of inserting and drawing the optical disk 2, the guide strip 221 is rotated and energized in the direction of arrow k₁ that is the direction of the outer rim surface of the optical disk 2 by the energizing force of the tensile coil spring 234 before the cam shaft 233 of the rotating plate 223 is pressed by the rotating strip 82 formed on the rotating support member 71 of the eject arm 52, and the outer rim surface of the optical disk 2 can be guided by the guide part 221b.

In addition, the engagement projecting part 64 is guided by the first cam groove 66 of the loading cam plate 53, whereby the loading arm 51 draws the optical disk 2 to the centering position at which the center hole 2a is positioned right above the turntable 23a. More specifically, the engagement projecting part 64 is guided by the first guide part 66a of the first cam groove 66, the loading arm 51 is rotated in the direction of arrow a₁ in which the optical disk 2 is drawn, and it carries the disk nearly to the centering position. The engagement projecting part 64 is guided by the second guide part 66b, whereby the rotation of the loading arm 51 is restricted in the directions of arrows a₁ and a₂.

Furthermore, when the optical disk 2 is carried nearly to the centering position, the deck arm 200 is pressed by the outer rim surface of the optical disk 2, and rotated in the direction of arrow i₁. At this time, the coil spring 203 applies the energizing force in the direction of arrow i₂ to the arm member 201, and the deck arm 200 applies it to the optical disk 2. The energizing force works on the optical disk 2 toward the direction of the turntable 23a by means of the abutting member 205 mounted on the arm member 201. As described above, the energizing force is maintained in a constant amount by the movement of the spring retaining part 214 in association with the rotation of the regulation arm 212 with no increase.

In other words, in the disk drive apparatus 1, as shown in FIG. 15, when the optical disk 2 is drawn into the housing 3, the rocking of the loading arm 51 and the centering guide 220 is restricted, and a constant energizing force works on the optical disk 2 by the deck arm 200. Then, in the disk drive apparatus 1, around the turntable 23a, the abutting part 61 of the loading arm 51, the guide strip 221 of the centering guide 220, and the abutting member 205 of the deck arm 200 support the outer rim surface of the optical disk 2 at three points as the disk mounting part 23 is centered. Among the three points, the optical disk 2 is supported rigidly by two points of the abutting part 61 and the guide strip 221 in the state in which rocking is restricted, and the energizing force is applied from the remaining point to the turntable 23a by the abutting member 205.

As described above, in the disk drive apparatus 1, the loading arm 51 which draws the optical disk 2 above the disk mounting part 23 is rigidly positioned in accordance with the centering position of the optical disk 2, whereby it can be reliably intended to center the optical disk 2.

In addition, in the disk drive apparatus 1, in addition to the loading arm 51, the centering guide 220 is rigidly positioned in accordance with the centering position of the optical disk 2, whereby it can be more reliably intended to center the optical disk 2.

Furthermore, in the disk drive apparatus 1, among the abutting part 61, the abutting member 205 and the guide strip 221 arranged nearly equally around the turntable 23a, two of them are made rigid in accordance with the centering position of the optical disk 2, and the remaining one energizes the optical disk 2 toward the turntable 23a side, whereby the disk can be centered more reliably. Thus, when the base unit 22 is ascended to the chucking position by the slider 122, described later, and by the subslider 151, the optical disk 2 can be smoothly chucked on the turntable 23a. Therefore, no sounds can occur by chucking the center hole 2a of the optical disk 2 on the turntable 23a as they are shifted, and a load can be eliminated on the optical disk 2 or the turntable 23a.

Here, when all of the abutting part 61, the guide strip 221 and the abutting member 205 are rigidly regulated which support the outer rim surface of the optical disk 2 in centering, a shift might occur at the centering position of the optical disk 2 due to errors in the outer dimensions of the optical disk 2, or in accuracy of components, leading to no smooth chucking of any types of the optical disks 2. On the other hand, the abutting member 205 is configured to be rotatably energized, not in rigid configuration, whereby errors in accuracy of the optical disk 2 or in the components can be absorbed, and the optical disk 2 can be reliably centered.

Moreover, at this time, the loading cam plate 53 guiding the engagement projecting part 64 is combined with the slider 122, and the slider 122 is supported across the slide direction by the bottom case 4, described later, whereby the loading arm 51 rotatably supported by the deck part 4a is positioned to the main chassis 6 similarly arranged on the bottom case 4 through the loading cam plate 53 and the slider 122. In addition, the guide strip 221 is rotated and energized by the opening 6h for centering guide of the main chassis 6, whereby the centering guide 220 is positioned to the main chassis 6. The base unit 22 disposed with the turntable 23a is supported up and down to the main chassis 6 as described later. In other words, to the main chassis 6, the loading arm 51 and the centering guide 220 is intended to position on one hand, and the turntable 23a is intended to position on the other hand.

Therefore, the loading arm 51 and the centering guide 220 are intended to be positioned to the main chassis 6, and they intend to center the optical disk 2 to the turntable 23a which is similarly positioned to the main chassis 6. Thus, the disk is reliably centered.

In addition, when the disk is centered, in the step of drawing the optical disk 2, in the eject arm 52, the guide projecting part 113 of the second link arm 55 is guided by the pulling guide wall 112b of the loop cam 57, whereby the retaining part 96 of the first link arm 54 is brought closer to the retaining part 98 formed in the main chassis 6, and the tensile coil spring 56 is returned from the extended state. At this time, the eject arm 52 may be configured in which the energizing force works in the direction of arrow b₂ on the disk mounting part 23 side when the force is small on the optical disk 2. Thus, in the disk drive apparatus 1, the optical disk 2 is supported at three points by the eject arm 52 which is energized on the disk mounting part 23 side, and by the loading arm 51 and the centering guide 220 which are restricted to the centering position of the optical disk 2 around the disk mounting part 23, and thus the optical disk 2 can be centered.

As shown in FIG. 16, when the optical disk 2 is chucked, in the centering guide 220, the cam shaft 233 formed on the rotating plate 223 is pressed by the rotating strip 82 disposed on the rotating support member 71 of the eject arm 52, whereby the rotating plate 223 and the guide plate 222 are rotated about the insertion hole 224 as they run counter to the energizing force of the tensile coil spring 234, and the guide strip 221 is moved in the direction of arrow k₂. Thus, in the guide strip 221, the guide part 221b is separated from the outer rim surface of the optical disk 2.

In addition, as described above, the engagement projecting part 64 is guided by the third guide part 66c of the first cam groove 66 of the loading cam plate 53, the loading arm 51 is rotated in the direction of arrow a₂, and the abutting part 61 is separated from the rim part of the optical disk 2. In addition, also in the deck arm 200, the abutting strip 209 of the pressing plate 202 is pressed by the tip end of the loading cam plate 53 in the direction of arrow f₁, whereby the arm member 201 energized by the pressing arm 202b is rotated in the direction of arrow i₁, and the abutting member 205 mounted on the arm member 201 is separated from the rim part of the optical disk 2. Moreover, the eject arm 52 is also rotated in the direction of arrow b₁ through the operation arm 58 in association with the slide of the slider 122, and the support part 88 and the pickup part 90 are separated from the rim part of the optical disk 2.

Therefore, the optical disk 2 chucked on the turntable 23a is released from the arms supporting the rim part and the centering guide 220, and the disk is rotatable by the disk rotating drive mechanism 24.

As shown in FIG. 11, the drive mechanism 120, which supplies the drive force to the disk transfer mechanism 50, has the drive motor 121, the slider 122 which receives the drive force of the drive motor 121 to slide inside the bottom case 4, and a gear train 123 which transmits the drive force of the drive motor 121 to the slider 122, and they are arranged on the bottom case 4 side of the main chassis 6. The drive mechanism 120 drives the disk transfer mechanism 50 and the base ascending/descending mechanism 150 by sliding the slider 122 by means of the drive motor 121.

When the optical disk 2 is inserted to a predetermined position and the first switch SW1 is pressed by the rotating support member 71 of the eject arm 52, the drive motor 121 is driven in the forward the direction in which the slider 122 is moved in the direction of arrow f₁. In addition, when the eject operation is made, the drive motor 121 is driven in the backward direction in which the slider 122 is moved in the direction of arrow f₂. The slider 122 is moved in the direction of arrow f₁ in FIG. 11 or in the direction of f₂ depending on the loading and ejecting the optical disk 2, and then it drives the arms of the disk transfer mechanism 50 and the base ascending/descending mechanism 150. The gear train 123 transmits the drive force of the drive motor 121 to the slider 122 through a rack part 131.

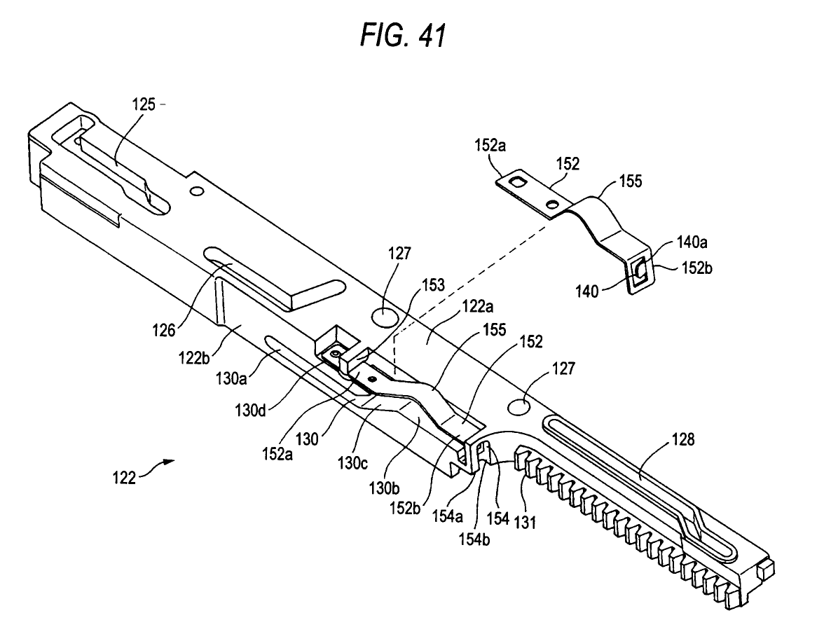

As shown in FIG. 41, the slider 122 is formed of a resin member in a rectangular parallelepiped overall, and a top 122a is formed with the first guide groove 125 in which the engagement projecting part 109 formed on the third link arm 100 is engaged, a second guide groove 126 which in which the coupling arm 165 is engaged that drives the subslider 151 of the base ascending/descending mechanism 150, described later, a pair of the engagement recesses 127 and 127 which are engaged in a pair of the engagement projections 68 and 68 formed on the loading cam plate 53, and a third guide groove 128 in which one end of an open/close arm that restricts the insertion of two optical disks 2.

In addition, on a side surface 122b on the base unit 22 side, the slider 122 is formed with the first cam slit 130 into which the first support shaft 47 is inserted that is projected on the subchassis 29 of the base unit 22, and the rack part 131 which is engaged in the gear train 123. The first cam slit 130 is assembled with a first guide plate 152 which prevents the first support shaft 47 of the subchassis 29 from wobbling to stably operate the disk rotating drive mechanism 24. Moreover, the slider 122 has a slide guide groove 129 formed on an under surface 122c, the slide guide groove which is projected from the bottom case 4 and whose the slide direction is guided by a pair of the guide projections 124 and 124 in the longitudinal direction (see FIG. 9).

The slider 122 is disposed between one side surface of the deck part 4a of the bottom case 4 and the base unit 22 in the bottom part of the bottom case 4. In addition, the slider 122 is placed lower than the optical disk 2 inserted from the disk port 19 into the housing 3, and the height of its top part is slightly lower than that of the deck part 4a. The slider 122 is covered with the main chassis 6, and it is slidably driven in the directions of arrows f₁ and f₂ that are the longitudinal direction through the drive motor 121 and the gear train 123 arranged in the bottom part of the bottom case 4.

Then, in the drive mechanism 120, the operation arm 58 engaged in the third link arm 100 and in the third link arm 100 is moved as it is interlocked with the slide of the slider 122 to regulate the rotation of the eject arm 52, and the loading cam plate 53 is moved to and fro to rotate the loading arm 51. Thus, the drive mechanism 120 performs the loading operation that draws the optical disk 2 into the housing 3, and the eject operation that eject the optical disk 2 from the disk mounting part 23 out of the disk port 19 in accordance with the slide of the slider 122.

Next, the base ascending/descending mechanism 150 which ascends and descends the base unit 22 as it is interlocked with the sliding operation of the slider 122 described above will be described. The base ascending/descending mechanism 150 ascends and descends the base unit 22 among these positions: the chucking position at which the base unit 22 is descended to mount the optical disk 2 centered at the disk mounting position on the turntable 23a of the disk mounting part 23; the chucking release position at which the base unit 22 is descended to release the optical disk 2 from the turntable 23a; and the recording/reproducing position at which the base unit 22 is positioned between the chucking position and the chucking release position to record or reproduce signals from the optical disk 2.

More specifically, in the base ascending/descending mechanism 150, the first support shaft 47 and the second support shaft 48 formed on the base unit 22 are ascended and descended by the subslider 151 which is slid in accordance with the slide of the slider 122 and the slider 122, whereby the base unit 22 is ascended and descended. As shown in FIG. 41, on the side surface of the slider 122 facing to the base unit 22, the first cam slit 130 is formed across the longitudinal direction which ascends and descends the base unit 22 between the chucking release position and the recording/reproducing position. The first cam slit 130 is formed with a lower horizontal plane 130a which corresponds to the chucking release position, an upper horizontal plane 130b which corresponds to the recording/reproducing position, an inclined surface 130c which connects the lower horizontal plane 130a to the upper horizontal plane 130b, and a mounting part 130d on which the first guide plate 152, described later, is mounted, and into the first cam slit, the first support shaft 47 projected on the subchassis 29 of the base unit 22 is slidably inserted.

In addition, the first cam slit 130 has the first guide plate 152 which guides the movement of the first support shaft 47, and prevents the first support shaft 47 from wobbling at the disk rotating drive mechanism 24. The first guide plate 152 is formed of a plate spring member, in which an end 152a has an engagement hole which is engaged in the projection piece formed on the engagement projecting part projected on the mounting part 130d of the first cam slit 130, and the end 152a is retained on a projection piece 153 which is formed from the top 122a of the slider 122 toward the mounting part 130d. The first guide plate 152 has a retain strip 140 formed at an end 152b, which is retained on a retaining part 154 disposed on the first cam slit 130. Above the contacting point of the upper horizontal plane 130b and the inclined surface 130c, the first guide plate 152 is formed with a projection 155 which the first support shaft 47 is moved therealong when the base unit 22 is ascended to the chucking position and is projected on the top 122a side of the slider 122 when the first support shaft 47 is moved along the upper horizontal plane 130b.

In addition, the lower horizontal plane 130a of the first cam slit 130 is slidably formed having the height slightly larger than the diameter of the first support shaft 47. On the other hand, the upper horizontal plane 130b has the height to the first guide plate 152 slightly smaller than the diameter of the first support shaft 47. Therefore, for the first guide plate 152, when the first support shaft 47 is moved along the upper horizontal plane 130b, the first support shaft 47 is press fitted, and the first support shaft 47 is clamped between the first guide plate and the upper horizontal plane 130b. Therefore, the first guide plate 152 suppresses vibrations caused by the spindle motor 24a of the disk rotating drive mechanism 24 disposed on the base unit 22, and it can stably rotate the optical disk 2.

In addition, in the first guide plate 152, the first support shaft 47 is clamped between it and the upper horizontal plane 130b, whereby the projection 155 is projected above the top 122a of the slider 122, and pressed against the top 6a of the main chassis 6. Therefore, during recording/reproducing the optical disk 2, the slider 122 is pressed against the bottom case 4 side by the first guide plate 152, and thus the influences of vibrations or disturbance caused by the base unit 22 can be suppressed.

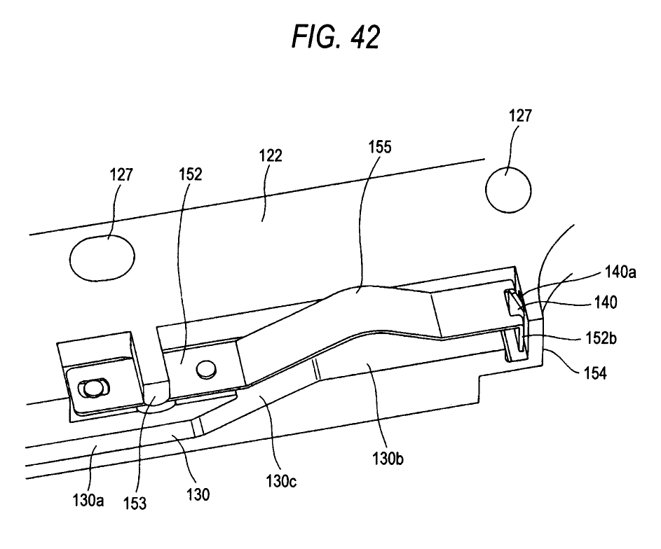

The retain strip 140 formed on the end 152b of the first guide plate 152 is formed in which the end 152b is bent in the direction orthogonal to the longitudinal direction of the slider 122, and a part of the main surface part of the end 152b is projected in a nearly rectangular shape along in the direction of bending the end 152b. The retaining part 154, on which the retain strip 140 is retained, has a slit 154b which is disposed on the front side of the upper horizontal plane 130b of the first cam slit 130 on a side wall 154a in the thickness direction from the top 122a of the slider 122 to in the thickness direction. Then, as shown in FIG. 42, the first guide plate 152 is retained on the first cam slit 130, whereby the end 152b of the first guide plate 152 faces the side wall 154a, the retain strip 140 is inserted into the slit 154b, and a top 140a of the retain strip 140 is abuttable against the upper part of the slit 154b.

Since the retain strip 140 is inserted into the slit 154b, in the first guide plate 152, when an impact is applied in the surface direction, the top 140a of the retain strip 140 abuts against the upper part of the slit 154b to receive the impact by the slider 122 through the top 140a of the retain strip 140. Therefore, even though an impact is applied in the surface direction due to an event that the disk drive apparatus 1 accidentally falls, for example, the first guide plate 152 can prevent plastic deformation.

Particularly, the first guide plate 152 is formed of a long elastic member, and it might cause plastic deformation against an impact in the surface direction. In addition, it is necessary to take measures to an impact applied at the time when the apparatus accidentally falls because of a simple package, when the disk drive apparatus 1 is shipped from a manufacturer, or when an electronic appliance mounted with the disk drive apparatus 1 is shipped. However, the retain strip 140 is formed to be retainable on the slider 122, whereby the first guide plate 152 can be prevented from being deformed.

The subslider 151 supports the second support shaft 48 projected from the subchassis 29 of the base unit 22, the subslider is engaged in the slider 122, and slidably arranged in association with the slide of the slider 122 in the direction of arrow h₁ or in the direction of arrow h₂ in FIG. 11 orthogonal to the loading direction of the optical disk 2.

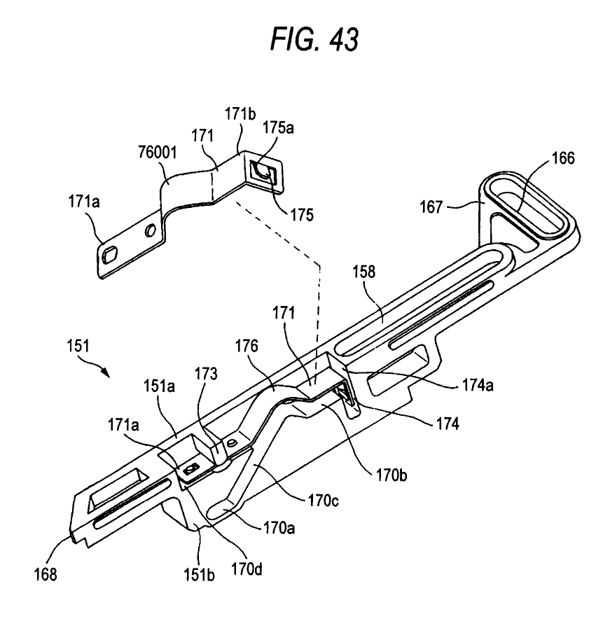

As shown in FIGS. 11 and 43, the subslider 151 is formed of a long flat plate member formed of a synthetic resin, and on its top 151a, a guide groove 158 is formed across the longitudinal direction which is engaged in a guide projecting part 157 projected from the main chassis 6. In addition, at the position slightly shifted from the guide groove 158 on an under side 151c, the subslider 151 is formed with a lower guide groove 160 across the longitudinal direction which is engaged in a guide projecting part 159 projected from the bottom case 4 (see FIG. 9). Then, in the subslider 151, the upper guide groove 158 is engaged in the guide projecting part 157 projected from the main chassis 6, and then the guide projecting part 157 is slid through the upper guide groove 158, whereas the lower guide groove 160 is engaged in the guide projecting part 159 projected from the bottom case 4, and then the guide projecting part 159 is slid through the lower guide groove 160. Thus, the subslider is slid in the direction of arrow h₁ or in the direction of arrow h₂ as it is interlocked with the slide of the slider 122.

In addition, on one end part positioned on the slider 122 side in the longitudinal direction, the subslider 151 is formed with an engagement groove 166 which is engaged in the coupling arm 165 coupled to the slider 122. The engagement groove 166 is disposed on an engagement strip 167 extended in the direction orthogonal to the longitudinal direction of the subslider 151. In addition, in the subslider 151, the other end part on the opposite side of the end part formed with the engagement strip 167 is the abutting projecting part 168 which abuts against the rotating support member 71 of the eject arm 52 in loading the optical disk 2. As shown in FIG. 16, in loading the optical disk 2, the abutting projecting part 168 abuts against the bend strip 81 of the rotating support member 71 to rotate the rotating support member 71 in the direction in which the pushing arm 72 is released from the side surface of the optical disk 2, and to restrict the rotation of the rotating support member 71 so that the pushing arm 72 having been rotated to the position separating from the side surface of the optical disk 2 is not rotated in the direction of the side surface of the optical disk 2. Therefore, the subslider 151 maintains the state in which the pushing arm 72 of the eject arm 52 is released from the side surface of the optical disk 2.

On a side surface 151b on the disk port 19 side, the subslider 151 is formed with the first cam slit 130 as well as the second cam slit 170 across the longitudinal direction which ascends and descends the base unit 22 among the chucking position, the chucking release position, and the recording/reproducing position. The second cam slit 170 is formed with a lower horizontal plane 170a which corresponds to the chucking release position, an upper horizontal plane 170b which corresponds to the recording/reproducing position, an inclined surface 170c which connects the lower horizontal plane 170a to the upper horizontal plane 170b and corresponds to the chucking position, described later, and a mounting part 170d on which a second guide plate 171 is mounted, and into the second cam slit, the second support shaft 48 is slidably inserted that is protruded on the subchassis 29 of the base unit 22.

The inclined surface 170c of the second cam slit 170 is disposed to the position higher than the position of the upper horizontal plane 170b, and it slightly descends to guide the base unit 22 to the upper horizontal plane 170b. Thus, the subslider 151 is slid in the direction of arrow h₁ to ascend the second support shaft 48 from the lower horizontal plane 170a to the inclined surface 170c, and the base unit 22 guided by the second cam slit 170 is moved from the chucking release position to the chucking position. At this time, the base unit 22 clamps the vicinity of the center hole 2a of the optical disk 2 centered on the disk mounting part 23 together with the turntable 23a and with the abutting protrusion part 8 disposed on the top plate 5a of the top cover 5 to chuck the optical disk 2. Furthermore, when the subslider 151 is slid in the direction of arrow h₁, the second support shaft 48 is descended from the inclined surface 170c to the upper horizontal plane 170b, and then the base unit 22 is moved from the chucking position to the recording/reproducing position.

In addition, as similar to the first cam slit 130, the second cam slit 170 has the second guide plate 171 which guides the movement of the second support shaft 48 and prevents the second support shaft 48 from wobbling at the recording/reproducing position to stably operate the disk rotating drive mechanism 24. The second guide plate 171 is formed of a plate spring member, in which an end 171a is disposed with an engagement hole, the engagement hole is engaged in the engagement projecting part projected on the mounting part 170d of the second cam slit 170, and the end 171a is retained on a projection piece 173 which is formed from the top 151a of the subslider 151 toward the mounting part 170d side. In addition, the second guide plate 171 is formed with a retain strip 175 on an end 171b, which is retained on a retaining part 174 disposed on the second cam slit 170. Moreover, above the contacting point of the upper horizontal plane 170b with the inclined surface 170c, the second guide plate 171 is formed with a projection 176 which the second support shaft 48 is moved therealong when the base unit 22 is ascended to the chucking position and which is projected on the top 151a of the subslider 151 side when the second support shaft 48 is moved to the upper horizontal plane 170b.

In addition, the lower horizontal plane 170a of the second cam slit 170 is slidably formed having the height slightly larger than the diameter of the second support shaft 48. On the other hand, the upper horizontal plane 170b has the height to the second guide plate 171 the same as the diameter of the second support shaft 48 or slightly lower than that. Therefore, when the second support shaft 48 is moved by the upper horizontal plane 170b, the second support shaft 48 is press fitted, and the second guide plate 171 clamps the second support shaft 48 between it and the upper horizontal plane 170b. Therefore, the second guide plate 171 can suppress vibrations caused by the spindle motor 24a of the disk rotating drive mechanism 24 disposed on the base unit 22 together with the first guide plate 152, and it can stably rotate the optical disk 2.

In addition, the second guide plate 171 clamps the second support shaft 48 between it and the upper horizontal plane 170b, and then the projection 176 is projected above the top 151a of the subslider 151a and pressed against the top 6a of the main chassis 6. Therefore, during recording/reproducing the optical disk 2, the subslider 151 is pressed against the bottom case 4 side by the second guide plate 171, and the influences of vibrations or disturbance caused by the base unit 22 can be suppressed.

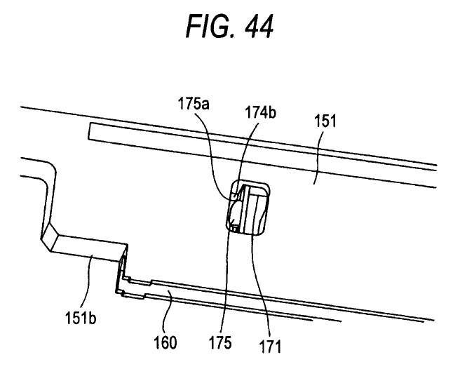

The retain strip 175 formed on the end 171b of the second guide plate 171 is formed in which the end 171b is bent in the direction orthogonal to the longitudinal direction of the subslider 151, and a part of the main surface part of the end 171b is projected in a nearly rectangular shape on the front side in the longitudinal direction along the direction of bending the end 171b. As shown in FIGS. 43 and 44, the retaining part 174, on which the retain strip 175 is retained, has a slit 174b which is disposed on the front side of the upper horizontal plane 170b of the second cam slit 170 across the thickness direction of a side wall 174a from the top 151a of the subslider 151 toward the thickness direction. The second guide plate 171 is retained on the second cam slit 170, the end 171b of the second guide plate 171 faces the side wall 174a, the retain strip 175 is inserted into the slit 174b, and the top 175a of the retain strip 175 is abuttable against the upper part of the slit 174b.

because the retain strip 175 is inserted into the slit 174b, when an impact is applied in the surface direction, in the second guide plate 171, the top 175a of the retain strip 175 abuts against the upper part of the slit 174b, and the impact can be received by the subslider 151 through the top 175a of the retain strip 175. Therefore, as similar to the first guide plate 152, even though an impact is applied in the surface direction due to an event that the disk drive apparatus 1 accidentally falls, for example, the second guide plate 171 can prevent plastic deformation.

In the coupling arm 165 which is engaged in the engagement groove 166 of the subslider 151 and coupled to the slider 122 and the subslider 151, a support part 165a disposed approximately in the middle part is rotatably mounted on the main chassis 6, an engagement projecting part 177 which is formed on an end 165b of the support part 165a is movably engaged in the second guide groove 126 of the slider 122, and an engagement projecting part 178 which is formed at an end 165c is movably engaged in the engagement groove 166 of the subslider 151.

As shown in FIG. 15, when the slider 122 is moved in the direction of arrow f₁, the engagement projecting part 177 is moved through the second guide groove 126 of the slider 122, the coupling arm 165 is rotated in the direction of arrow 11 as it is pivoted about the support part 165a, and the engagement projecting part 178 slides the subslider 151 in the direction of arrow h₁ as it moves through the engagement groove 166. In addition, as shown in FIG. 18, when the slider 122 is moved in the direction of arrow f₂, the engagement projecting part 177 is moved through the second guide groove 126, the coupling arm 165 is rotated in the direction of arrow 12 as it is pivoted about the support part 165a, the engagement projecting part 178 slides the subslider 151 in the direction of arrow h₂ as it moves through the engagement groove 166.

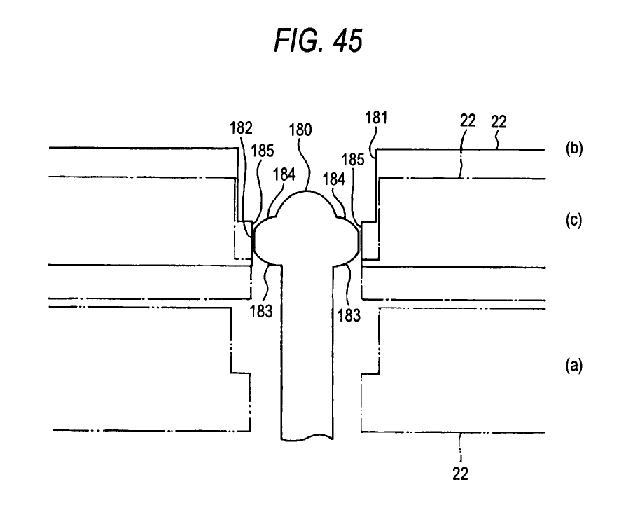

As shown in FIGS. 3 and 45, in the disk drive apparatus 1, the guide pin 180 which guides the base unit 22 so that the center hole 2a of the optical disk 2 carried at the centering position by the disk transfer mechanism 50 is positioned to the turntable 23a of the disk mounting part 23 disposed on the base chassis 27 when the base unit 22 is ascended to the chucking position.

As shown in FIG. 45, the guide pin 180 is raised from the bottom part of the bottom case 4, and in the upper part, a flange 182 is formed which is inserted into a guide hole 181 formed on the base chassis 27. The flange 182 is formed with a first guide part 183 which has an inclined surface with a diameter slightly larger than the diameter of the guide hole 181 of the base chassis 27 and widened toward the upper end part, and a second guide part 184 which has an inclined surface decreased in diameter toward the upper end part. Then, when the base chassis 27 is ascended and descended, the first and second guide parts 183 and 184 are inserted as they are slidably contacted with a guide wall 185 formed on the guide hole 181, and then the flange 182 guides the base unit 22 to the chucking position of or the chucking release position.

The guide hole 181 of the base chassis 27, into which the guide pin 180 is inserted, is perforated near the turntable 23a apart from the third support shaft 49 to be the rotating support point of the base unit 22. As shown in FIG. 45, inside the guide hole 181, the guide wall 185 is swelled and formed in the lower part of the base chassis 27. In the guide wall 185, a clearance is formed which is slightly larger than the diameter of the flange 182 of the guide pin 180, and the flange 182 is inserted into the clearance, whereby the base unit 22 is guided so that the center hole 2a of the optical disk 2 is positioned to the turntable 23a of the disk mounting part 23.

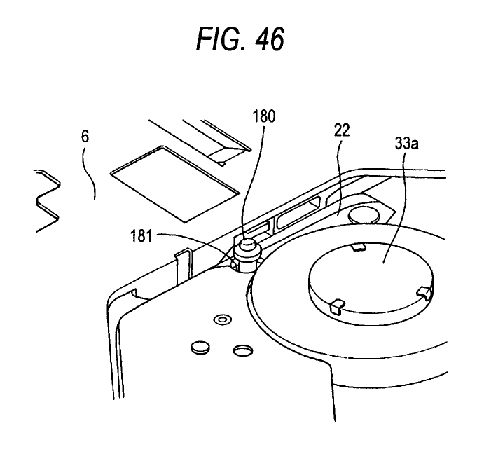

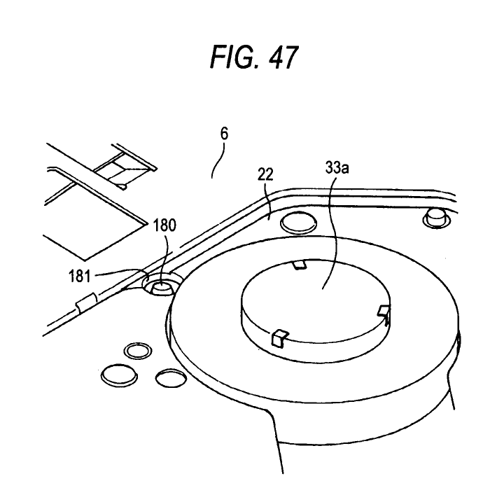

More specifically, as indicated by chain double-dashed lines in (a) in FIG. 45 and as shown in FIG. 46, when the base unit 22 is descended at the chucking release position, the flange 182 of the guide pin 180 is positioned above the guide hole 181. When the optical disk 2 is transferred to the centering position, the base chassis 27 is ascended, and the flange 182 is inserted into the guide hole 181. As indicated by solid lines in (b) in FIG. 45 and as shown in FIG. 47, when the base chassis 27 is descended to the chucking position of the optical disk 2, the guide wall 185 swelled inside the guide hole 181 is slid over the first guide part 183 of the guide pin 180, and the flange 182 is inserted through the clearance between the guide walls 185. As described above, the base chassis 27 is ascended as it is guided by the guide pin 180, and then the turntable 23a of the disk mounting part 23 is positioned to the center hole 2a of the optical disk 2 carried at the centering position. Therefore, the disk can be smoothly chucked with no excess load applied to the optical disk 2 or the turntable 23a.

In addition, the guide pin 180 and the guide hole 181 are formed correspondingly on the other end side on the opposite side of one end in the longitudinal direction disposed with the third support shaft 49 which supports the rotation of the base unit 22 near the disk mounting part 23. Thus, a shift between the optical disk 2 carried to the centering position and the turntable 23a can be corrected most efficiently, and the center hole 2a of the optical disk 2 can be reliably positioned to the engaging protrusion part 33a of the turntable 23a.

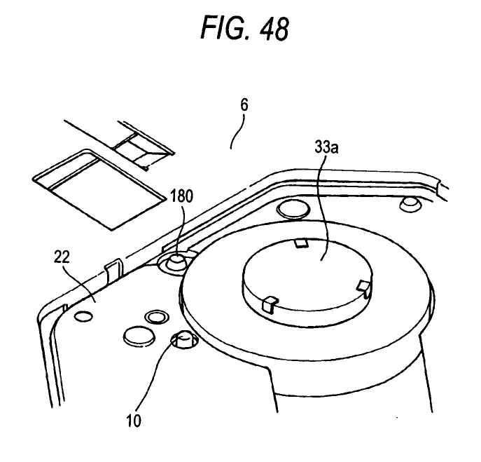

Then, as indicated by alternate long and short dash lines in (c) in FIG. 45 and as shown in FIG. 48, when the base unit 22 is descended to the recording/reproducing position, the guide wall 185 of the guide hole 181 of the base chassis 27 is slid over the second guide part 184 of the flange 182, the flange 182 is guided as insertable into the guide hole 181, and then the guide wall 185 is descended to the position at which it is separated from the flange 182. As described above, in the state in which the base unit 22 is descended to the recording/reproducing position, since the guide pin 180 is not contacted with the guide hole 181, disturbance such as vibrations is prevented from transmitting from the bottom case 4 to the base chassis 27 side through the guide pin 180. Therefore, such an event can be prevented that disturbance is transmitted to the disk rotating drive mechanism 24 or the optical pickup 25 through the guide pin 180, and adversely affects the recording/reproducing characteristics.

Moreover, the guide pin 180 is formed at the height at which the guide pin does not abut against the under side of the optical disk 2 rotated and driven by the disk rotating drive mechanism 24, and the guide pin is unlikely to damage the information recording surface of the optical disk 2.

After the recording/reproducing operation is finished to move to the step of ejecting the optical disk 2, the base unit 22 is descended to the chucking release position, and the optical disk 2 is pushed up from the turntable 23a by the guide pin 180 to release chucking. At this time, the base chassis 27 is positioned such that the guide hole 181 is arrange in the lower part of the guide pin 180.

In addition, in the disk drive apparatus to which an embodiment of the invention is applied 1, the guide pin 180 also functions as a chucking release pin which releases the chucking of the optical disk 2. In other words, the guide pin 180 is formed in which the upper end part has a hemisphere, and the guide pin 180 and the guide hole 181 of the base chassis 27 correspond to a non-recording area which is formed near the center hole 2a of the optical disk 2 mounted on the turntable 23a. Thus, when the base unit 22 is descended to the chucking release position of the optical disk 2, the optical disk 2 is pushed up by the upper end part of the guide pin 180, and then the disk is released from chucking on the turntable 23a. According to this configuration, since it is unnecessary to use a chucking release pin which releases the chucking of the optical disk 2, other than the guide pin 180, reductions can be intended in the number of parts and in the weight of the disk drive apparatus 1.

It should be understood by those skilled in the art that various modifications, combinations, sub-combinations and alterations may occur depending on design requirements and other factors insofar as they are within the scope of the appended claims or the equivalents thereof.

What is claimed is:

1. A disk drive apparatus comprising:
a device main body which a disk-shaped recording medium is inserted thereinto and ejected therefrom;
a loading arm which has an arm main body and a support part wherein when the disk-shaped recording medium is inserted, the loading arm is rotated in the insertion direction to draw the disk-shaped recording medium into the device main body, and when the disk-shaped recording medium is ejected, the loading arm is rotated in the eject direction, the arm main body which is rotatably supported on a pivot part that is disposed in the direction orthogonal to in the direction of inserting and ejecting the disk-shaped recording medium by the device main body and disposed in a plane in parallel with one side of surfaces of the disk-shaped recording medium, and the support part which is disposed on the tip end of the arm main body, and supports the side surface on the back side of the disk-shaped recording medium in the insertion direction;
a loading cam plate which has a cam groove and rotates the loading arm, the cam groove in which an engagement projecting part is engaged that is projected on the arm main body;
a drive mechanism which is coupled to the loading cam plate, and reciprocates the loading cam plate inside the device main body in association with inserting and ejecting the disk-shaped recording medium, whereby the drive mechanism rotates the loading arm through the loading cam plate in directions of inserting and ejecting the disk-shaped recording medium;
an eject arm which is rotatably supported in the direction orthogonal to the directions of inserting and ejecting the disk-shaped recording medium by the device main body and on the other side of surfaces in plane in parallel with the disk-shaped recording medium, and which is pressed by the disk-shaped recording medium and rotated in the insertion direction when the disk-shaped recording medium is inserted into the device main body, and is rotated in the eject direction to eject the disk-shaped recording medium when the disk-shaped recording medium is ejected;
a link mechanism which couples the eject arm to the drive mechanism, and the drive mechanism is driven, whereby the link mechanism rotates the eject arm in the directions of inserting and ejecting the disk-shaped recording medium; and
cam means which is engaged in the link mechanism, wherein an engagement part of the link mechanism is pivoted from the insertion to the ejection of the disk-shaped recording medium to control an amount of rotation of the eject arm so that the amount of rotation of the eject arm with respect to the drive mechanism in ejecting the disk-shaped recording medium is greater than the amount of rotation of the eject arm with respect to the drive mechanism in inserting and ejecting the disk-shaped recording medium,
wherein a long hole is provided in one of the arm main body and the pivot part, and
a protrusion part is provided in the other one which is inserted into the long hole.

2. The disk drive apparatus according to claim 1, wherein a cam groove of the loading cam plate which guides the engagement projecting part comprises:
a rotating guide part which rotates the loading arm in the direction of drawing the disk-shaped recording medium to transfer the disk to a disk holding part when moved to one side of the device main body by the drive mechanism, whereas which allows the loading arm rotatable in the eject direction of the disk-shaped recording medium when moved to the other side of the device main body by the drive mechanism;
a centering guide part restricts the rotation of the loading arm, and allows the loading arm to support the disk-shaped recording medium transferred by the disk holding part at a centering position;
a release guide part which rotates the loading arm in the eject direction in which the support part is separated from the side surface of the disk-shaped recording medium; and
a non-engagement part which is not engaged in the engagement projecting part and is not involved in rotating the loading arm by the loading cam plate,
wherein when a disk-shaped recording medium of large diameter of about 12 cm is inserted from a disk port of the device main body to a position about 23 mm to 30 mm to the side surface on the back side in insertion direction of the disk-shaped recording medium of large diameter, the rotating guide part operates so as to start the drawing operation by the loading arm.

3. The disk drive apparatus according to claim 1, wherein the cam means comprises:
an insertion guide wall along which an engagement part of the link mechanism is moved in association of the rotation of the eject arm when the disk-shaped recording medium is inserted;
a pulling guide wall along which an engagement part of the link mechanism is moved in association with the rotation of the eject arm driven by the drive mechanism when the disk-shaped recording medium is drawn; and
an ejecting guide wall along which an engagement part of the link mechanism is moved in association with the rotation of the eject arm driven by the drive mechanism when the disk-shaped recording medium is ejected.

4. The disk drive apparatus according to claim 3, wherein the eject arm is energized in the eject direction of the disk-shaped recording medium by guiding the link mechanism by means of the insertion guide wall;
an energizing force in the eject direction of the disk-shaped recording medium is reduced by guiding the link mechanism by means of the pulling guide wall; and
an energizing force in the eject direction of the disk-shaped recording medium is suppressed by guiding the link mechanism by means of the ejecting guide wall.

5. A disk drive apparatus comprising:
a device main body which a disk-shaped recording medium is inserted thereinto and ejected therefrom;
a loading arm which has an arm main body and a support part wherein when the disk-shaped recording medium is inserted, the loading arm is rotated in the insertion direction to draw the disk-shaped recording medium into the device main body, and when the disk-shaped recording medium is ejected, the loading arm is rotated in the eject direction, the arm main body which is rotatably supported on a pivot part that is disposed in the direction orthogonal to in the direction of inserting and ejecting the disk-shaped recording medium by the device main body and disposed in a plane in parallel with one side of surfaces of the disk-shaped recording medium, and the support part which is disposed on the tip end of the arm main body, and supports the side surface on back side of the disk-shaped recording medium in the insertion direction;
a loading cam plate which has a cam groove and rotates the loading arm, the cam groove in which an engagement projecting part is engaged that is projected on the arm main body;
a drive mechanism which is coupled to the loading cam plate, and reciprocates the loading cam plate inside the device main body in association with inserting and ejecting the disk-shaped recording medium, whereby the drive mechanism rotates the loading arm through the loading cam plate in directions of inserting and ejecting the disk-shaped recording medium;
an eject arm which is rotatably supported in the direction orthogonal to the direction of inserting and ejecting the disk-shaped recording medium by the device main body and on the other side of surfaces in plane in parallel with the disk-shaped recording medium, and which is pressed by the disk-shaped recording medium and rotated in the insertion direction when the disk-shaped recording medium is inserted into the device main body, and is rotated in the eject direction to eject the disk-shaped recording medium when the disk-shaped recording medium is ejected;
a link mechanism which couples the eject arm to the drive mechanism, and the drive mechanism is driven, whereby the link mechanism rotates the eject arm in the direction of inserting and ejecting the disk-shaped recording medium; and
a cam unit which is engaged in the link mechanism, wherein an engagement part in the link mechanism is pivoted from the insertion to the ejection of the disk-shaped recording medium to control an amount of rotation of the eject arm so that the amount of rotation of the eject arm with respect to the drive mechanism in ejecting the disk-shaped recording medium is greater than the amount of rotation of the eject arm with respect to the drive mechanism in inserting and ejecting the disk-shaped recording medium,
wherein a long hole is provided in any one of the arm main body or the pivot part, and
a protrusion part is provided in the other one which is inserted into the long hole.
